(19) United States
(12) Patent Application Publication
(10) Pub. No.: US 2023/0202106 A1
(43) Pub. Date: Jun. 29, 2023

(54) APPARATUSES, SYSTEMS AND METHODS FOR ELECTROHYDRODYNAMIC (EHD) MATERIAL DEPOSITION

(71) Applicant: THE BOARD OF TRUSTEES OF THE UNIVERSITY OF ILLINOIS, Urbana, IL (US)

(72) Inventor: Alexander L. Yarin, Clarendon Hills, IL (US)

(21) Appl. No.: 17/928,443

(22) PCT Filed: May 27, 2021
(86) PCT No.: PCT/US21/34422

§ 371 Date: Nov. 29, 2022

Related U.S. Application Data
(60) Provisional application No. 63/032,555, filed on May 30, 2020.

(51) Int. Cl. B29C 64/209; B29C 64/112; B33Y 30/00

(52) U.S. Cl. CPC B29C 64/209; B29C 64/112; B33Y 30/00

(57) ABSTRACT

Apparatuses, systems and methods are provided for electrohydrodynamic material deposition. An associated electro-hydrodynamic material deposition printer head may include a material delivery nozzle configured to deliver at least one material in a first direction relative to a substrate, and an electric field generator configured to control a direction of an electric field proximate the material being directed to redirect at least a portion of the at least one material in a second direction relative to the substrate, wherein the second direction is different that the first direction.

### FIELD OF DISCLOSURE

The present disclosure relates generally to apparatuses, systems, and methods for additive manufacturing and/or direct printing. More specifically, the present disclosure relates to apparatuses, systems, and methods for electrohydrodynamic (EHD) material deposition.

### BACKGROUND

Nearly 70 years since conception, inkjet printing has evolved into a staple within modern industry as a useful advanced fabrication tool. While relatively simple in principle, the trend to maximize DPI (dots per inch) while concurrently reducing the size of the machinery, has made the successful implementation of this non-contact process very complex. Despite these and other challenges, inkjet printing remains at the forefront as a direct printing technique when fabricating, for example, functional electronics, sensors, three-dimensional biological materials, etc.

Dispensing liquid jets are used in a vast range of industrial applications including, for example, additive manufacturing (AM), direct ink writing (DIW), drop on demand (DOD), surface coating, dispensing cooling, etc. Many of these applications are linked by common underlying physical phenomena associated with a material being deposited, a method by which the material is deposited, and a substrate on which the material is deposited. Because building structures pixel-by-pixel, and layer-by-layer, may require placement of adjacently located droplets, a coalescence between two merging drops may be a dynamic phenomenon.

Within the broad scope of AM, many manufacturing advantages have been demonstrated, including freedom of structural design, reduced concept-to-completion time, and minimized waste. Specifically, nozzle-based continuous filament extrusion AM technologies possess an ability to print a wide range of materials including but not limited to metals, synthetic polymers, natural polymers, ceramics, bio-gels, etc. One such nozzle-based AM technology is DIW which may be synonymous with robocasting (robotic material extrusion). DIW is often described as a technique or process capable of depositing, dispensing or processing different types of materials over various surfaces following a preset pattern or layout. While the concept of extruding functional fluids through a nozzle to digitally defined locations is decades-old, new applications in printed electronics continue to widen DIW as an emerging field. For example, DIW may provide a bright opportunity for electronic systems due to evolving availability of functional materials. Manipulation and control of droplets of material have never been more prevalent than in today's complex additive manufacturing industry.

DIW may, for example, be incorporated into a three-dimensional (3D) printing process that fabricates objects by depositing functional ink on a substrate layer-by-layer, for a wide range of applications including: flexible electronics, scaffolds, bio-structures, flooring, decorative construction materials, wood-like materials, stone-like materials, metal-like materials, textile-, show- and other related materials, electronics-related materials, bio-materials, repairing and remanufacturing, surface texturing, etc. In DIW, adhesion between inks of different materials, and between the ink and the substrate, remains to be a challenge.

Nozzle-based deposition technologies, which build layer-by-layer (additive manufacturing), have not kept pace with other 3-D printing techniques (e.g., Stereolithography (SLA), etc.), in layer-build time or throughput. While nozzle-based printing is already arguably versatile, such sub-categories as DIW are difficult to be used on rough surfaces. Modern application and forthcoming ideas impose extreme demands on AM and DIW systems requiring ever increasing speed while maintaining precision and reliable functioning.

One problem with known DIW systems is that an increased relative velocity between nozzle and substrate increases manufacturing defects, such as bulging, discontinued lines, liquid puddles, liquid splashing and coffee-ring effects, therefore, limiting an associated printing speed. Printing resolution may also be limited in known systems by, for example, an inner diameter (I.D.) of an associated material dispensing needle in the DIW system. To achieve a good printing accuracy, the dispensing needle is usually located close to the substrate at a distance which is called standoff distance (S.D.). In reality, the S.D. is proportional to the printing orifice diameter and is typically set between 50-100 percent the needles' I.D. With DIW needles often being on an order of 50-100 μm, attempting to maintain a microscale standoff distance often proves problematic, and has previously limited prints to very smooth substrates and low speeds (0.1-100 mm/s).

### SUMMARY

An electrohydrodynamic material deposition printer head may include a material delivery nozzle configured to deliver at least one material in a first direction relative to a substrate. The printer head may further include an electric field generator configured to control a direction of an electric field proximate the material being directed to redirect at least a portion of the at least one material in a second direction relative to the substrate. The second direction may be different that the first direction.

In another embodiment, an electrohydrodynamic material deposition system may include a material delivery nozzle configured to deliver at least one material in a first direction relative to a substrate. The system may also include at least one electrode configured to generate an electric field proximate the material being delivered. The system may further include a controller configured to control an orientation of the electric field to redirect at least a portion of the at least one material in a second direction relative to the substrate, wherein the second direction is different than the first direction.

In a further embodiment, a computer-implemented method for electrohydrodynamic material deposition may include controlling, using a processor, a material delivery nozzle configured to direct at least one material in a first orientation relative to a substrate in response to the processor executing a material delivery nozzle control module. The method may also include controlling, using the processor, an orientation of an electric field proximate the material delivery nozzle to redirect at least a portion of the at least one material in a second orientation relative to the substrate in response to the processor executing an electric field controlling module. The second orientation may be different that the first orientation.

In yet a further embodiment, a computer-readable medium storing computer-readable instructions that, when executed by a processor, may cause the processor to control an electrohydrodynamic material deposition process. The computer-readable medium may also include a material delivery nozzle control module controlling, using a processor, a material delivery nozzle configured to direct at least one material in a first orientation relative to a substrate in response to the processor executing. The computer-readable medium may further include an electric field controlling module that, when executed by a processor, causes the processor to control an orientation of an electric field proximate the material delivery nozzle to redirect at least a portion of the at least one material in a second orientation relative to the substrate in response to the processor executing. The second orientation is different that the first orientation.

In another embodiment, an electrohydrodynamic material deposition system may include a material delivery nozzle configured to direct at least one material in a first direction relative to a substrate. The system may also include a means for controlling an orientation of an electric field proximate the material delivery nozzle to redirect at least a portion of the at least one material in a second orientation relative to the substrate. The second orientation is different that the first orientation.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicated of the presence or absence of particular elements in any of the exemplary embodiments, except as may be explicitly delineated in the corresponding written description. Also, none of the drawings are necessarily to scale.

FIGS. 1A and 1B depict an example electrohydrodynamic material deposition apparatus;

FIG. 1C depicts a high-level block diagram of an example electrohydrodynamic material deposition system;

FIG. 1D depicts a block diagram of an example electrohydrodynamic material deposition apparatus;

FIG. 1E depicts an example method of operating an example electrohydrodynamic material deposition apparatus;

FIG. 1F depicts a block diagram of an example remote computing device for use within an electrohydrodynamic material deposition system;

FIG. 1G depicts an example method of operating a remote computing device for use within an electrohydrodynamic material deposition system;

FIG. 2A depicts a schematic diagram of an example electrohydrodynamic material deposition system with perpendicular dispensing of a circular jet onto a translating substrate and facilitating smooth material deposition by means of the E.F. shaped by governing electrodes above and below an associated substrate;

FIG. 2B depicts a schematic diagram of an example electrohydrodynamic material deposition system with perpendicular dispensing of a circular jet onto a translating substrate and facilitating smooth material deposition by means of the E.F. shaped by at least one governing electrode above an associated substrate;

FIGS. 3A and 3B depict example retrofitted DIW (Direct Ink Writing) automated dispensing systems setup utilizing perpendicular dispensing of a circular material jet onto a translating substrate enhancing deposition by means of the applied E.F.;

FIGS. 4A and 4B depict example electrohydrodynamic material deposition systems for water dispensing at ˜1030 mm/s onto a Mylar belt (0.019 mm in thickness), 20 mm/sec. 4(b) Water dispensing on Mylar (polyethylene terephthalate) belt 100 mm/sec. Mylar is partially wettable by water, with the contact angle of ˜35-40°;

FIGS. 5A-C depict a solution of 60 wt % of sugar in water issued at ˜380 mm/s: FIG. 5A depcits 20 mm/sec belt speed; steady state, FIG. 5B 40 mm/sec belt speed; steady state, and FIG. 5C depicts 60 mm/sec belt speed; transient state resulting in discrete droplet formation on the belt;

FIGS. 6A and 6B depict a 60 wt % sugar solution in water issued from the nozzle at ˜380 mm/s. FIG. 6A 20 mm/s belt speed, no E.F.—0 kV FIG. 6B 20 mm/s belt speed, voltage of 2.5 kV;

FIGS. 7A-D depict an example spot-E printed at ˜2 mm/s from the nozzle onto Mylar belt at two different belt speeds without and with the E.F. of 2.5 kV applied to the governing electrode (not seen shown in the shapshots): FIG. 7A Spot-E, 40 mm/s belt speed, 0 kV, FIG. 7B Spot-E, 40 mm/s belt speed, 2.5 kV, and FIG. 7C Spot-E, 80 mm/s belt speed, 0 kV. FIG. 7D Spot-E, 80 mm/s belt speed, 2.5 kV;

FIGS. 8A-D depict an example spot-E extruded at ˜2 mm/sec from 34-gauge needle at 30 psi with a 40 mm/s belt speed and 2.5 kV applied voltage at the governing electrode (not seen in the snapshots); FIG. 8A S.D. ˜80 μm e., FIG. 8B S.D. ˜240 μm, and FIG. 8C S.D. ˜380 μm. (d) S.D. ˜600 μm;

FIGS. 9A-C depict an example spot-E extruded from 34-gauge needle with a 40 mm/s belt speed and 2.5 kV applied voltage at the governing electrode (not seen in the snapshots); FIG. 9A S.D. ˜80 μm, 30 psi, ˜2 mm/s., FIG. 9B S.D. ˜600 μm, 30 psi, ˜2 mm/sec., and FIG. 9C S.D. ˜600 μm, 60 psi, ˜4 mm/s;

FIGS. 10A-C depict an example spot-E extruded at ˜2 mm/s from 34-gauge needle with the 80 mm/s belt speed, 30 psi and 2.5 kV applied voltage at the governing electrode (not seen in the snapshots): FIG. 10A before an obstacle, FIG. 10B at the obstacle, and FIG. 10C after the obstacle:

FIGS. 11A-D depict an example spot-E extruded at ˜2 mm/s onto Mylar belt moving at 20 mm/s from 34-gauge needle, 30 psi.: FIG. 11A t≈0 s (the moment when the E.F. of 2.5 kV/mm was turned off) f., FIG. 11B t≈0.25 s., FIG. 11C t≈0.5 s., and FIG. 11D t≈1 s.:

FIGS. 12A-C depict an example spot-E extruded at ˜15 mm/s onto polyester (PTA) belt (0.35 mm thickness) from 32-gauge needle, at the 20 mm/s belt speed, 45 psi.: FIG. 12A View of bundled fibers at 97× magnification, FIG. 12B Failed printing state without E.F. applied, and FIG. 12C 2.5 kV/mm voltage applied to the governing electrode;

FIGS. 13A-D depict an example spot-E extruded at ˜29 mm/s onto woven cotton belt (0.85 mm thickness) from 30-gauge needle, at the 20 mm/s belt speed, 41 psi., FIG. 13B View of bundled fibers at 97× magnification, FIG. 13C Failed printing state without E.F., and FIG. 13D Intact printing line at 2.5 kV/mm voltage applied to the governing electrode;

FIGS. 14A-D depict an example spot-E extruded at ˜37 mm/s onto woven jute belt (2.21 mm thickness) from 27-gauge needle, at the 20 mm/s belt speed, 30 psi.: FIG. 14A View of bundled fibers at 32× magnification, FIG. 14B View of bundled fibers at 97× magnification, FIG. 14C Failed printing state without E.F. applied., and FIG. 14D Successful intact trace resulting from 2.5 kV/mm applied to the governing electrode;

FIGS. 15A-J depict an example spot-E extruded at ˜10 mm/s onto glass substrate (1 mm thickness) from 32-gauge needle at 30 psi. Printed on the DIW machine: (a) 50 mm/s, 0 kV/mm. (A) 50 mm/s, 2.5 kV/mm. (b) 100 mm/s, 0 kV/mm. (B) 100 mm/s, 2.5 kV/mm. (c) 150 mm/s, 0 kV/mm. (C) 150 mm/s, 2.5 kV/mm. (d) 200 mm/s, 0 kV/mm. (D) 200 mm/s, 2.5 kV/mm. (e) 250 mm/s, 0 kV/mm. (E) 250 mm/s, 2.5 kV/mm. (f) 300 mm/s, 0 kV/mm. (F) 300 mm/s, 2.5 kV/mm. (g) 350 mm/s, 0 kV/mm. (G) 350 mm/s, 2.5 kV/mm. (h) 400 mm/s, 0 kV/mm. (H) 400 mm/s, 2.5 kV/mm. (i) 450 mm/s, 0 kV/mm. (I) 450 mm/s, 2.5 kV/mm. (j) 500 mm/s, 0 kV/mm. (J) 500 mm/s, 2.5 kV/mm;

FIGS. 16A and 16B depict an example spot-E extruded onto glass substrate (1 mm thickness) from 32-gauge needle at 10 mm/s with 2.5 kV/mm applied to the governing electrode, 30 psi.: FIG. 16A Short break in the trace line printed at 200 mm/sec. and FIG. 16B Short break in the trace line printed at 450 mm/s;

FIGS. 17A and 17B depict an example spot-E extruded at ˜10 mm/s onto glass substrate (1 mm thickness) from 32-gauge needle, 30 psi., electrically-driven instability of printed traces at elevated E.F. strengths: FIG. 17A E.F. strength of 3.0 kV/mm. and FIG. 17B E.F. strength of 3.1 kV/mm;

FIGS. 18A-C depict an example spot-E extruded at ˜29 mm/s from 30-gauge needle onto woven cotton (0.85 mm thickness) adhered with double-sided tape to a glass substrate (1 mm thickness).; FIG. 18A 0 kV/mm, 40 mm/s, discontinues trace ˜3.5 mm wide, FIG. 18B 2.5 kV/mm, 40 mm/s, continues trace ˜2 mm wide, and FIG. 18C 2.5 kV/mm, 80 mm/s, continues trace ˜1 mm wide;

FIG. 19 depicts a sketch of an example jet axis, with coordinate axes and unit vectors used, a substrate belt here moves vertically at x=l;

FIG. 20 depicts an example predicted jet configuration in a boundary layer near a deflecting belt moving in a direction of the H axis, the parameter values: a̅₀̅=0.1, and V̅_̅{̅τ̅1̅}̅=10, No E.F. is applied:

FIG. 21 depicts an example predicted overall jet configuration, the parameter values: a̅₀̅=0.1, and V̅_̅{̅τ̅1̅}̅=10, No E.F. is applied;

FIGS. 22A-C depict an example predicted overall jet configurations affected by the E.F., the parameter values: a̅₀̅=0.1, and V̅_̅{̅τ̅1̅}̅=10; FIG. 22A Ē=0.3, FIG. 22B Ē=1, and FIG. 22C Ē=2;

FIG. 23 depicts an example jet of spot-E deposited on a belt moving horizontally to the right without E.F. relative a theoretically predicted centerline, and an experimentally observed centerline, parameter values are a̅₀̅=0.622, V̅_̅{̅τ̅1̅}̅=12.46, and Ē=0;

FIG. 24 depicts an example jet of spot-E deposited on a belt moving horizontally to the right with the E.F. pulling the jet in the opposite direction, parameter values are: a̅₀̅=0.622 and V̅_̅{̅τ̅1̅}̅=12.46. The dimensionless E.F. strengths values used in the theoretical predictions are: Ē=0.1 (orange line), Ē=0.5 (grey line), Ē=1 (yellow line), and Ē=2 (blue line);

FIGS. 25A and 25B depict a schematic of example electrohydrodynamic material deposition system with FIG. 25A having Horizontal electrodes on the dielectric substrate, and FIG. 25B Vertical electrodes mounted on the printhead over the dielectric substrate;

FIGS. 26A-E depict example linseed oil on glass slide subjected to an electric field strength of 1.57 kV/cm., with a surface-aligned electrode configuration of FIG. 26A;

FIGS. 27A-C depict a schematic of an example electrohydrodynamic material deposition system throughout notable positions of the print (not to scale), FIG. 27A Needle directly above digital location as the droplet is ejected, FIG. 27B While the needle is not printing, electrodes centered over the area of interest are charged to create the horizontal electric field strength of 1.57 kV/cm. Area of interest is tunable via electrode spacing; here it was 5.08 cm., and FIG. 27C All printing motion and electrical processes have stopped; the finished line or trace having experienced the effect of the applied electric field and subsequently coalesced;

FIGS. 28A-D depict printed line with droplet of linseed oil on glass at spacing above the thresholds for self-coalescence: FIG. 28A before applied E.F., FIG. 28B after the E.F. strength of 1.57 kV/cm has been applied and droplet coalescence achieved, FIG. 28C Spot-E printing on Mylar at the threshold of self-coalescence resulting in a randomly discontinuous trace, and FIG. 28D after the E.F. strength of 1.57 kV/cm has been applied, the results reveal a smoother continuous trace;

FIG. 29 depicts example surface waviness of printed linseed oil with selective droplet spacing;

FIGS. 30A-D depict example printed arrays of linseed oil on glass used to for electrically-driven film formation: FIG. 30A Before the E.F. was applied (case 1), FIG. 30B the corresponding image after the E.F. has been applied in case 1, FIG. 30C Before the E.F. was applied (case 2), and FIG. 30D the corresponding image after the E.F. has been applied in case 2;

FIGS. 31A and 31B depict electrowetting in conjunction with motion control of droplets;

FIG. 32A depicts a schematic of an example electrohydrodynamic material deposition system, FIG. 32B Details of droplet deposition and polarity;

FIG. 33 depicts an example image of an electrode array on PCB (Printed Circuit Board) board with the electrode size of 3 mm and an insulation distance of 0.15 mm, an insulation layer is invisible in this image;

FIG. 34 depicts a SEM image of an example sonicated ink (a CNT suspension) dried under the effect of 1 kV electric potential difference at ambient temperature;

FIG. 35 depicts flow curves of different example inks measured using a rotational viscometer Brookfield DV II+ Pro;

FIG. 36 depicts example shear stresses corresponding to the flow curves of FIG. 35;

FIG. 37 depicts results of an example uniaxial elongation experiment, which revealed non-Newtonian behavior;

FIGS. 38A-E depict motion of an example sessile droplet from a grounded electrode (left) to the high-voltage electrode (right) accompanied by a stick-slip motion and the corresponding oscillations (surface waves on the droplet surface) at 8 kV, an inter-electrode distance is 12 mm;

FIGS. 39A-D depict example droplet splitting with a tiny residual droplet staying in the middle, both bigger droplets move to different electrodes;

FIGS. 40A-C depict PEO droplets: FIG. 40A The original shape of the droplet (the aqueous 10 wt % PEO solution; PEO Mv=200,000 Da), FIG. 40B Deformed droplet, as well as FIG. 40C the final position of the droplet. During droplet motion it acquires a teardrop shape and forms a tail shaped like a cone;

FIGS. 41A-D depict an example stick and release of a water droplet on a vertical wall: panel (a) shows the droplet stick to the wall, (b) the moment of release, and (c) and (d) the sliding motion of the droplet on the wall;

FIGS. 42A and 42B depict an example of a pendent droplet, which is not large enough to detach from the surface. (a) Droplet shape and contact angle without electric field, (b) enhanced surface wetting and attraction of the droplet to the surface due to the electric field;

FIGS. 43A-C depict an example of a pendant droplet sustained by the electric field (a). After switching the electric field off, the droplet detaches from the surface (b), and a residual droplet sticks to the surface (c);

FIGS. 44A-E depict upward motion of a water droplet with a volume of about 0.3 μl on parafilm and silicone oil.

FIG. 45 depicts a blister configuration photographed in the experiment with parameters of Eq. (86) superimposed.

FIG. 46A depicts an example principle of blister testing setup, including the specimen substrate, Kapton cap, electrodes, as well as the through hole for the shaft in blister test;

FIG. 46B depicts an image of an example Kapton cap on ceramic board ready for 3D printing;

FIG. 47 depicts stress-strain curves for Spot-E at three different extension rates, the inset shows the small-strain range (encompassed by dashed circle) where Young's modulus of 12 MPa was measured;

FIG. 48 depicts a sketch of an example electrohydrodynamic material deposition system using a modified Nordson printer with an electrode location shown;

FIG. 49 depicts a typical load-extension curve measured in the blister test of spot E, Region I corresponds to the delamination of the Kapton tape, and region II—to the blister formation, the extension of 2.5 mm marked by an asterisk is used in data processing;

FIGS. 50A-C depict example blister formation of Spot E on (a) sandblasted glass, (b) chemically etched glass, and (c) ceramic. In all cases the shaft extension is 2.5 mm. The blister borders are highlighted by red circles;

FIG. 51 depicts an example graph 5100 depicts spot-E adhesion energy of a printed material relative to various substrates;

FIG. 52 depicts an example graph 5200 depicts spot-E adhesion energy of a printed material relative to various substrates with E.F. during printing;

FIG. 53 depicts an example graph 5300 depicts EcoFlex adhesion energy of a printed material relative to various substrates;

FIG. 54 depicts an example graph 5400 depicts spot-E adhesion energy of a printed material relative to various substrates with UV light during printing;

FIGS. 55A and 55B depict a side view of an example spot-E layer printed on glass without (a) and with the electric field (b). The line horizontal lines are tangents at the top of each layer. The profile is highly uniform in the case of specimens without electric field (panel a), and non-uniform for specimens printed under with the electric field (panel b);

FIG. 56A depicts a schematic of an example drop on demand (DOD) system;

FIG. 56B depicts an example electrode design without a grounded needle;

FIG. 56C depicts example an electrode design with a grounded needle;

FIG. 57 depicts a schematic of an example high-impedance buffer circuit for use in an electrohydrodynamic material deposition system;

FIG. 58A depicts a schematic of an example print head retrofitted with electrodes;

FIG. 58B depicts a CAD drawing of an example overhang structure (a model confinement) with all dimensions (mm);

FIG. 58C depicts an example trajectory of ink droplets as a modified print head overcomes the problematic printing situation caused by an overhang structure;

FIG. 59 depicts example measured current/voltage characteristics of the inter-electrode gap. The experimental data is shown by symbols spanned by a line;

FIG. 60A depicts an example global view of tear-like droplet just detached from the printing needle;

FIG. 60B depicts a magnified image of tear-like droplet just detached from the printing needle;

FIG. 60C depicts a spherical droplet in the range used for further analysis;

FIG. 60D depicts a magnified image of spherical droplet in the range used for further analysis with magnified droplets in panels FIG. 60B and FIG. 60C visually capture transition from tear-like tail to a perfectly spherical droplet;

FIG. 61A depicts example detaching droplets at the following applied voltages: 3 kV, FIG. 61B depicts 5 kV, and FIG. 61C depicts 6 kV, a printing needle is grounded in all cases;

FIG. 62A depicts an example droplet mass detachment frequency;

FIG. 62B depicts an example imposed volumetric flow rate [with the one calculated using Eq. (93)];

FIG. 62C depicts three different values of an applied voltage (3, 5 and 6 kV) in the case of grounded printing needle;

FIG. 63 depicts example average charge of glycerol droplets found using Eq. (92) and the experimentally measured droplet landing location, charging by ionized air is denoted as (i), whereas direct charging by wire electrode—as (ii);

FIG. 64 depicts an example specific charge of glycerol droplets. Charging by ionized air is denoted as (i), whereas direct charging by wire electrode—as (ii);

FIG. 65 depicts an example charge per unit surface area on glycerol droplets. Charging by ionized air is denoted as (i), whereas direct charging by wire electrode—as (ii);

FIG. 66 depicts example droplet trajectories in the case of charging by ionized air as in FIG. 56B. Experimental data are shown by symbols, the trajectories predicted by Eq. (92)—by straight lines with open symbols corresponding to the listed applied voltages;

FIG. 67 depicts example droplet trajectories resulting from the two different methods of droplet charging: Charging by ionized air is denoted as (i), whereas direct charging by wire electrode—as (ii);

FIG. 68A depicts a schematic of example glycerol droplet locations;

FIG. 68B depicts a photo of an example glycerol sample pattern on a glass substrate printed in minutes;

FIG. 69A depicts a schematic of an example spot-E droplet locations numbered sequentially in printing order, a procedure was repeated twice to achieve a dual-layer print;

FIG. 69A depicts a photo of an example dual-layer spot-E sample pattern printed in minutes;

FIG. 70A depicts a schematic of example spot-E droplet locations printed below a problematic overhang structure (inside a confinement) and numbered sequentially in printing order, lettered subscripts denote specific applied voltages corresponding to different electric field strength, FIG. 70A depicts a backlit photo (taken orthogonal to the x-axis) of spot-E printed below problematic overhang structure comprised of VeroClear RGD-810 photo-resin;

FIG. 71A depicts a photo (taken at about 45° from horizontal) of spot-E printed below the problematic overhang structure (in confinement); and

FIG. 71B depicts a zoomed-out photo revealing an overhang structure with a printed logo inside.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercial feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

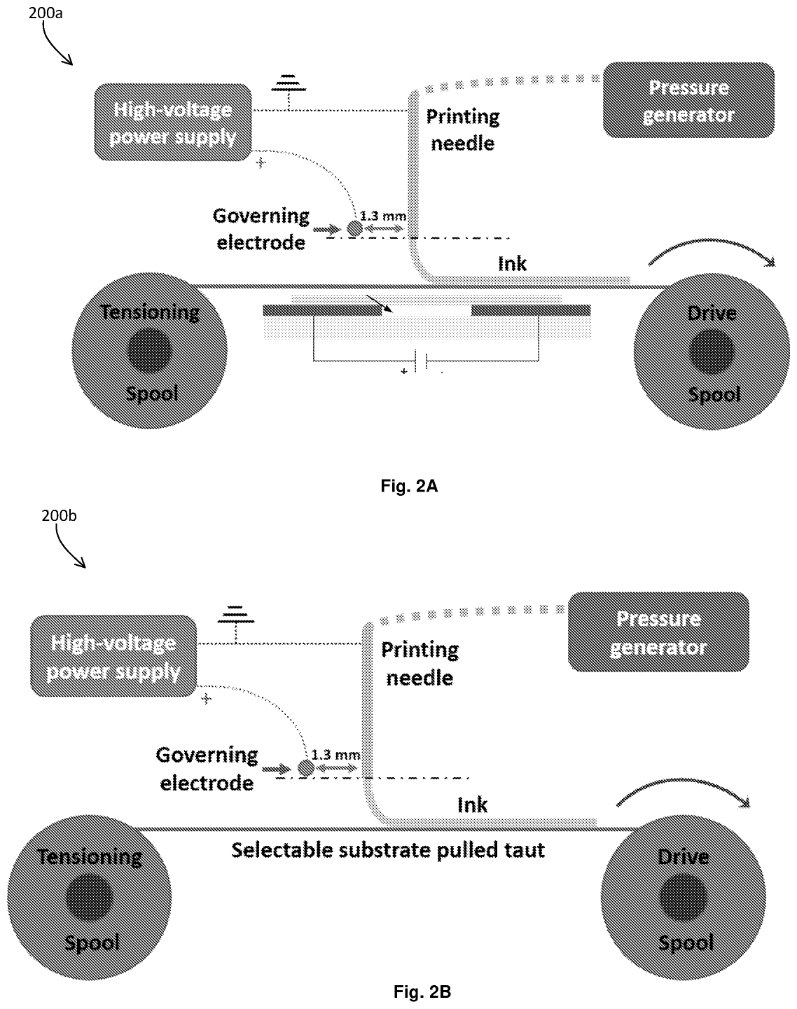

Apparatuses, systems, and methods are provided to address challenges associated with printing speed, resolution, material choices, and limited layer numbers in direct ink writing (DIW) and/or additive manufacturing (AM). For example, a conventional DIW process may be modified with an applied electric field set to pull (or push) an ink jet footprint, on a moving substrate, in a direction opposite to that of relative substrate motion. As described in detail herein, conventional DIW process theory may be modified with an electric field. For example, a governing electrode may be mounted on a print head and, as a result, effects of an associated electric field (E.F.) may not diminish as a build height increases (e.g., example electrohydrodynamic material deposition system of FIG. 2B, etc).

As described in detail herein a coulomb force, resulting from a strategically applied electric field, may, for example, enhance microfluidic systems and derive new products. In particular, being pre-charged by both non-contact and direct methods, low-volume material droplets may be selectively printed, creating multi-layered patterns on an associated substrate. Print speed may be valued within AM on a similar magnitude as resolution and cost. In addition to a strategically applied electric field, polymers may be added to a dispensed material to increase speed of EHD line-printing to, for example, affect jet behavior. Associated results are demonstrated with adding polymer to ink to, for example, increase a printing speed in a specific case from 10 to 50 mm/s for continuous line-printing.

Alternatively, or additionally Ink may be, for example, pulled and/or deflected from a nozzle by applying a plurality of dynamically varying E.F.s. For example, a first E.F. may be applied between a material dispensing needle and an associated substrate, and may facilitate DIW with electrohydrodynamic (EHD) jetting. EHD may, for example, electrostatically pull material from a needle to an associated substrate as the liquid meniscus shapes into a modified “Taylor cone” with a jet issued from a needle tip. EHD jetting may be, for example, capable of printing sub-micrometer features from nanometer-sized jets with minimal risk of clogging. Further facilitating this process with two additional electrodes placed between the needle and substrate, individual droplets and/or a jet may be electrostatically deflected to, for example, create sub-micrometer features with translating print speeds up to 500 mm/s. Because the EHD process may depend on a distance between an electrically charged nozzle and a grounded electrode beneath the substrate, effects of the E.F. may diminish as build height increases.

In the context of DIW process, the apparatuses, systems, and methods of the present disclosure may determine an influence of an electric field on an adhesion of several commonly used and commercially available materials deposited on different substrate materials including: glass, Kapton tape, ceramics, hydrophobic surfaces, etc. An electric field may be applied, for example, after or during different stages of the printing process, and the results may be compared to reference specimens. For example, a blister test may be employed to measure adhesion energy, which may characterize a bond between different materials. The apparatuses, systems, and methods of the present disclosure may enhance adhesion between different materials by means of an electric field, thereby, improving quality of associated printed items.

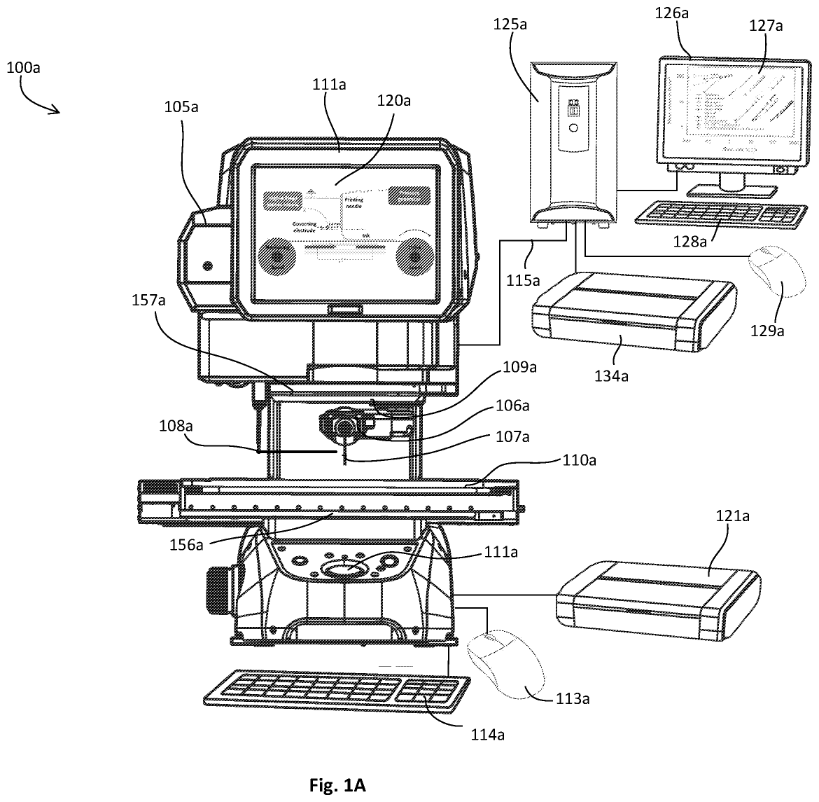

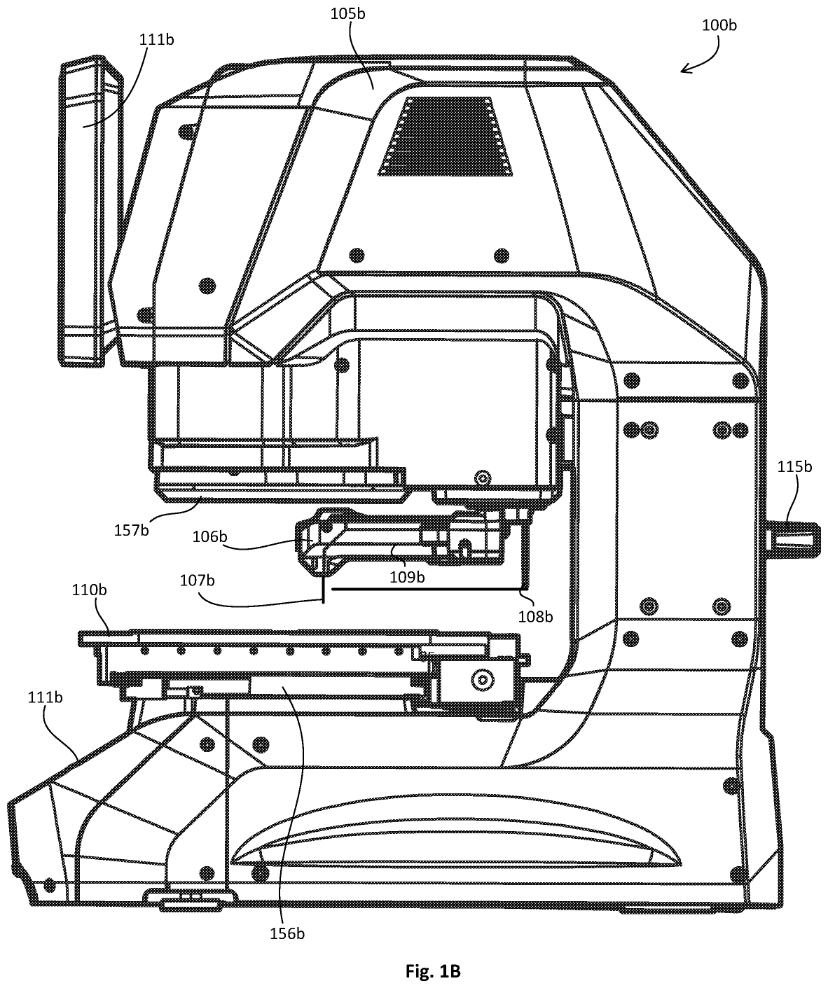

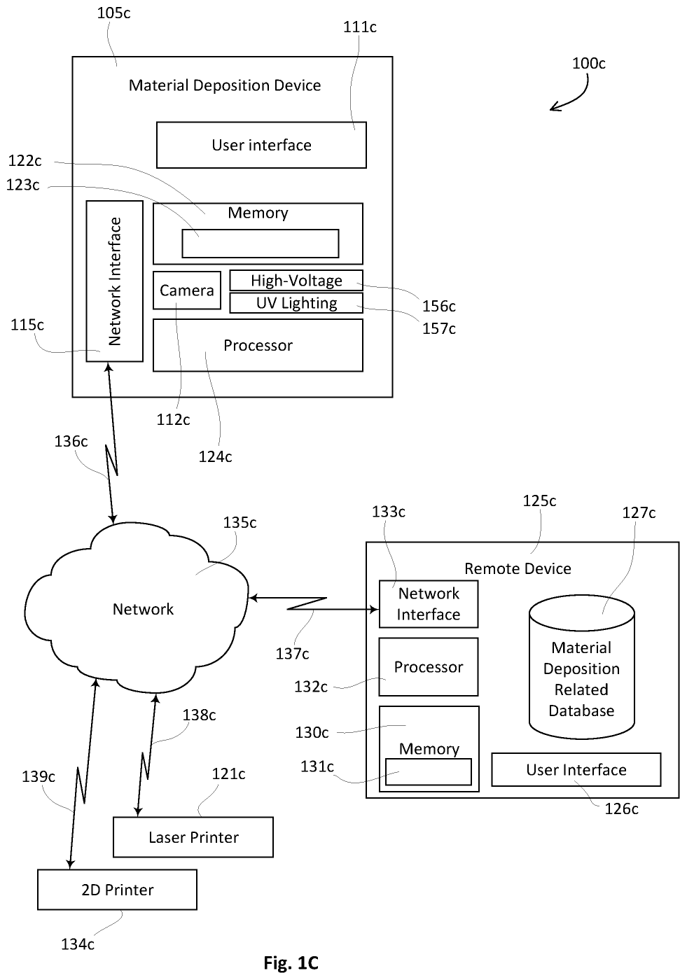

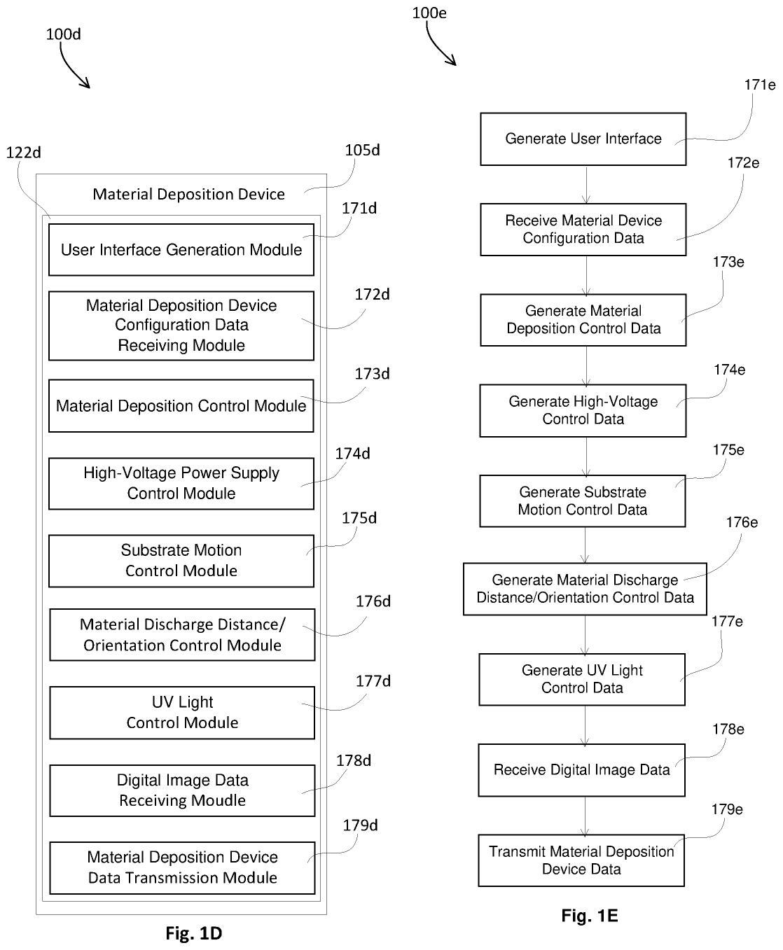

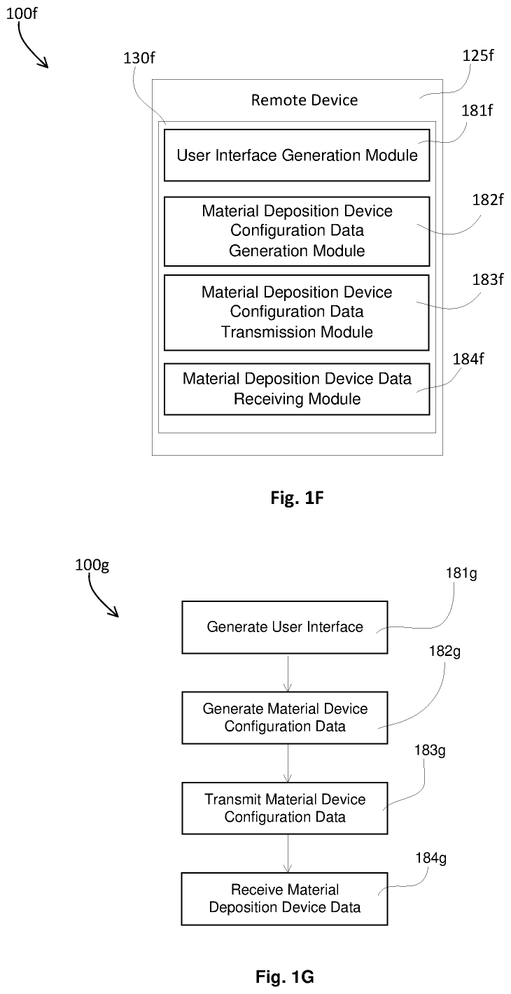

Turning to FIGS. 1A-G, an electrohydrodynamic material deposition system 100a-g may include an electrohydrodynamic material deposition device 105a-d communicatively interconnected to a remote computing device 125a,c,f via a network 115a,b. As described in detail herein, the electrohydrodynamic material deposition device 105a-d may be, for example, configured to implement a DIW process and/or an AM process. Other implementations of the system 100a may be directed to manufacturing various products using a DIW process and/or an AM process. The electrohydrodynamic material deposition device 105a-f may include at least one user interface 111a-c, 113a, 114a, and a printer 121a. A user interface 111a-c may include, for example, a display 120a associated with operation of the electrohydrodynamic material deposition device 105a-d.

The electrohydrodynamic material deposition device 105a-d may include a printer head 106a,b having a nozzle 107a,b and at least one first electrode 108a,b mounted to a dielectric material 109a,b. The at least one first electrode 108a,b may be, for example, positioned proximate the nozzle 107a,b on a nozzle side of an associated substrate 110a,b. The electrohydrodynamic material deposition device 105a-f may also include at least one second electrode 156a,b. The at least one second electrode 156a,b may be, for example, positioned proximate the substrate 110a,b on a side of the substrate 110a,b opposite the nozzle 107a,b. The electrohydrodynamic material deposition device 105a-d may include at least one UV light emitter 157b. The UV light emitter may be configured to, for example, cure a UV curable material dispensed from the nozzle 107a,b.

The remote device 125a,c,f may include at least one user interface 126a,c, 128a, 129a and a printer 134a,c. A user interface 126a may include, for example, a display 127a associated with operation of the electrohydrodynamic material deposition device 105a-d.

With additional reference to FIG. 1C, the electrohydrodynamic material deposition device 105a-d may include a memory 122c and a processor 121c for storing and executing, respectively, a module 123c. The module 123c, stored in the memory 122c as a set of computer-readable instructions, may be related to an application for implementing at least a portion of the electrohydrodynamic material deposition system 100a-g. As described in detail herein, the processor 124c may execute at least a portion of the module 123c to, among other things, cause the processor 124c to receive, generate, and/or transmit data (e.g., electrohydrodynamic material deposition data, etc.) with the remote device 125a,c,f, and/or the printer 121a,c.

The electrohydrodynamic material deposition device 105a-d may also include a user interface 111a-c which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 111a-c may exhibit a user interface display which may, for example, depict a user interface for implementation of at least a portion of the electrohydrodynamic material deposition system 100a-g. The electrohydrodynamic material deposition device 105b may include at least one digital imaging device 106c, a high-voltage power supply 156c and a UV light source 157c.

The electrohydrodynamic material deposition device 105a-d may also include a network interface 115a-c configured to, for example, facilitate communications between the electrohydrodynamic material deposition device 105a-d and the network 135c via any wireless communication network 136c, including for example: a wireless LAN, MAN or WAN, WiFi, TLS v1.2 WiFi, the Internet, or any combination thereof. Moreover, a electrohydrodynamic material deposition device 105a-d may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

The remote device 125a,c,f may include a memory 130c and a processor 132c for storing and executing, respectively, a module 131c. The module 131c, stored in the memory 130c as a set of computer-readable instructions, may be related to an application for implementing at least a portion of the electrohydrodynamic material deposition system 100a-g. As described in detail herein, the processor 132c may execute at least a portion of the module 131c to, among other things, cause the processor 132c to receive, generate, and/or transmit data (e.g., electrohydrodynamic material deposition data, etc.) with the network 135c, the electrohydrodynamic material deposition device 105a-d, and/or the printer 121a,c.

The remote device 125a,c,f may also include a user interface 126a,c which may be any type of electronic display device, such as touch screen display, a liquid crystal display (LCD), a light emitting diode (LED) display, a plasma display, a cathode ray tube (CRT) display, or any other type of known or suitable electronic display along with a user input device. An associated user interface may exhibit a user interface display 127a related to, for example, the electrohydrodynamic material deposition device 105a-d.

The remote device 125a,c,f may also include a material deposition related database 127c and a network interface 133c. The biological indicator inactivity database 127b may, for example, store biological indicator related data, etc. The network interface 133b may be configured to facilitate communications, for example, between the remote device 125b and the network 135b via any wireless communication network 137b, including for example: TLS v1.2 Cellular, CSV/JSON Output, TLS v1.2 REST API, a wireless LAN, MAN or WAN, WiFi, TLS v1.2 WiFi, the Internet, or any combination thereof. Moreover, a remote device 125b may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

With additional reference to FIG. 1D, the material deposition device 105a-d may include a user interface generation module 171d, a material deposition device configuration data receiving module 172d, a material deposition device control module 173d, a high-voltage power supply control module 174d, a substrate motion control module 175d, a material discharge nozzle-to-substrate distance and orientation control module 176d, a UV light control module 177d, a digital image data receiving module 178d, and a material deposition device data transmission module 179d, for example, stored on a memory 122c,d as a set of computer-readable instructions. In any event, the modules 171d-179d may be similar to, for example, the module 123c of FIG. 1C.

With additional reference to FIG. 1E, a method of operating a material deposition device 100e may be implemented by a processor (e.g., processor 124c of FIG. 1C) executing, for example, at least a portion of the module 123c of FIG. 1C or a portion of the modules 171d-179d. In particular, processor 124c may execute the user interface generation module 171d to, for example, cause the processor 124c to generate a user interface display 120a (block 171e). Any given user interface display may, for example, enable an individual to operate an electrohydrodynamic material deposition system 100a-g.

The processor 124c may execute the material deposition device configuration data receiving module 172d to, for example, cause the processor 124c to receive material deposition device configuration data (block 172e). For example, the processor 124c may receive material deposition device configuration data from a remote device 125a,c,f.

The processor 124c may execute the material deposition device control module 173d to, for example, cause the processor 124c to control the electrohydrodynamic material deposition device 105a-d (block 173e). The processor 124c may execute the high-voltage power supply control module 174d to, for example, cause the processor 124c to control the high-voltage power supply 156c (block 174e). The processor 124c may execute the substrate motion control module 175d to, for example, cause the processor 124c to control substrate motion (block 175e).

The processor 124c may execute the a material discharge nozzle-to-substrate distance and orientation control module 176d to, for example, cause the processor 124c to control a nozzle-to-substrate distance and/or orientation (block 176e). The processor 124c may execute the UV light control module 177d to, for example, cause the processor 124c to control the UV light157c (block 177e). The processor 124c may execute the digital image data receiving module 178d to, for example, cause the processor 124c to receive digital image data (block 178e). For example, the processor 124c may receive digital image data from camera 106b. The processor 124c may execute the material deposition device data transmission module 179d to, for example, cause the processor 124c to transmit material deposition device data (block 179e). For example, the processor 124c may transmit material deposition device data to a remote device 125a,c,f.

With additional reference to FIG. 1F, the remote device 125a,c,f may include a user interface generation module 180f, a material deposition device configuration data generation module 181f, a material deposition device configuration data transmission module 182f, and a material disposition device data receiving module 183f, for example, stored on a memory 130c,f as a set of computer-readable instructions. In any event, the modules 180f-183f may be similar to, for example, the module 131c of FIG. 1C.

With additional reference to FIG. 1E, a method of operating a remote device 100f may be implemented by a processor (e.g., processor 132c of FIG. 1C) executing, for example, at least a portion of the modules 181f-184f of FIG. 1F. In particular, processor 132c may execute the user interface generation module 180f to, for example, cause the processor 132c to generate a user interface display 127a (block 181g). Any given user interface display may, for example, enable an individual to operate an electrohydrodynamic material deposition system 100a-g.

The processor 132c may execute the material deposition device configuration data generation module 181f to, for example, cause the processor 132c to generate material deposition device configuration data (block 182g). The processor 132c may execute the material deposition device configuration data transmission module 182f to, for example, cause the processor 132c to transmit material deposition device configuration data (block 183g). For example, the processor 132c may transmit material deposition device configuration data to an electrohydrodynamic material deposition device 105a-d

The processor 132c may execute the material disposition device data receiving module 183f to, for example, cause the processor 132c to receive material deposition device data (block 184g). For example, the processor 132c may recieve material deposition device data from an electrohydrodynamic material deposition device 105a-d.

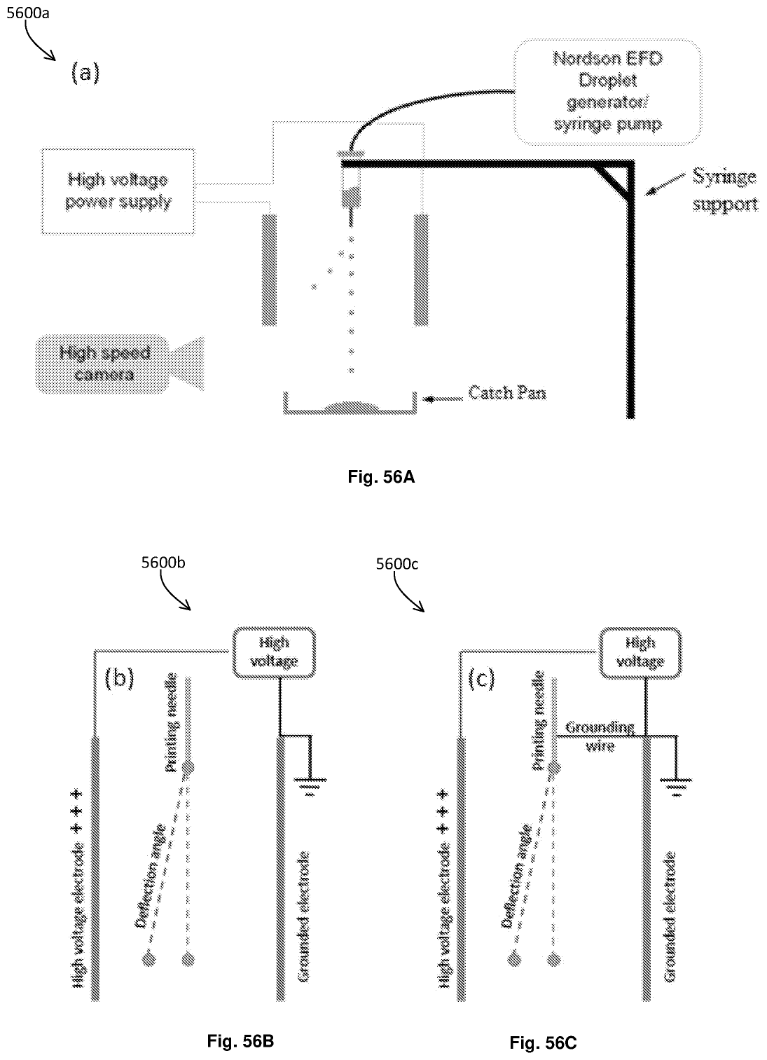

With reference to FIG. 2A, an electrohydrodynamic material deposition system 200a to perpendicularly dispense a circular jet of material onto a horizontally translating substrate may include a mechanism to translate the substrate beneath the nozzle and the governing electrode. The electrohydrodynamic material deposition system 200a may be similar to, for example the electrohydrodynamic material deposition system 100a-d of FIGS. 1A-D. FIG. 2A depicts a schematic diagram of the experimental setup realizing perpendicular dispensing of a circular jet onto a translating substrate and facilitating smooth ink deposition by means of the E.F. shaped by the governing electrode. This electrohydrodynamic material deposition system 200a may mimic one of the degrees of freedom found in dispensing robots and ink-jet systems. This electrohydrodynamic material deposition system 200a may be used, for example, to facilitate video recording of the writing process as illustrated in the electrohydrodynamic material deposition systems 3200a, 5600a of FIGS. 32A and 56A, respectively.

A high-voltage power supply 156b may provide a ground to the printing needle while it positively charges the governing electrode placed behind the needle relative to the direction of the substrate motion. This governing electrode would always pull the ink in the direction opposite to that of the substrate motion. To generate a driving pressure, a commercial pressure controller (e.g., a Nordson Ultimus I, etc.) supplemented with 27, 30, 32 and 34-gauge stainless steel printing needles is used in this setup. This system allowed for a well-defined pressure pulse (1-80 psi) to be applied to the ink within the needle for a specific time. The governing electrode was produced from a 0.5 mm copper wire bent into a position not to extend below the printing needle edge. To explore the effect of the ink viscosity in the DIW process, a water jet is compared to a more viscous jet comprised of a solution of 60 wt % of sugar in water. A commercial DIW ink (Spot-E) was purchased from Spot-A materials to explore the effect of the E.F. Voltages applied to the governing electrode were in the 2-4 kV range with the E.F. strength being limited to ˜3 kV/mm by the dielectric breakdown of air. After initial experiments, the setup depicted in FIG. 1 was retrofitted to a DIW (Direct Ink Writing) automated dispensing system and shown in FIG. 2A.

Turning to FIG. 2B, an electrohydrodynamic material deposition system 200b to perpendicularly dispense a circular jet of material onto a horizontally translating substrate may include a mechanism to translate the substrate beneath the nozzle and the governing electrode. The electrohydrodynamic material deposition system 200b may be similar to, for example the electrohydrodynamic material deposition system 200a except the electrohydrodynamic material deposition system 200b does not include a second electrode 156a,b.

With reference to FIGS. 3A and 3B, retrofitted DIW (Direct Ink Writing) automated dispensing systems 300a,b may be setup utilizing perpendicular dispensing of a circular material jet onto a translating substrate 310a,b enhancing deposition by means of the applied E.F. One 0.5 mm copper electrode 308a,b may be attached to a custom dielectric printhead 106a,b placing a needle 307a,b inline with the electric field. The systems 300a,b may be configured to implement ultra-fast line printing. For example, a simple pattern with 10 cm in length may be printed with 5 replicates in random order both with and without the applied E.F. at the line speed in the 50-500 mm/s range. A continuous filament extrusion and deposition may be captured using, for example, a high-speed CCD camera (e.g., a Phantom V210, etc.) using back-light shadowgraphy. The systems 300a,b may also include a ground wire 340a,b, a processor 324a,b, a material dispenser 343a,b, a syringe 341a,b, and a material stage 342a,b.

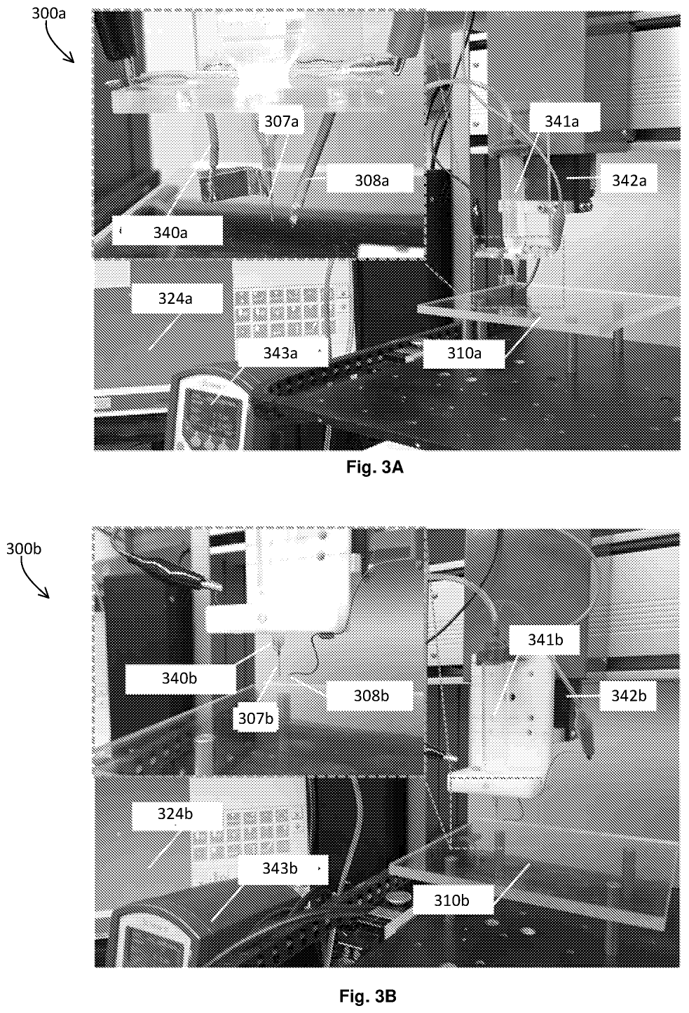

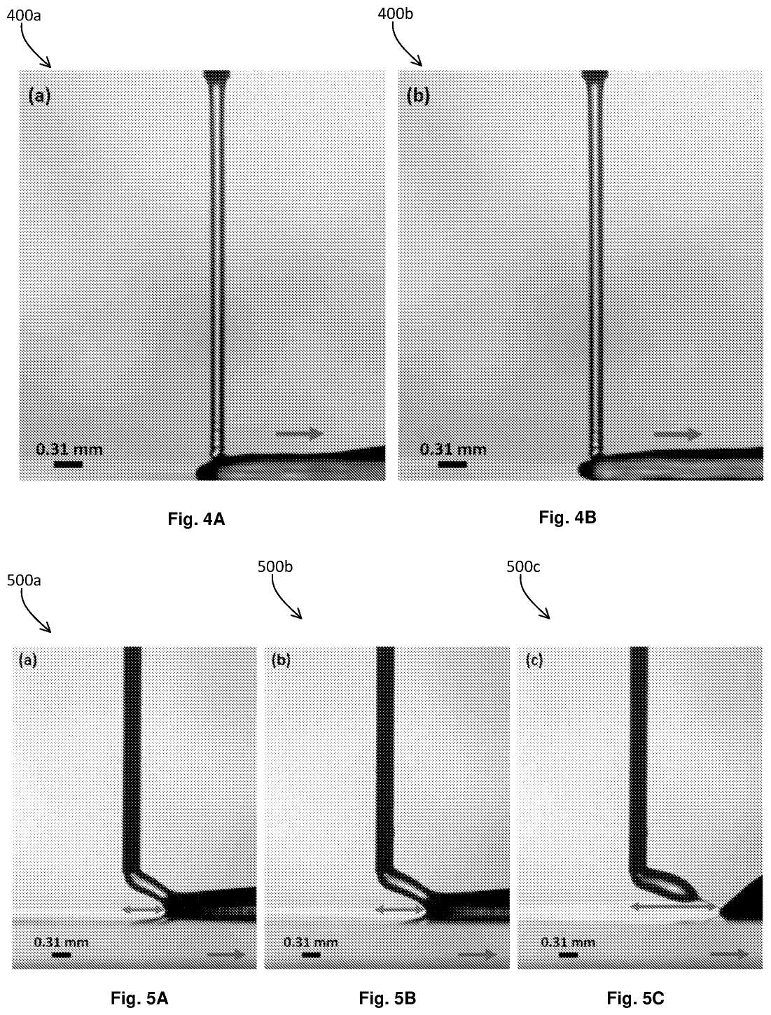

Turning to FIG. 4A, water may be dispensed at ˜1030 mm/s onto a Mylar belt (0.019 mm in thickness), 20 mm/sec. With additional reference to FIG. 4B, water may be dispensed on a mylar (polyethylene terephthalate) belt, 100 mm/sec. Mylar may be partially wettable by water, with the contact angle of ˜35-40°. In DIW, the ink viscosity may often be several orders of magnitude higher than that of water. Accordingly, a model fluid, a solution of 60 wt % of sugar in water may be prepared (the viscosity of 7.81 cP at 21.1° C.). With an increase in viscosity, there may no longer be lamellae advancement against the direction of the belt motion even at the lowest belt speed. With all variables held constant except the belt velocity, FIGS. 4A and 4B depict dispensing of water at an estimated 1030 mm/s with belt speeds of 20 mm/s (FIG. 4A) and 100 mm/s (FIG. 4B). While a slight decrease in the advancement of lamella (the jet footprint) against the substrate motion is noticed at the increased belt speed, the low viscosity of water (0.97 cP at 21.1° C.) allows a relatively easy spreading and wettability-driven advancement of the three-phase contact line against the direction of the belt motion.

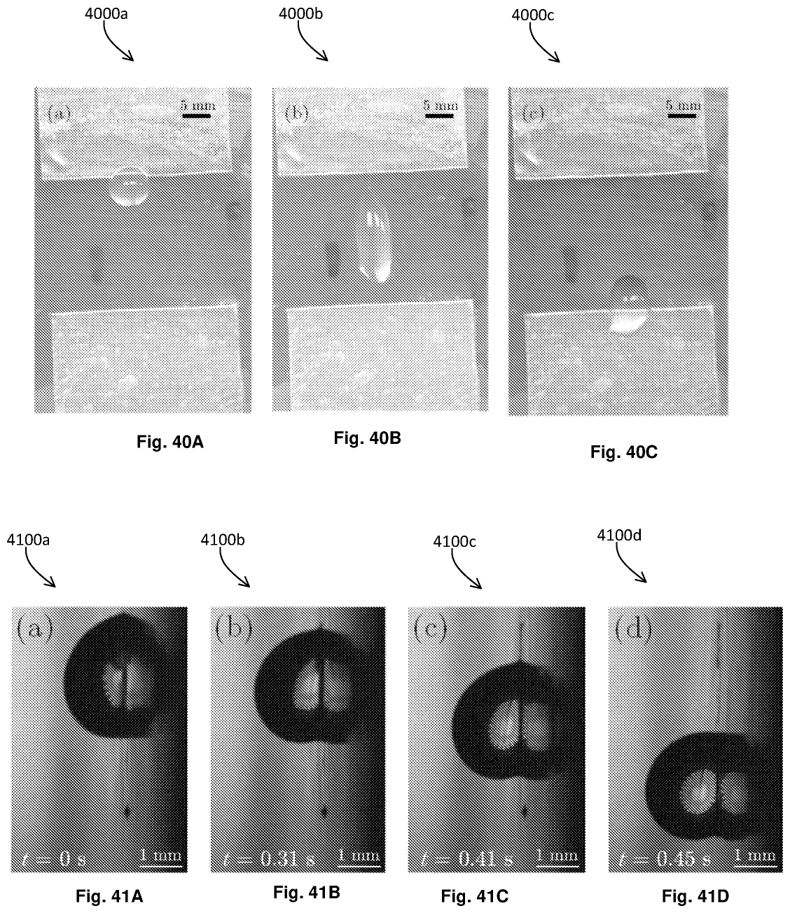

With reference to FIGS. 5A-C, steady-state locations of a three-phase contact line at two different belt speeds is illustrated: 20 mm/sec in FIG. 5A and 40 mm/sec in FIG. 5B. FIG. 5C the transient state, with the jet being stretched by the belt travelling at 60 mm/sec until the trace line breaks up resulting in discrete droplets. FIGS. 5A-C depict a solution of 60 wt % of sugar in water issued at ˜380 mm/s: FIG. 5A depcits 20 mm/sec belt speed; steady state. FIG. 5B 40 mm/sec belt speed; steady state. FIG. 5C depicts 60 mm/sec belt speed; transient state resulting in discrete droplet formation on the belt. Blue arrows show the displacement of the triple line from the jet axis. To investigate the influence of the E.F. on the jet, a fixed belt velocity, standoff distance, and pressure were used in the following experiments. Without the electric field, the belt wetting by the impacting jet is mainly affected by the belt speed and the flow rate in the jet (cf. sub-section 3.2). The jet impacts onto the belt and forms a liquid path, which also might break up into individual drops under the action of surface tension. The applied E.F. affects the jet behavior, as well as the wetting of the surface. The jet and advancing triple line are pulled toward the governing high-voltage electrode, thus, facilitating lamella motion against the direction of the belt motion. For a high electric field strength, the viscous solution readily spreads over the belt against the direction of its motion reducing and/or completely eliminating the offset between the triple line and the jet axis (cf. FIG. 5C). This diminishes dramatically the propensity to formation of discrete droplets. The electrically-facilitated holding of the triple line near the jet axis allows higher belt speeds at steady-state operation, i.e., allows an increase in the printing velocity compared to the comparable control case without E.F.

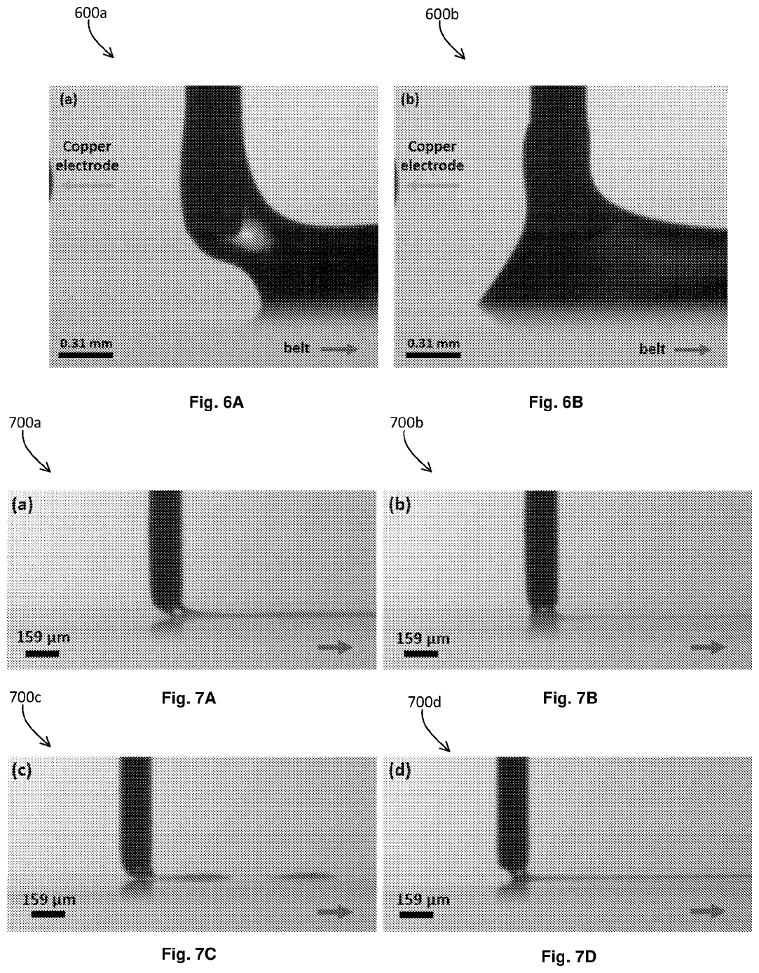

Turning to FIGS. 6A and 6B, a 60 wt % sugar solution in water issued from the nozzle at ˜380 mm/s. FIG. 6A 20 mm/s belt speed, no E.F.—0 kV FIG. 6B 20 mm/s belt speed, voltage of 2.5 kV. To further explore the effect of the E.F. on DIW, a commercial ink Spot-E purchased from from Spot-A materials was loaded into the barrel syringe and extruded through a 34-gauge needle at 30 psi. A relatively smooth Mylar (polyethylene terephthalate) ribbon with a surface roughness estimated Rₐ≤10 μm was loaded into the belt drive, as in FIGS. 4A-6B. FIGS. 6A and 6B depict E.F.-facilitated pulling of the lamella (jet footprint) triple line against the direction of the belt motion by electrowetting. Such a new steady-state location of the triple line slightly before the jet axis rather than behind it significantly stabilize the direct writing process using the 60 wt % sugar solution in water is extruded through a 30-gauge blunt needle. Both FIGS. 6A and 6B depict steady-state configurations, with the only difference being the applied E.F. with a strength of 2.5 kV/mm to the governing electrode in FIG. 6B. It is clear that in the reverse motion of a dispensing robot the E.F. pulls the jet and lamella triple line in the printing direction eliminating the drag-off distance, which seen in FIG. 5A and eliminated in 4B.

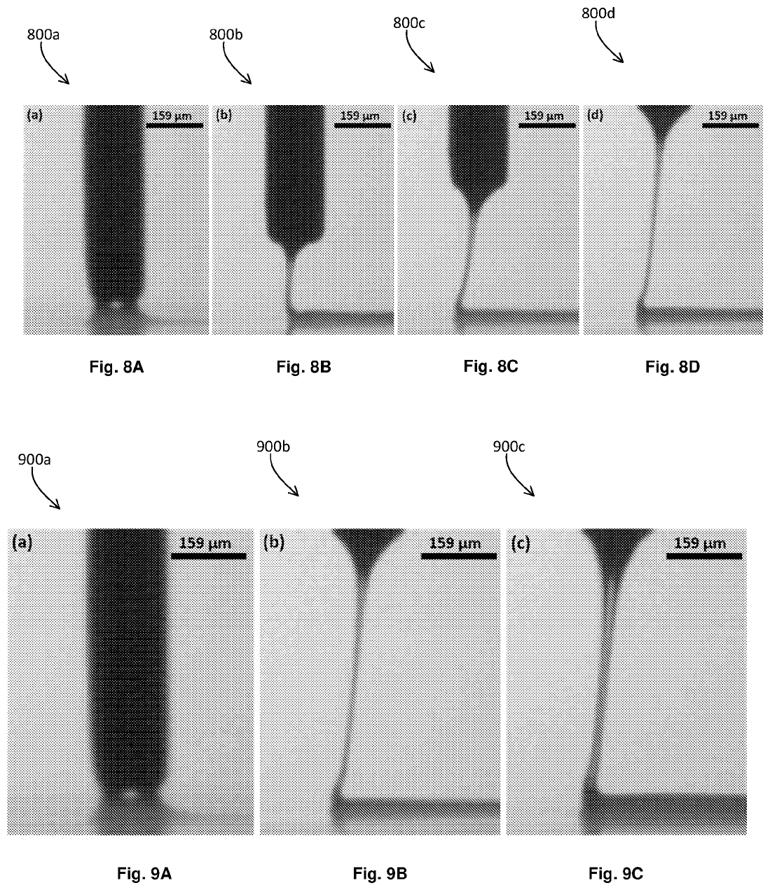

With reference to FIGS. 7A-D, spot-E printed at ˜2 mm/s from the nozzle onto Mylar belt at two different belt speeds without and with the E.F. of 2.5 kV applied to the governing electrode (not seen shown in the shapshots). FIG. 7A Spot-E, 40 mm/s belt speed, 0 kV. FIG. 7B Spot-E, 40 mm/s belt speed, 2.5 kV. FIG. 7C Spot-E, 80 mm/s belt speed, 0 kV. FIG. 7D Spot-E, 80 mm/s belt speed, 2.5 kV. With print improvement achieved and recorded at S.D. less than or equal to the diameter of the printing nozzle (cf. FIGS. 5 and 6), the effect of the E.F. on DIW at elevated S.D. was explored. FIGS. 8A-D shows a series of snapshots taken at different S.D. of 80, 240, 380 and 600 μm, respectively. The results show that a strategically applied E.F. would allow a DIW machine printing at the surface to lift its needle and clear an obstacle without disturbing an intact-line printing. This demonstration of reduction of DIW sensitivity to S.D. is an associated benefit of electrowetting. FIG. 7A depicts an intact spot-E trace line may be printed at 4 cm/s with no applied electric field applied, albeit the drag-off distance is large. The application of the E.F. (2.5 kV/mm) in FIG. 7B reveals a similar trend to that observed with the 60 wt % sugar/water solution, i.e., reduction of the drag-off distance accompanied by a smooth steady-state print. Doubling the belt speed to 8 cm/s, FIG. 7C reveals a problematic printing state where the trace line fails to stay intact, and discrete puddles are left on the surface of the Mylar ribbon. FIG. 7D confirms the intact-line printing at this speed is achievable with the addition of the E.F. of 2.5 kV/mm.

Turning to FIGS. 8A-D, spot-E may be extruded at ˜2 mm/sec from 34-gauge needle at 30 psi with a 40 mm/s belt speed and 2.5 kV applied voltage at the governing electrode (not seen in the snapshots). (a) S.D.˜80 μm e. (b) S.D.˜240 μm. (c) S.D.˜380 μm. (d) S.D.˜600 μm. While the width of the trace line from a DIW machine is most often on the same order of magnitude as the I.D. of the printing needle, the ability to raise the needle if an E.F. is applied, allows DIW printers to reduce their trace width compared to a trace line printed at the same flowrate and no E.F. applied.

With reference to FIGS. 9B and 9B, a change in a trace line thicknesses may result from a change in the S.D., while FIGS. 9B and 9C show the effect of an increased flow rate as the driving pressure was increased from 30 to 60 psi at the same S.D. FIGS. 9A-C Spot-E extruded from 34-gauge needle with a 40 mm/s belt speed and 2.5 kV applied voltage at the governing electrode (not seen in the snapshots). FIG. 9A S.D. ˜80 μm, 30 psi, ˜2 mm/s. FIG. 9B S.D.˜600 μm, 30 psi, ˜2 mm/sec. FIG. 9C S.D.˜600 μm, 60 psi, ˜4 mm/s. In DIW prints, the standoff distance between the needle and substrate are held to a high tolerance to avoid printing defects and failures. Typically in DIW, the S.D. throught the print varies by less than 10% of the original S.D. set at the beginning of printing. In contrast, present research explored extreme cases. By deflecting the Mylar ribbon on the belt-drive apparatus, an abnormally large S.D. deviation was administered during the print. FIGS. 9A-C show three sequential snapshots corresponding respectively to before, at and after the obstacle. It is seen that even with a relatively large variation in S.D. (which corresponds to the case of rough surfaces), a continuous and uniform trace was deposited on the translating belt in all the three cases.

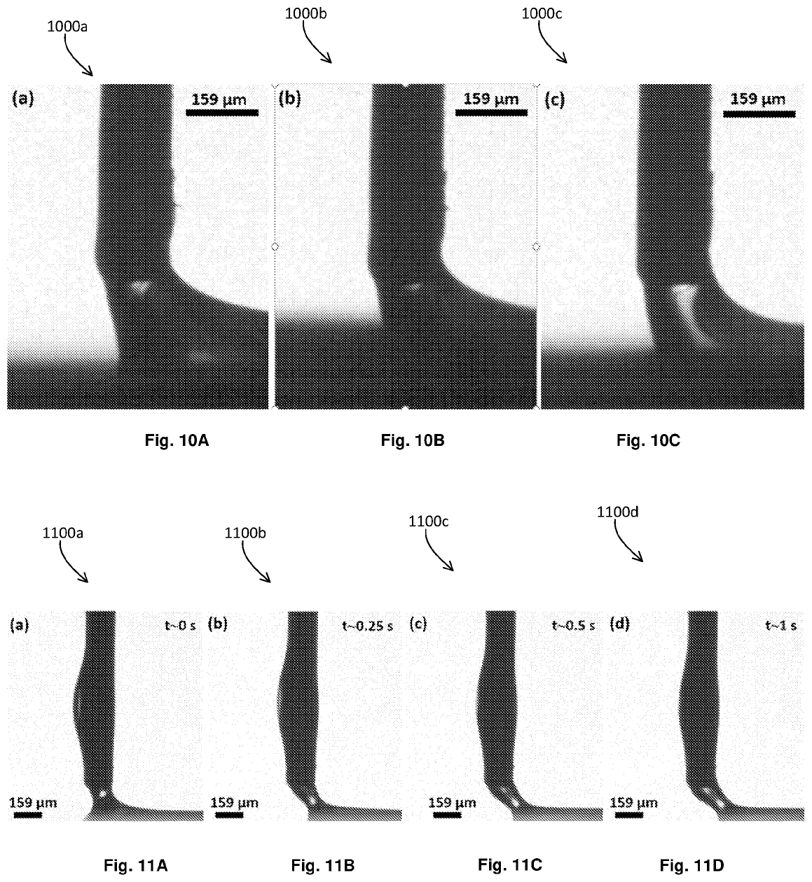

Turning to FIGS. 10A-C, spot-E may be extruded at ˜2 mm/s from 34-gauge needle with the 80 mm/s belt speed, 30 psi and 2.5 kV applied voltage at the governing electrode (not seen in the snapshots). FIG. 10A before the obstacle, FIG. 10B at the obstacle, and FIG. 10C after the obstacle.

With reference to FIGS. 11A-D, transient effects accompanying turning off an E.F. in the case of spot-E ink DIW on a Mylar belt is illustrated. FIG. 11A depicts an initial time moment when the electric potential was turned off at t≈0 s. FIG. 11B depicts development of a drag-off distance already at t≈0.25 s. Then, at t≈0.5 s, the triple line of the lamellar footprint of the jet leading already swept by the moving belt quite significantly, reaching a final steady-state position at t≈1 s. FIGS. 11A-D depict a Spot-E extruded at ˜2 mm/s onto Mylar belt moving at 20 mm/s from 34-gauge needle, 30 psi. (a) t≈0 s (the moment when the E.F. of 2.5 kV/mm was turned off) f. (b) t≈0.25 s. (c) t≈0.5 s. (d) t≈1 s. Several woven substrates comprised of both polymer and natural fibers were also tested, to evaluate the benefits of the applied E.F. for printing on varied super-rough surfaces which are traditionally impossible to print ink on using DIW technologies. The surface roughness for the three belts of these types was relatively high. For the polyester (PTA) ribbon, the surface roughness Rₐ was ˜200 μm. At 97× magnification,

Turning to FIGS. 12A-C, spot-E may be extruded at ˜15 mm/s onto polyester (PTA) belt (0.35 mm thickness) from 32-gauge needle, at the 20 mm/s belt speed, 45 psi. FIG. 12A View of bundled fibers at 97× magnification. FIG. 12B Failed printing state without E.F. applied. FIG. 12C 2.5 kV/mm voltage applied to the governing electrode (out of view in panels b and c). The woven cotton belt is further tested as a substrate. It has an even higher surface roughness with Rₐ≈˜360 μm, which is almost impossible to print inks on using the conventional DIW technologies reported in literature. FIG. 12A depicts individual fibers bundled and woven creating a much rougher PTA surface than the Mylar belt seen in FIGS. 4A-11D. FIG. 12B captures a failed print as the ink breaks up into unconnected droplets due to the insufficient wetting on this super-rough substrate. By applying 2.5 kV/mm to the governing electrode, FIG. 12C shows a continuous trace being printed on PTA with an almost zero drag-off distance.

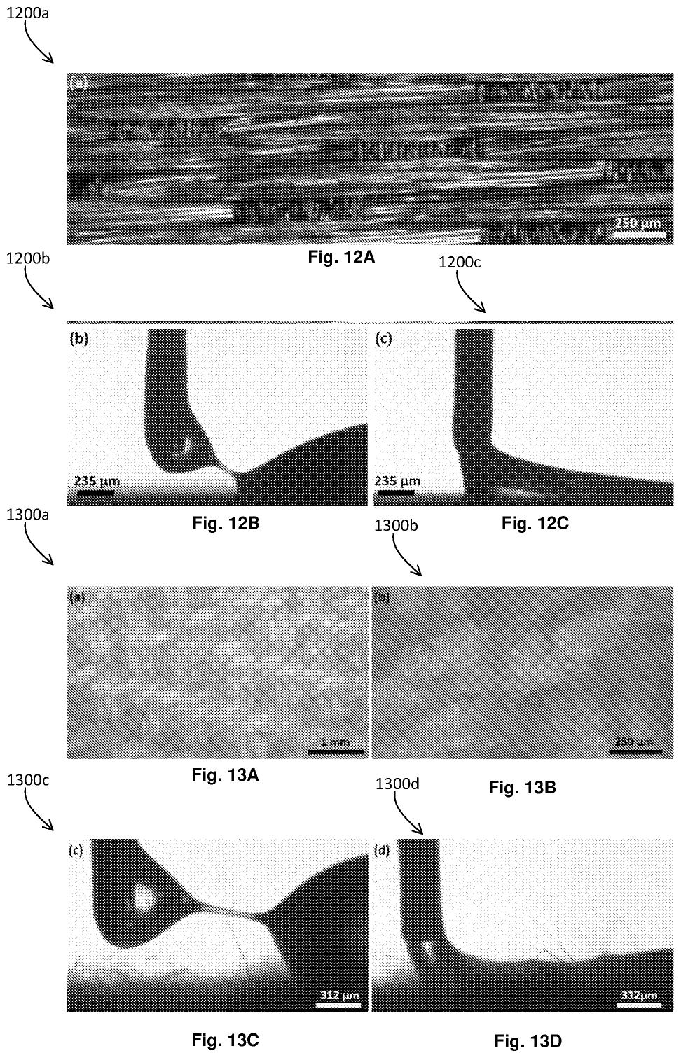

With reference to FIGS. 13A-D, spot-E may be extruded at ˜29 mm/s onto woven cotton belt (0.85 mm thickness) from 30-gauge needle, at the 20 mm/s belt speed, 41 psi. FIG. 13B View of bundled fibers at 97× magnification. FIG. 13C Failed printing state without E.F. FIG. 13D Intact printing line at 2.5 kV/mm voltage applied to the governing electrode which is not in the camera view. Another super-rough material was tested as substrate in our study. It was made from bundled jute fibers woven into a ribbon 12.7 mm wide and 2.21 mm thick. FIG. 13A was taken at 32× magnification, which reveals the overall view of the cotton belt surface patterned by the bundles woven together, while FIG. 13B at 97× magnification demonstrates the individual fibers which comprise the larger bundles. It should be emphasized that the individual fibers in the woven cotton belt are not necessarily neatly organized within the larger bundles and often leave the confinement of the bundle sometimes reaching several orders of magnitude higher above the printing surface than the average roughness extends. These elevated strands can easily be seen in FIGS. 13C and 13D where the two snapshots, respectively, show a failed printing state without E.F. and a successful intact printing trace with an E.F. strength of 2.5 kV/mm applied.

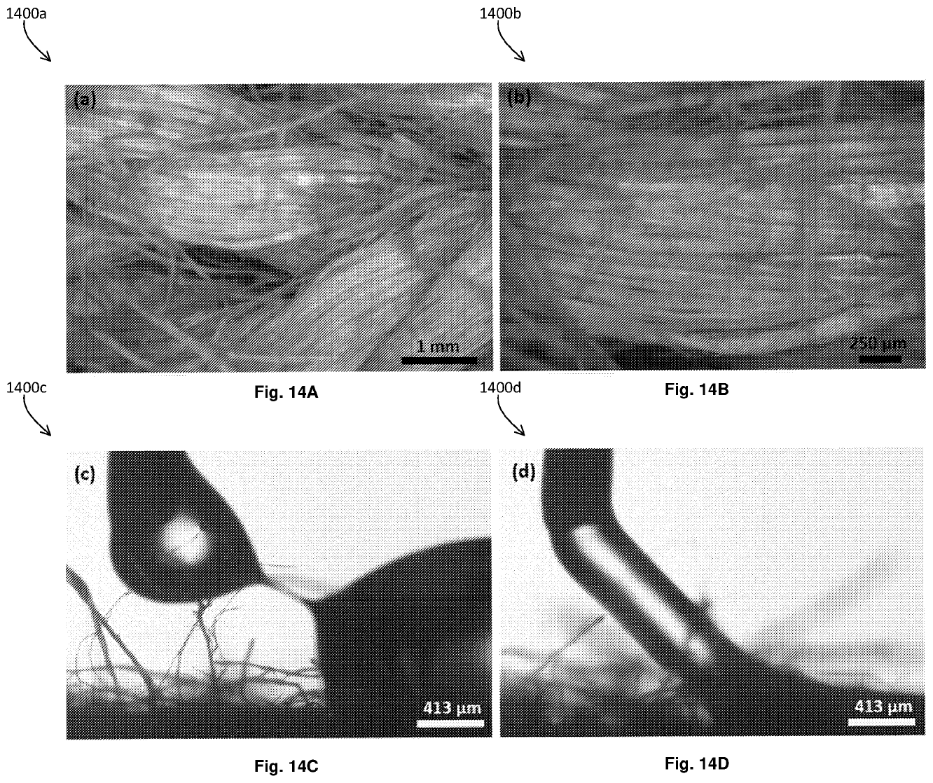

Turning to FIGS. 14A-D, spot-E may be extruded at ˜37 mm/s onto woven jute belt (2.21 mm thickness) from 27-gauge needle, at the 20 mm/s belt speed, 30 psi. FIG. 14A View of bundled fibers at 32× magnification. FIG. 14B View of bundled fibers at 97× magnification. FIG. 14C Failed printing state without E.F. applied. FIG. 14D Successful intact trace resulting from 2.5 kV/mm applied to the governing electrode which is not in the camera view. In the model experimental setup, the E.F.-affected jetting was easily captured via CCD camera due to a stationary nozzle. Upon transitioning to a moving DIW dispensing robot, such a visualization of the extruding ink became too difficult as the nozzle mechanically shifted according the printing program. While the pixelated data of the advancing lamella was not recorded during prints conducted with the DIW robot, an achievable increased printing speed and versatility facilitated by the electrically-modified needle can easily be observed in the printed traces after completion. The surface roughness based on the bundle diameter was estimated at 1.1 mm and can be observed at 32× and 97× magnifications in FIGS. 14A and 14B, respectively. The woven jute also revealed many individual fibers which are not contained within the bundles, similarly to those observed in FIG. 13B, further decreasing the uniformity of the belt surface used for ink deposition. Once again, a positive effect of the applied electric field on a continuous printed trace line was observed. FIG. 14C depicts a failed print without E.F. applied, and FIG. 14D shows a continuous trace successfully printed by our electrostatically-assisted DIW on this roughest substrate, with 2.5 kV/mm E.F. applied to the governing electrode.

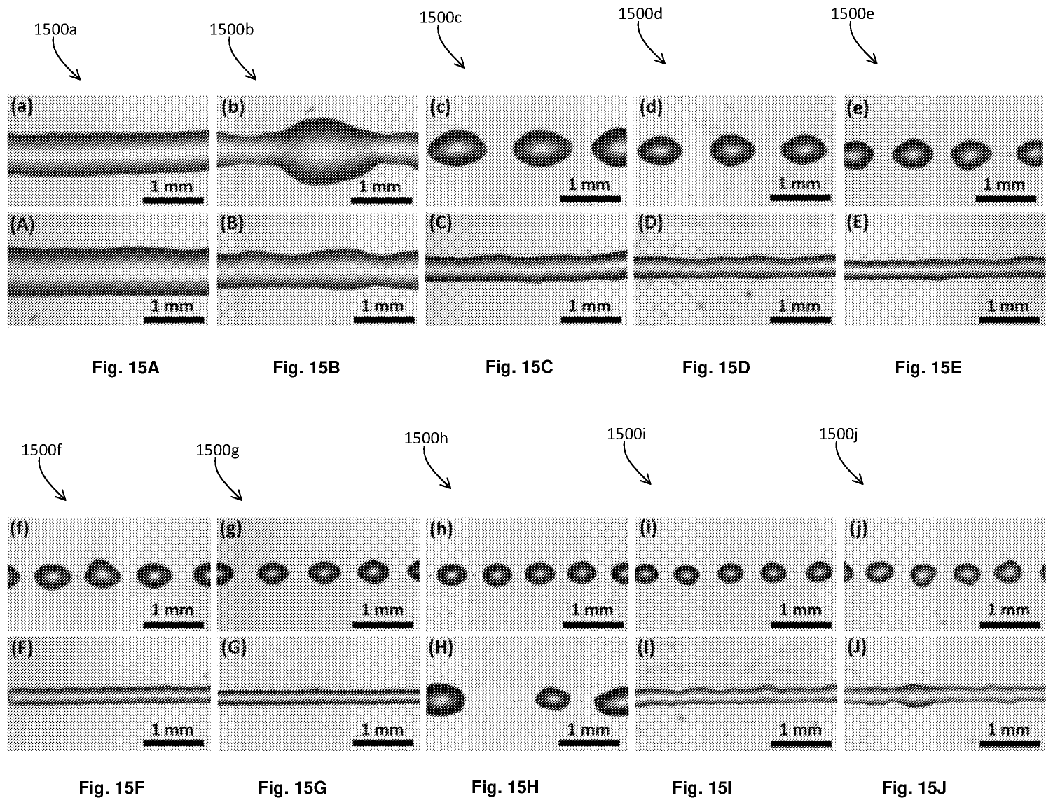

Turning to FIGS. 15A-J, spot-E may be extruded at ˜10 mm/s onto glass substrate (1 mm thickness) from 32-gauge needle at 30 psi. Printed on the DIW machine. (a) 50 mm/s, 0 kV/mm. (A) 50 mm/s, 2.5 kV/mm. (b) 100 mm/s, 0 kV/mm. (B) 100 mm/s, 2.5 kV/mm. (c) 150 mm/s, 0 kV/mm. (C) 150 mm/s, 2.5 kV/mm. (d) 200 mm/s, 0 kV/mm. (D) 200 mm/s, 2.5 kV/mm. (e) 250 mm/s, 0 kV/mm. (E) 250 mm/s, 2.5 kV/mm. (f) 300 mm/s, 0 kV/mm. (F) 300 mm/s, 2.5 kV/mm. (g) 350 mm/s, 0 kV/mm. (G) 350 mm/s, 2.5 kV/mm. (h) 400 mm/s, 0 kV/mm. (H) 400 mm/s, 2.5 kV/mm. (i) 450 mm/s, 0 kV/mm. (I) 450 mm/s, 2.5 kV/mm. (j) 500 mm/s, 0 kV/mm. (J) 500 mm/s, 2.5 kV/mm. Note that even though the electric potential applied to the governing electrode revealed a significant increase in the printing speeds available to achieve intact printed traces, the resulting trace lines were not necessarily perfect. FIGS. 15A-J depict results of Spot-E printed at ten different translating velocities as 10 cm trace lines onto a glass sheet 1 mm in thickness. The panels in FIGS. 15A-J are grouped by letter to designate printing speed (the lower-case letter panels) and the applied voltage (the upper-case letter panels). For example, the trace in FIG. 15A1 is printed at 50 mm/s with no E.F., while the one shown in FIG. 15A2 is printed at 50 mm/s with 3 kV voltage applied to the governing electrode. The printing speed in FIGS. 15A-J is in the 50-500 mm/s range and increase in the 50 mm/s increments from panel (a) to panel (b) and so on until the maximum velocity of the DIW robot is reached. When analyzing the different trace morphologies in the lower-case letter panels in FIGS. 15A-J without E.F. applied, one can see that only the first two of ten printing speeds (50 and 100 mm/s) result in continuous trace lines. Of the two continuous trace lines printed in the absence of the E.F. only FIG. 15A (for the lowest printing speed) reveals a relatively uniform trace width, whereas FIG. 15B already reveals significant undulations at a higher printing speed. Undulations of this magnitude can also be considered defects in DIW. These type of defects escalate at still higher printing speeds resulting in eight discontinuous prints at still higher printing speeds in FIGS. 15A-J. It should be emphasized that while 50 mm/s is considered adequate for DIW printing, the appropriate speed is judged based on the corresponding resolution and cost. The upper-case letter panels in FIGS. 15A-J reveal that the 3 kV voltage applied to the governing electrode facilitates printing intact trace lines up to the machine's maximum-capability speed of 500 mm/s. Of the ten distinct printing speeds tested, in 90% of the cases with applied E.F. intact 10 cm-long printed traces were obtained. An anomaly can be seen only in FIG. 15H were even with the E.F. applied, the majority of the 10 cm trace was broken up. This is likely due to an uncontrollable nuisance variable unable to be factored out with blocking between print speeds and randomization of runs, e.g., harmonic vibrations or instabilities.

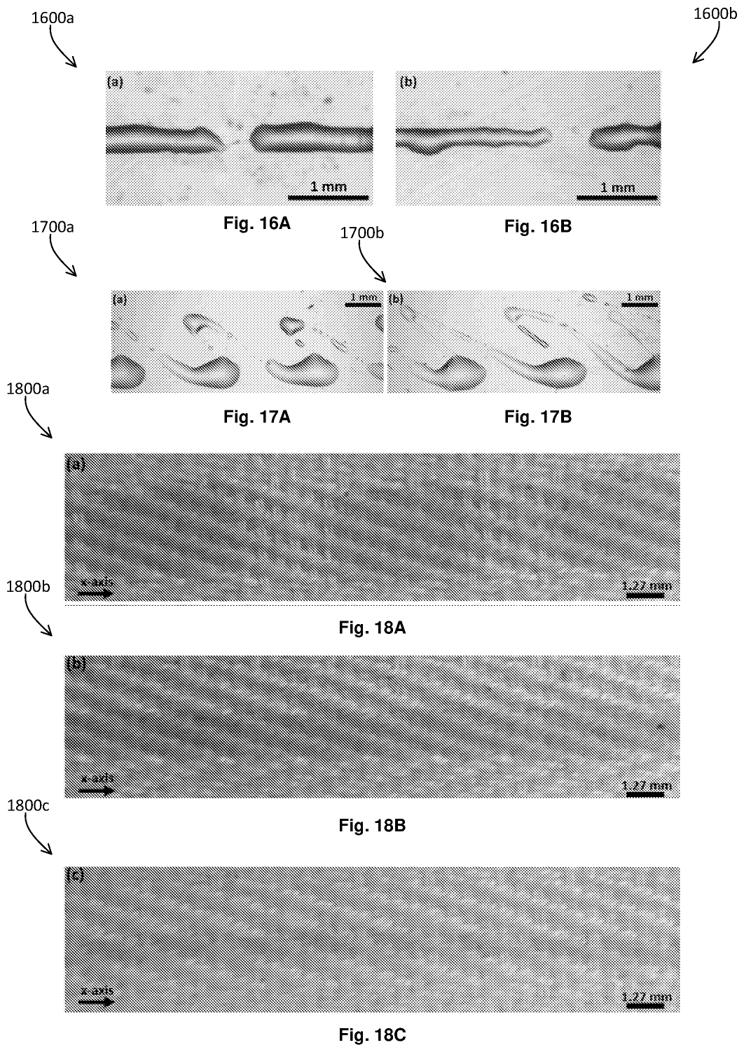

With reference to FIGS. 16A and 16B, spot-E may be extruded onto glass substrate (1 mm thickness) from 32-gauge needle at ˜10 mm/s with 2.5 kV/mm applied to the governing electrode, 30 psi. FIG. 16A Short break in the trace line printed at 200 mm/sec. FIG. 16B Short break in the trace line printed at 450 mm/s. In the aforementioned experiments, the E.F. pulled the triple line of the footprint of the jetted ink in the direction of printing at the electric field strength of ˜2.5 kV/mm. FIGS. 16A and 16B highlight two random breaks in the trace lines printed at 200 mm/s and 450 mm/s with the applied E.F., respectively, albeit the majority of the printed traces at these speeds were continuous.

Turning to FIGS. 17A and 17B, spot-E may beextruded at ˜10 mm/s onto glass substrate (1 mm thickness) from 32-gauge needle, 30 psi. Electrically-driven instability of printed traces at elevated E.F. strengths. FIG. 17A E.F. strength of 3.0 kV/mm. FIG. 17B E.F. strength of 3.1 kV/mm. Below the 3 kV/mm threshold, an additional experiment was performed using the DIW robot and printing onto woven cotton substrate previously tested in the model belt drive setup of FIG. 2A. However, increasing the E.F. strength close to the dielectric breakdown of air (i.e., 3 kV/mm) resulted in the completely discontinuous patterns shown in FIGS. 17A and 17B printed at 3 and 3.1 kV/mm, respectively. This phenomenon is likely caused by the electrically-driven instability of the trace, which becomes dominant in comparison to the previously discussed electrowetting pulling of the triple line.

With reference to FIGS. 18A-C, top views of Spot-E traces extruded through a 30-gauge needle at 41 psi with a translating print velocity of 40 mm/s along the x-axis with the other two print axes fixed. FIG. 18B depicts the discontinuous trace line printed without E.F., whereas FIG. 18B the continuous line printed with the E.F. of 2.5 kV/mm applied to the governing electrode. FIG. 18C depicts the continuous trace which could be printed at a doubled print velocity (80 mm/s) with the E.F. of 2.5 kV/mm applied. It is see that doubling the print velocity did not disrupt the trace line but rather diminished its width to one half of that seen in FIG. 18B. FIGS. 18A-C Spot-E extruded at ˜29 mm/s from 30-gauge needle onto woven cotton (0.85 mm thickness) adhered with double-sided tape to a glass substrate (1 mm thickness). (a) 0 kV/mm, 40 mm/s, discontinues trace˜3.5 mm wide. (b) 2.5 kV/mm, 40 mm/s, continues trace˜2 mm wide. (c) 2.5 kV/mm, 80 mm/s, continues trace˜1 mm wide. Here, the theoretical description of a material jet configuration in the DIW process and its modification by the electric forces. For a steady-state jet, the governing equations read:

$$\frac{dfV}{d ξ} = 0 \qquad ( 1 )$$

$$\frac{d}{d ξ} ( P τ + Q ) = 0 \qquad ( 2 )$$

$$\frac{dM}{d ξ} + τ \times Q = 0 \qquad ( 3 )$$

Equation (1) is the continuity equation which expresses the mass balance, with f being the cross-sectional area of the jet, V_{τ} being the velocity magnitude (the velocity projection to the jet axis with the local unit vector τ; cf. FIG. 18), and ξ being the arc length. Equation (2) is the force balance (the momentum balance equation in the inertialess approximation valid for slowly moving viscous jets of interest here), with P being the magnitude of the local longitudinal force in the jet cross-section, and Q being the local shearing force in the jet cross-section. Equation (3) is the moment-of-momentum equation, with M being the local moment of stresses acting in the jet cross-section. In Eqs. (1)-(3) and hereinafter the boldfaced characters denote vectors.

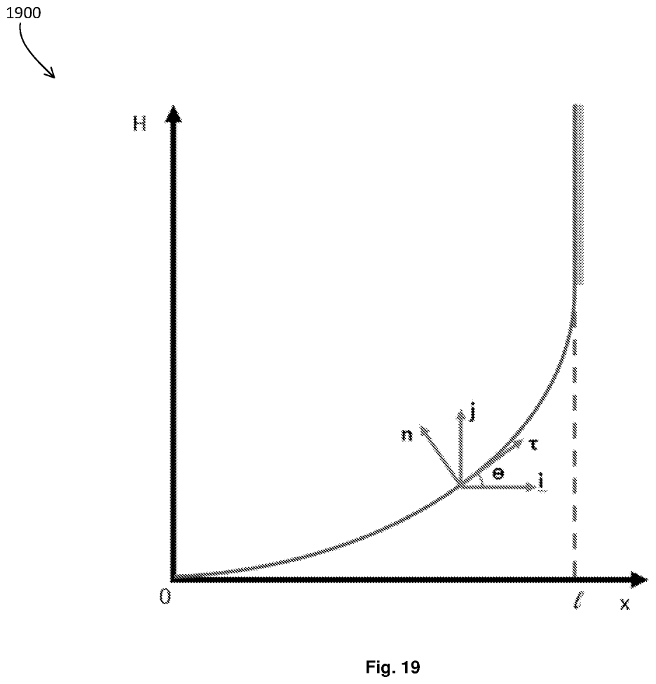

FIG. 19 depicts a sketch of the jet axis shown in red, with the coordinate axes and unit vectors used. The belt here moves vertically at x=l. In the present case the jet axis is a plane curve. Accordingly, Q has the only non-zero component in the direction of the unit normal vector to the jet axis n, i.e. Q=nQₙ, and M has the only non-zero component in the direction of the unit binormal vector to the jet axis b, i.e. M=bM_{b}; cf. FIG. 18. Then, Eq. (3) takes the following form:

$$\frac{{dM}_{b}}{d ξ} + {Q}_{n} = 0 \qquad ( 4 )$$

where accordingly:

$${M}_{b} = 3 μ I ( \frac{{dkV}_{τ}}{d ξ} - \frac{3}{2} k \frac{{dV}_{τ}}{d ξ} ) \qquad ( 5 )$$

with μ being the liquid viscosity, I being the moment of inertia of the jet cross-section, and k being the curvature of the jet axis.

Using Eqs. (4) and (5), one finds the shearing force as

$${Q}_{n} = - 3 μ [ I ( \frac{{dkV}_{τ}}{d ξ} - \frac{3}{2} k \frac{{dV}_{τ}}{d ξ} ) ] \qquad ( 6 )$$

Note also that jet cross-section in bending stays practically circular and thus,

$$f = π {a}^{2} , I = \frac{π {a}^{4}}{4} \qquad ( 7 )$$

where a is the local cross-sectional radius.

It should be emphasized that in Eqs. (2) and (3) we disregard the gravity force assuming its effect to be negligibly small in for DIW jets. Also, here the unmodified DIW process is considered first, i.e., the effect of the electric forces will be included separately.

Using the Frenet-Serret formulae, transform Eq. (2) to the following form

$$τ \frac{dP}{d ξ} + Pkn + n \frac{{dQ}_{n}}{d ξ} - {kQ}_{n} τ = 0 \qquad ( 8 )$$

In the projection of Eq. (8) to the tangent, the term −kQₙτ can be neglected compared to τdP/dξ. Then, the tangential projection of Eq. (8) reads

$$\frac{dP}{d ξ} = 0 \qquad ( 9 )$$

According to ^{(Yarin 1993)}, the longitudinal force is given by

$$P = 3 μ f \frac{{dV}_{τ}}{d ξ} \qquad ( 10 )$$

Integration Eqs. (1) and (2), one finds

$${fV}_{τ} = q , 3 μ f \frac{{dV}_{τ}}{d ξ} = F \qquad ( 11 )$$

where the constants of integration q and F have the meaning of the given volumetric flow rate in the jet q, and the still unknown pulling force imposed on the jet by the belt F.
Excluding f from Eqs. (11), onre obtains the differential equation for V_{τ}

$$\frac{d μ}{{V}_{τ}} \frac{{dV}_{τ}}{d ξ} = F \qquad ( 12 )$$

Integrating the later and using the boundary condition on the nozzle exit

ξ=0, V_{τ}=V_{τ0} (13)

where V_{τ0} is the jet velocity at the nozzle exit, which is known, one obtains the velocity distribution along the jet

$${V}_{τ} = {V}_{τ 0} exp ( \frac{F}{3 μ q} ξ ) \qquad ( 14 )$$

The velocity of the jet on the belt at ξ=L (where L is the total jet length from the nozzle to the belt) V_{τ1} is also known, albeit L is still unknown. Accordingly, Eq. (14) yields the following relation of the unknown force F to the unknown length L

$$F = \frac{3 μ q}{L} ln ( \frac{{V}_{τ 1}}{{V}_{τ 0}} ) \qquad ( 15 )$$

The normal projection of Eq. (8) reads

$$Pk + \frac{{dQ}_{n}}{d ξ} = 0 \qquad ( 16 )$$

Substituting the expression for the shearing force (6) and using Eqs. (10) and (11) for the longitudinal force, transform Eq. (16) to the following form:

$$Fk - 2 μ \frac{{d}^{2}}{d {ξ}^{2}} [ I ( \frac{{dkV}_{τ}}{d ξ} - \frac{3}{2} k \frac{{dV}_{τ}}{d ξ} ) ] = 0 \qquad ( 17 )$$

Denote by θ the angle between the jet axis and the axis Ox directed from the nozzle normally to the belt. Then, the curvature of the jet axis can be expressed as:

$$k = \frac{d θ}{d ξ} \qquad ( 18 )$$

and Eq. (17) takes the following form

$$F \frac{d θ}{d ξ} - 3 μ \frac{{d}^{2}}{d {ξ}^{2}} \{ I [ \frac{d}{d ξ} ( \frac{d θ}{d ξ} {V}_{τ} ) - \frac{3}{2} \frac{d θ}{d ξ} \frac{{dV}_{τ}}{d ξ} ] \} = 0 \qquad ( 19 )$$

The solution of this fourth order differential equation for θ is subjected to the following for boundary conditions

$$\begin{matrix}ξ = 0 , θ = 0 & ( 20 ) \\ ξ = 0 , \frac{d}{d ξ} \{ I [ \frac{d}{d ξ} ( \frac{d θ}{d ξ} {V}_{τ} ) - \frac{3}{2} \frac{d θ}{d ξ} \frac{{dV}_{τ}}{d ξ} ] \} = 0 & ( 21 ) \\ ξ = L , θ = \frac{π}{2} & ( 22 ) \\ ξ = L , \frac{d θ}{d ξ} \to 0 & ( 23 )\end{matrix}$$

The condition (20) implies that the jet is coaxial to the nozzle when it leaves it; the condition (21) means that the shearing force Qₙ=0 at the nozzle exit; the conditions (22) and (23) correspond to the jet roll-over the moving belt. Even though the relation of F to L is known from Eq. (15), it should should be emphasized that the problem formed by the fourth order differentioal equation (19) with the four boundary conditions (20)-(23) still contains one unknown—the total jet length L. Accordingly, an additional integral condition is required, namely,

$$ℓ = {\int }_{0}^{L} cos [ θ ( ξ ) ] d ξ \qquad ( 24 )$$

where l is the given distance from the nozzle to the belt along the x-axis, i.e., the standoff distance.

After finding θ=θ(ξ), he shape of the jet H=H(x) is found using the following geometric relations:

$$\begin{matrix}H ( ξ ) = {\int }_{0}^{ξ} sin [ θ ( ξ ) ] d ξ & ( 25 ) \\ x = {\int }_{0}^{ξ} cos [ θ ( ξ ) ] d ξ & ( 26 )\end{matrix}$$

Equation (19) with the boundary conditions (20) and (21) admits the following integration:

$$F θ - 3 μ \frac{d}{d ξ} \{ I [ \frac{d}{d ξ} ( \frac{d θ}{d ξ} {V}_{τ} ) - \frac{3}{2} \frac{d θ}{d ξ} \frac{{dV}_{τ}}{d} ] \} = 0 \qquad ( 27 )$$

Additionally, the second Eq. (7) and the first Eq. (11) yield:

$$I = \frac{{q}^{2}}{4 π} \frac{1}{{V}_{τ}^{2}} \qquad ( 28 )$$

Then, using Eqs. (14) and (28), transform Eq. (27) to the following dimensionless form:

$$\frac{ln \overline{{V}_{τ1}}}{\overline{L}} θ - \frac{{\overline{a}}_{0}^{2}}{4} \frac{d}{d ξ} [ {\overline{{V}_{τ1}}}^{- ξ / \overline{L}} ( \frac{{d}^{2} θ}{d {ξ}^{2}} - \frac{ln \overline{{V}_{τ1}}}{2 \overline{L}} \frac{d θ}{d ξ} ) ] = 0 \qquad ( 29 )$$

where ξ is rendered dimensionless by l, and—in transition—V_{τ} and F were rendered dimensionless by V_{τ0} and μq/l, respectively.
Equation (29) involves three dimensionless groups

$$\overline{{V}_{τ1}} = \frac{{V}_{τ1}}{{V}_{τ0}} , \overline{{a}_{0}} = \frac{{a}_{0}}{ℓ} , \overline{L} = \frac{L}{ℓ} \qquad ( 30 )$$

of which the first two are given, whereas the third one is found as discussed above.
The boundary conditions (20)-(23) take the following dimensionless form:

$$\begin{matrix}ξ = 0 , θ = 0 & ( 31 ) \\ ξ = 0 , \frac{d}{d ξ} [ {\overline{{V}_{τ1}}}^{- ξ / \overline{L}} ( \frac{{d}^{2} θ}{d {ξ}^{2}} - \frac{ln \overline{{V}_{τ1}}}{2 \overline{L}} \frac{d θ}{d ξ} ) ] = 0 & ( 32 ) \\ ξ = \overline{L} , θ = \frac{π}{2} & ( 33 ) \\ ξ = \overline{L} , \frac{d θ}{d ξ} \to 0 & ( 34 )\end{matrix}$$

Note that one of the two conditions (31) ad (32) is already redundant, because of Eq. (29).
In addition, the condition (24) takes the form:

$$1 = {\int }_{0}^{\overline{L}} cos [ θ ( ξ ) ] d ξ \qquad ( 35 )$$

Equations (25) and (26) do not change their form when x, H and ξ are rendered dimensionless by l. Consider the realistic case of V̅_̅{̅τ̅1̅}̅>>1. It is easy to see that one expects to find a solution, in which:

$$\frac{{d}^{3} θ}{d {ξ}^{3}} >> \frac{ln \overline{{V}_{τ1}}}{2 \overline{L}} \frac{{d}^{2} θ}{d {ξ}^{2}} >> \frac{ln \overline{{V}_{τ1}}}{2 \overline{L}} \frac{d θ}{d ξ} \qquad ( 36 )$$

These inequalities will be assumed to hold now, and proven a posteriori. Implying the inequalities (36), the problem (29), (31)-(33) is recast as:

$$\begin{matrix}\frac{{d}^{3} θ}{d {ξ}^{3}} + κ {\overline{{V}_{τ1}}}^{ξ / \overline{L}} θ = 0 & ( 37 ) \\ ξ = 0 , θ = \frac{{d}^{3} θ}{d {ξ}^{3}} = 0 & ( 38 ) \\ ξ = \overline{L} , θ = \frac{π}{2} , \frac{d θ}{d ξ} \to 0 & ( 39 )\end{matrix}$$

In Eq. (37) the following notation is used:

$$κ = - \frac{4}{{\overline{a}}_{0}^{2}} \frac{ln \overline{{V}_{τ1}}}{\overline{L}} \qquad ( 40 )$$

Note once again, that one of the two conditions (38) is redundant, because of Eq. (37). In the case of V̅_̅{̅τ̅1̅}̅>>1 formation of the boundary layer near ξ=L̅ is expected. In this boundary layer Eq. (37) takes the form:

$$ε \frac{{d}^{3} θ}{d {ξ}^{3}} + κθ = 0 \qquad ( 41 )$$

where:

$$ε = \frac{1}{\overline{{V}_{τ1}}} << 1 \qquad ( 42 )$$

As usual in the matched asymptotic expansions of the boundary layer theory, the inner stretched coordinate is introduces as:

$$X = \frac{\overline{L} - ξ}{{ε}^{1 / 3}} \qquad ( 43 )$$

Then, Eq. (41) takes the following asymptotic form:

$$\frac{{d}^{3} θ}{{dX}^{3}} + \vert κ \vert θ = 0 \qquad ( 44 )$$

Its solution reads:

$$θ = {C}_{1} {e}^{- γ X} + {e}^{γ X} ( {C}_{2} cos \frac{\sqrt{3}}{2} γ X + {C}_{3} sin \frac{\sqrt{3}}{2} γ X ) \qquad ( 45 )$$

where C₁-C₃ are the constants of integration and γ=|κ|^{1/3}.

The inner solution (45) is supposed to be matched with the outer solution outside the bojndary layer (still to be found) as X→∞. That means that C₂=C₃=0. On the other hand, the first boundary condition (39) yields C₁=π/2, and thus, in the boundary layer θ=(π/2)exp(−γX), i.e.,:

$$θ = \frac{π}{2} exp [ - {( \frac{4}{{\overline{a}}_{0}^{2}} \frac{ln \overline{{V}_{τ1}}}{\overline{L}} )}^{1 / 3} ( \overline{L} - ξ ) ] \qquad ( 46 )$$

It is easy to see that for ε<<1, the second boundary condition (39) holds, because dθ/dξ˜ε^{1/3}→∞. Moreover, for ε<<1, d²θ/dξ²˜ε^{2/3}, d³θ/dξ³˜ε, which proves the inequalities (36). Outside the boundary layer, Eq. (37) becomes:

$$\frac{{d}^{3} θ}{d {ξ}^{3}} + θ = 0 \qquad ( 47 )$$

Its solution is given by Eq. (45) with ξ instead of X. To satisfy the outer boundary conditions (38) and achieve matching with the outer solution (46) as ξ→L̅, all the constants of integration should be zero, and thus, the outer solution becomes:

θ=0 (48)

In the boundary layer when ξ is very close to L̅, the outer solution θ=(π/2)exp(−γX) can be approximated by its truncated expansion in the Taylor series, θ≈(π/2)(1−γX), which, together with the outer solution (47), allows one to evaluate the intergrals in Eqs. (35), (25) and (26), to find

$$\overline{L} \approx 1 + ( \frac{4 - π}{4} ) {( \frac{{\overline{a}}_{0}^{2}}{4} \frac{1}{ln \overline{{V}_{τ1}}} \frac{1}{\overline{{V}_{τ1}}} )}^{1 / 3} \qquad ( 49 )$$

and the jet axis H=H(x) in the parametric form (with ξ being the parameter) as:

$$H ( ξ ) = \{ \begin{matrix}0 , for 0 \leq ξ < {ξ}_{0} , \\ ξ - {ξ}_{0} + \frac{{π}^{2}}{{\overline{a}}_{0}^{2}} {( \frac{4}{{\overline{a}}_{0}^{2}} \overline{{V}_{τ1}} ln \overline{{V}_{τ1}} )}^{2 / 3} [ {( \overline{L} - ξ )}^{3} - {( \overline{L} - {ξ}_{0} )}^{3} ] , for {ξ}_{0} \leq ξ \leq \overline{L}\end{matrix} \qquad ( 50 )$$

$$x ( ξ ) = \{ \begin{matrix}ξ , for 0 \leq ξ < {ξ}_{0} , \\ {ξ}_{0} + \frac{π}{2} {( \frac{4}{{\overline{a}}_{0}^{2}} \overline{{V}_{τ1}} ln \overline{{V}_{τ1}} )}^{1 / 3} ( \overline{L} ξ - \frac{{ξ}^{2}}{2} - \overline{L} {ξ}_{0} - \frac{{ξ}_{0}^{2}}{2} ) , for {ξ}_{0} \leq ξ \leq \overline{L}\end{matrix} \qquad ( 51 )$$

Note that in Eqs. (49) and (50) the outer boundary of the boundery layer is taken at ξ₀=L̅−O(ε^{1/3}), in particular, at

$${ξ}_{0} = 1 - \frac{π}{4} {( \frac{{\overline{a}}_{0}^{2}}{4} \frac{1}{\overline{{V}_{τ1}} ln \overline{{V}_{τ1}}} )}^{1 / 3} \qquad ( 52 )$$

Equation (51) also yields the lateral coordinate at which the deflected jet meets the moving belt:

$$H ( \overline{L} ) = \frac{( 1 - {π}^{2} / 24 )}{{[ ( 4 / {\overline{a}}_{0}^{2} ) \overline{{V}_{τ1}} ln \overline{{V}_{τ1}} ]}^{1 / 3}} \qquad ( 53 )$$

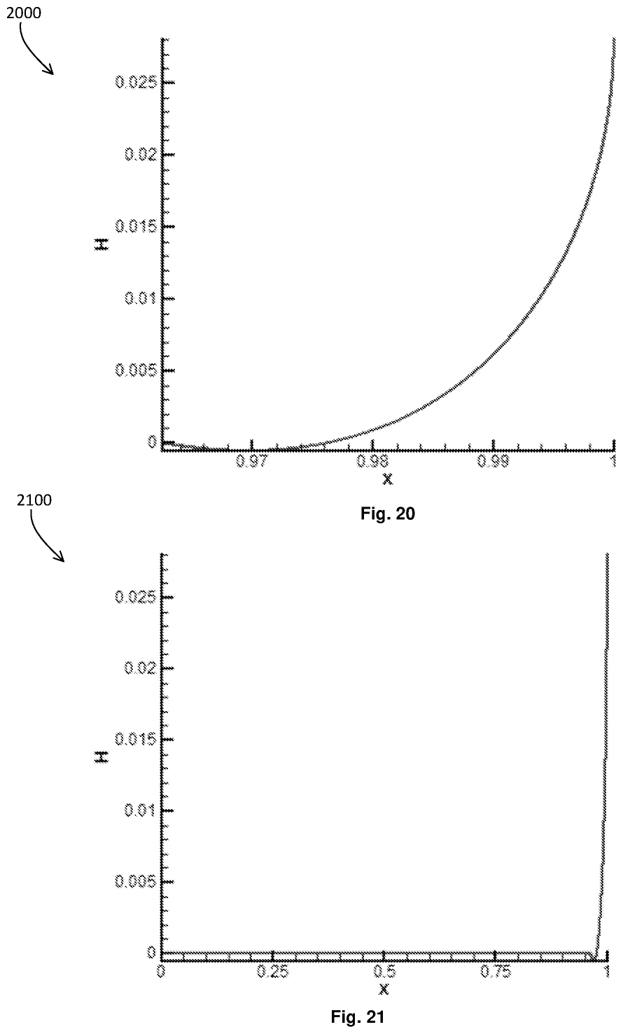

FIG. 20 illustrates the predicted jet configuration near the deflecting belt in the boundary layer, i.e., the one given by Eq. (46). FIG. 20 The predicted jet configuration in the boundary layer near the deflecting belt moving in the direction of the H axis. The parameter values: a̅₀̅=0.1, and V̅_̅{̅τ̅1̅}̅=10. No E.F. is applied. The corresponding jet configuration given by Eqs. (49)-(51) in this case is shown in FIG. 20.

FIG. 21 depicts The predicted overall jet configuration. The parameter values: a̅₀̅=0.1, and V̅_̅{̅τ̅1̅}̅=10. No E.F. is applied. Consider the effect of the electric forces on jet configuration. Let the jet has a net charge e₀ per unit length when it is issued from the nozzle. Material elements in the jet are stretched and the length of a unit element becomes equal to λ=\sqrt{1+(dH/dx)²}=1/cos θ because dH/dx=tan θ and in the present case cos θ>0 because −π/2≤θ≤π/2. Accordingly, the charge conservation in a material jet element means that the current charge per unit length is e=e₀/λ=e₀ cos θ.

Assume that in the space surrounding the jet an electric field is imposed by an electrode system. In particular, consider the electric field strength E parallel to the belt and directed opposite to the direction of the belt motion, i.e., E=−Ej, where E is the magnitude and j is the unit vector of the H-axis, i.e. of the direction of the belt motion. According to FIG. 19, j=n cos θ+τ sin θ, and thus, the electric force acting on a unit element of the jet Fₑₗ=eE is given by the following expression:

Fₑₗ=−e₀E cos θ(n cos θ+τ sin θ) (54)

Accounting for this force in the governing equations, yields the following system of equations generalizing Eqs. (1)-(3) for the case where the electric force is present:

$$\begin{matrix}\frac{{dfV}_{τ}}{d ξ} = 0 & ( 55 ) \\ \frac{d}{d ξ} ( P τ + Q ) + {F}_{el} = 0 & ( 56 ) \\ \frac{dM}{d ξ} + τ \times Q - In \times {F}_{el} = 0 & ( 57 )\end{matrix}$$

As before, Eq. (56) the only non-zero projection of Eq. (56) is the one on the binormal b, and it reads [cf. with Eq. (4)]:

$$\frac{{dM}_{b}}{d ξ} + {Q}_{n} - {e}_{0} EI cos θ sin θ = 0 \qquad ( 58 )$$

Using the Frenet-Serret formulae, transform Eq. (55) to the following form:

$$τ \frac{dP}{d ξ} + Pkn + n \frac{{dQ}_{n}}{d ξ} - {kQ}_{n} τ - {e}_{0} E cos θ ( n cos θ + τ sin θ ) = 0 \qquad ( 59 )$$

As in sub-section IV.1, the realistic case of V̅_̅{̅τ̅1̅}̅>>1 is in focus when the appearance of the boundary layer in the jet configuration near the belt is expected. The extra term on the left in Eq. (57) [cf. with Eq. (4)] is negligibly small in the boundary layer near the belt where θ→π/2. Due to the same reason, the effect of the electric force in Eq. (58) in the boundary layer is negligibly small, and the entire solution in the boundary layer found in the previous sub-section IV.1, Eqs. (49)-(50), holds with a minor modification:

$$\begin{matrix}H ( ξ ) = \{ \begin{matrix}0 , for 0 \leq ξ < {ξ}_{0} , \\ H ( {ξ}_{0} ) + ξ - {ξ}_{0} + \frac{{π}^{2}}{24} {( \frac{4}{{\overline{a}}_{0}^{2}} \overline{{V}_{τ1}} ln \overline{{V}_{τ1}} )}^{2 / 3} [ {( \overline{L} - ξ )}^{3} - {( \overline{L} - {ξ}_{0} )}^{3} ] , for {ξ}_{0} \leq ξ \leq \overline{L}\end{matrix} & ( 60 ) \\ x ( ξ ) = \{ \begin{matrix}ξ , for 0 \leq ξ < {ξ}_{0} , \\ {ξ}_{0} + \frac{π}{2} {( \frac{4}{{\overline{a}}_{0}^{2}} \overline{{V}_{τ1}} ln \overline{{V}_{τ1}} )}^{1 / 3} ( \overline{L} ξ - \frac{{ξ}^{2}}{2} - \overline{L} {ξ}_{0} - \frac{{ξ}_{0}^{2}}{2} ) , for {ξ}_{0} \leq ξ \leq \overline{L}\end{matrix} & ( 61 )\end{matrix}$$

Namely, in the boundary layer at ξ₀≤ξ≤L̅ the matching of H in Eq. (59) brings in an extra term H (ξ₀) because the outer solution is affected now by the electric field, and H(ξ₀)≠0 anymore. Note that in Eqs. (59) and (60) the previous expression for L̅ given by Eq. (48) is used as a reasonable approximation having in mind that the main contribution in the integral of Eq. (35) is associated with the boundary layer domain.

Outside the boundary layer where θ is close to zero the only significant contribution of the electric field is in the formal component of Eq. (58), which rakes the following dimensionless form:

$$\frac{ln \overline{{V}_{τ1}}}{\overline{L}} \frac{d θ}{d ξ} - \frac{{\overline{a}}_{0}^{2}}{4} \frac{{d}^{2}}{d {ξ}^{2}} [ {\overline{{V}_{τ1}}}^{- ξ / \overline{L}} ( \frac{{d}^{2} θ}{d {ξ}^{2}} - \frac{ln \overline{{V}_{τ1}}}{2 \overline{L}} \frac{d θ}{d ξ} ) ] = \overline{E} {cos}^{2} θ \qquad ( 62 )$$

where a new dimensionless group, the dimensionless electric field strength, appears:

$$\overline{E} = \frac{{e}_{0} E {ℓ}^{2}}{μ q} \qquad ( 63 )$$

Having in mind the inequalities (36) and the fact than in the outer solution θ is close to zero, and thus, cos² θ≈1, transform Eq. (61) to the following one:

$$\frac{{d}^{4} θ}{d {ξ}^{4}} + ω \frac{d θ}{d ξ} = - \frac{4}{{\overline{a}}_{0}^{2}} \overline{E} \qquad ( 64 )$$

where:

$$ω = - \frac{4}{{\overline{a}}_{0}^{2}} ln \overline{{V}_{τ1}} \qquad ( 65 )$$

Intergrating Eq. (63) once and using the boundary conditions (38), we obtain:

$$\frac{{d}^{3} θ}{d {ξ}^{3}} + ωθ = - \frac{4}{{\overline{a}}_{0}^{2}} \overline{E} ξ \qquad ( 66 )$$

The solution of the latter equation reads:

$$θ = {C}_{1} {e}^{- γξ} + {e}^{γξ} ( {C}_{2} cos \frac{\sqrt{3}}{2} γξ + {C}_{3} sin \frac{\sqrt{3}}{2} γξ ) - \frac{4}{{\overline{a}}_{0}^{2} ω} \overline{E} ξ \qquad ( 67 )$$

where C₁-C₃ are the constants of integration and γ=ω^{1/3}. Note that γ<0 because ω<0.

Applying to Eq. (45) the boundary conditions (38) and the matching condition

ξ→ξ₀, θ→0 (68)

One finds the constants C₁-C₃ as:

$$\begin{matrix}{C}_{1} = \frac{( 4 / {\overline{a}}_{0}^{2} ω ) \overline{E} {ξ}_{0}}{exp ( - {γξ}_{0} ) - exp ( {γξ}_{0} ) [ cos \sqrt{3} γξ / 2 + ( 2 / {3}^{5 / 2} ) sin \sqrt{3} γξ / 2 ]} & ( 69 ) \\ {C}_{2} = - {C}_{1} , {C}_{3} = - \frac{2}{{3}^{5 / 2}} {C}_{1} & ( 70 )\end{matrix}$$

The configuration of the jet affected by the electric field corresponding to the outer solution (66), (68) and (69) is found by the numerical integration of the following equations at 0≤ξ≤ξ₀:

$$\frac{dH}{d ξ} = sin [ θ ( ξ ) ] , \frac{dx}{d ξ} = cos [ θ ( ξ ) ] \qquad ( 71 )$$

subjected to the following boundary conditions:

ξ=0, H=0, x=0 (72)

This integration, in particular, allows one to find H(ξ₀) required in Eq. (59). The latter also yields the value of the deflection of the jet on the belt as:

$$H ( \overline{L} ) = H ( {ξ}_{0} ) + \frac{( 1 - {π}^{2} / 24 )}{{[ ( 4 / {\overline{a}}_{0}^{2} ) \overline{{V}_{τ1}} ln \overline{{V}_{τ1}} ]}^{1 / 3}} \qquad ( 73 )$$

which modifies Eq. (52) in the case when the effect of the electric field is important.

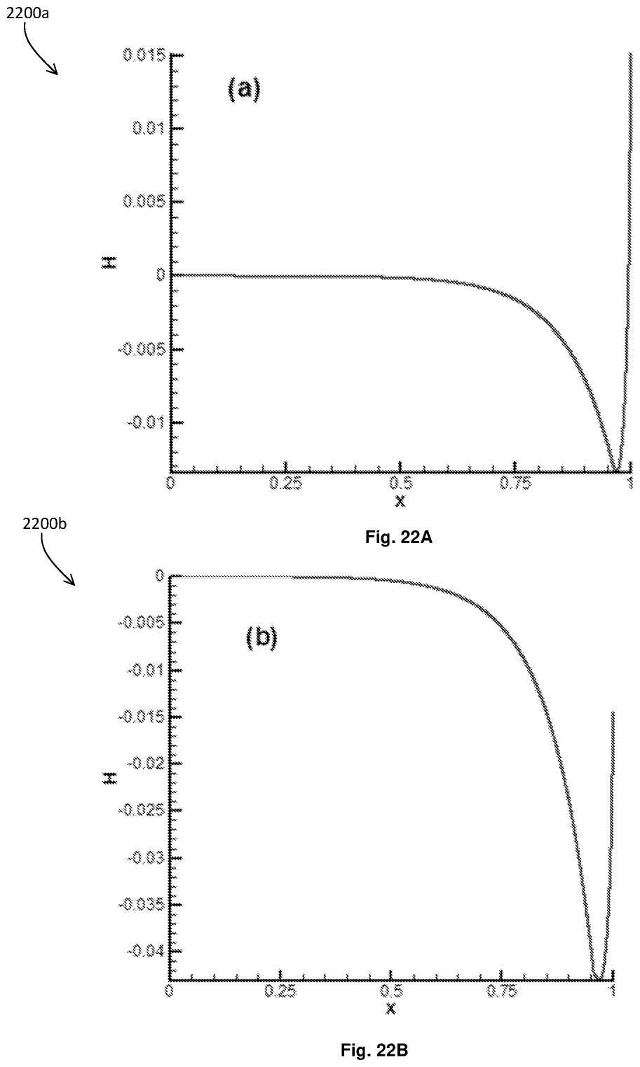

The predicted jet configurations affected by the applied electric field are illustrated in FIGS. 22A-C. FIGS. 22A-C The predicted overall jet configurations affected by the E.F. The parameter values: a̅₀̅=0.1, and V̅_̅{̅τ̅1̅}̅=10. (a) Ē=0.3, (b) Ē=1, (c) Ē=2. The results in FIG. 21 show how the progressively stronger electric field more and more pulls the jet against the direction of the belt motion, essentially diminishing the drag-off distance. It is also instructive to compare these results with the jet configuration predicted without the electric field in FIG. 20.

In the experiments Spot-E of viscosity of 0.3 Pa×s was extruded through a needle of the inner cross-sectional radius a₀=0.207 mm, of length of 25.4 mm, at the pressure drop of 68948 Pa. The distance between the nozzle exit and the belt was l=0.333 mm. Using the Poiseuille law, the average velocity V_{τ0}=3.21 mm/s, which, indeed, corresponds to laminar flow, as implied. Accordingly, in the case of the belt velocity of V_{τ1}=40 mm/s, in the absence of the electric field the values of the relevant dimensionless parameters are the follows: a̅₀̅=0.622, V̅_̅{̅τ̅1̅}̅=12.46, and Ē=0. The experimental data and the theoretically predicted configuration of the jet axis are presented in FIG. 22.

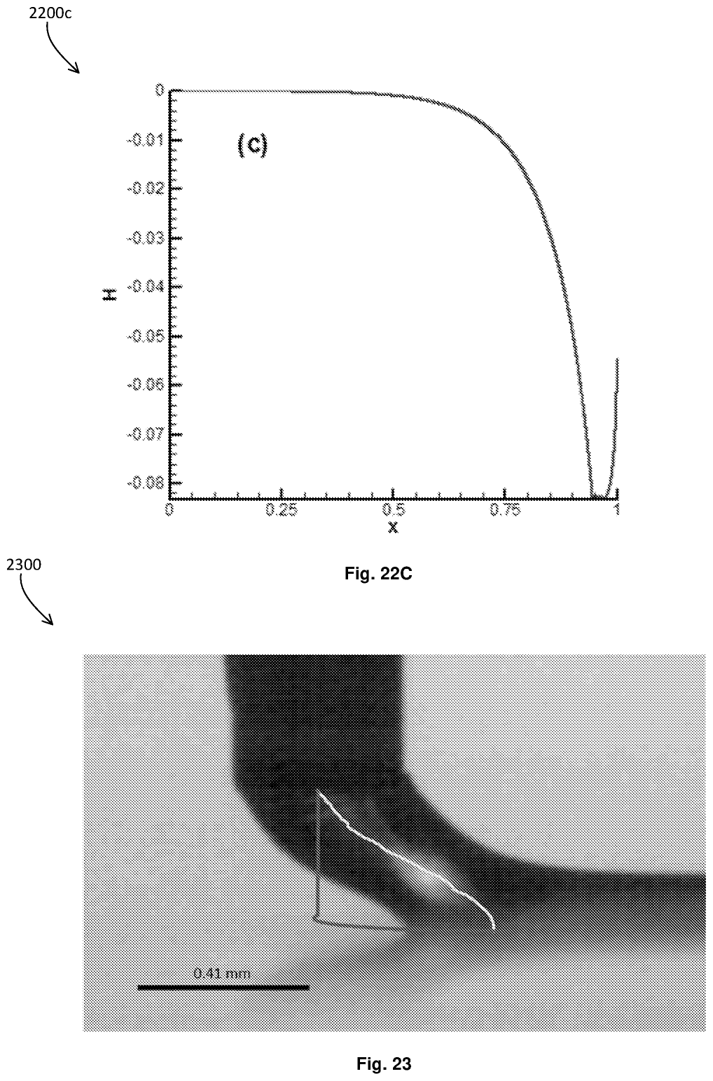

With reference to FIG. 23, a jet of spot-E deposited on the belt moving horizontally to the right without E.F. Parameter values are a̅₀̅=0.622, V̅_̅{̅τ̅1̅}̅=12.46, and Ē=0. FIG. 23 depicts that the theory is incapable of predicting the configuration of the centerline observed experimentally with Spot-E. The latter seemingly is capable of developing significant elastic stresses at strong stretching, which sustain such a suspended jet in steady state, as show in FIG. 23. The theory, which is purely viscous, does not result in such suspended configurations because it does not account for the elastic stresses, assuming viscous Newtonian fluid. The corresponding case with the imposed E.F. of 2.5 kV/mm is depicted in FIG. 23.

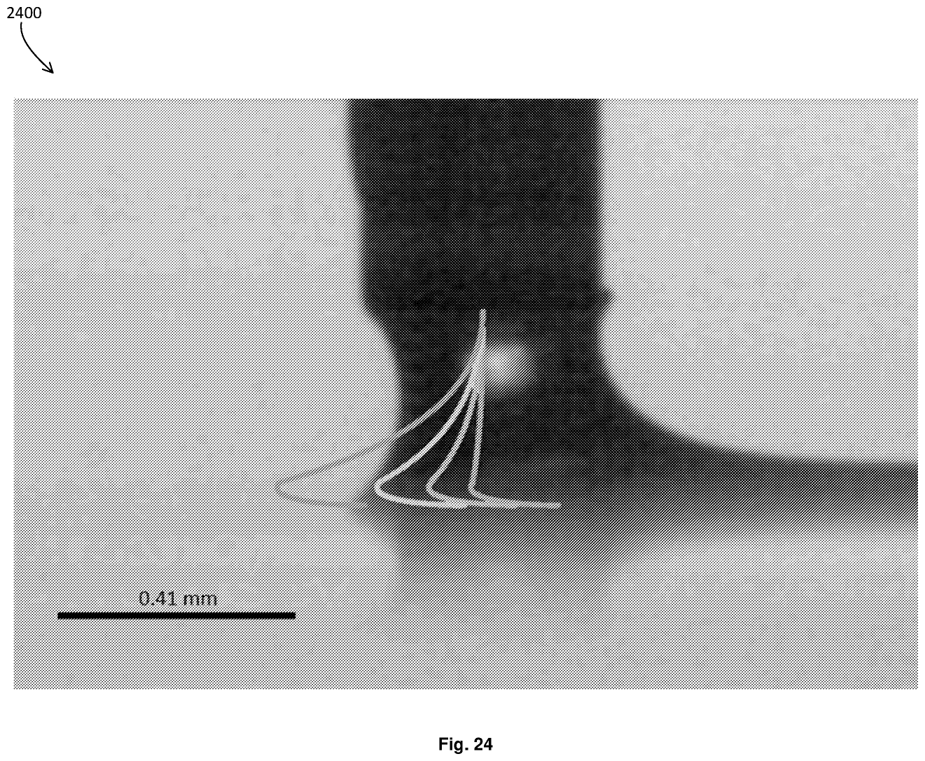

Turning to FIG. 24, a jet of spot-E may be deposited on the belt moving horizontally to the right with the E.F. pulling the jet in the opposite direction. The parameter values are: a̅₀̅=0.622 and V̅_̅{̅τ̅1̅}̅=12.46. The dimensionless E.F. strengths values used in the theoretical predictions are: Ē=0.1 (orange line), Ē=0.5 (grey line), Ē=1 (yellow line), and Ē=2 (blue line). FIG. 24 reveals that the electric field is capable to pull the jet back to its almost straight configuration above the boundary layer swept by the belt. Because insignificant elastic stresses are expected in this case, the theory could potentially yield a more plausible predictions. Indeed, the centerline predicted with Ē=0.5 looks plausible, while those with the higher values of Ē are presented to illustrate the tendency of the jet evolution under the effect of the E. F., albeit exaggerate it. It should be emphasized that in the present experiments the value of the electric charge carried by the unit length of the jet e₀ is unknown, and thus, the value of the dimensionless group Ē given by Eq. (62) cannot be calculated independently, even though the E.F. strength is known. Accordingly, several values of Ē are tested in FIG. 24 to revel the most plausible on the background of the experimental data.

Droplet jetting technologies, as applied to 3D printing (additive manufacturing), may be a strategic tool in creating biological sensors and wearable, flexible three-dimensional electronic devices. While the typical discretely-formed droplets tend to limit throughput, several highlights to the jetting process include an ample choice of ink/substrate combinations and printing with nearly zero waste. From a functional manufacturing perspective, it is important to understand how these discretely-formed droplets can be interconnected into digitally patterned lines and films within the limitations of the physics and hardware involved. Here we investigate the effectiveness of a Coulomb force created by charged electrodes placed either below the substrate or on the printhead. From the physical point of view, the phenomenon of dynamic electrowetting-on-dielectric (DEWOD) is used. It is demonstrated that sessile droplets, placed initially separately with little chance of natural coalescence, can be selectively coerced by the added electric field into the electrically-enhanced forced coalescence. Positive results were recorded for both electrode configurations at spacing distances greater than those achieved in literature. These results reveal novel manifestations of electrically-driven coalescence, which hold great promise for new manufacturing design opportunities, reduction in raw material use, operation on extremely rough surfaces, and continuous narrow prints in situations where the previous approaches failed. In addition to droplet-into-line coalescence, the first-approximation potential to merge 2D droplet arrays into films is also demonstrated.

Nearly 70 years since conception, inkjet printing has evolved into a staple within modern industry as a useful advanced fabrication tool. While relatively simple in principle, the trend to maximize DPI (dots per inch) while concurrently reducing the size of the machinery, has made the successful implementation of this non-contact process very complex. Despite these and other challenges, inkjet printing remains at the forefront as a direct printing technique when fabricating functional electronics, sensors and three-dimensional biological materials. Because building structures pixel-by-pixel, and layer-by-layer requires placement of adjacently located droplets, the coalescence between two merging drops is one key dynamic phenomenon receiving attention in current research works. The majority of the above-mentioned works aimed at creating a continuous line or a conducting trace through coalescence. Applying electric forces (essentially, associated with the Maxwell stresses at the droplet surface) could cause electrocoalescence, which could be useful for droplet manipulation or potentially beneficial to manufacturing as a novel tool. While admittedly the coalescence of two adjacent droplets is not always desirable, the ability to control or tune the phenomenon may prove advantageous.

Coalescence can occur relatively quickly in inkjet printing, with literature claiming the characteristic times of the order of ˜100 ms or less (Sarojini et al. 2016). The characteristic hydrodynamic time of droplet coalescence is τ_{H}=μR₀/σ and reveals that the timescale related to the viscous regime of coalescence, can be reduced by several orders of magnitude when the viscosity (μ) is relatively low and the surface tension (σ) is relatively high. Also worth mentioning is that the characteristic hydrodynamic time is proportional to droplet size (R₀), which continues to decrease as new, high-resolution techniques emerge. High-resolution inkjet patterns typically have features in the 10-100 μm range (Singh et al. 2010), but current trends are aiming for nanometer-sized pixels on both solid and flexible, porous and non-porous substrates. It is important to keep these ever-shrinking scales in mind when considering techniques used to manipulate functional, drop-on-demand inkjet printing, say, to enhance or prevent droplet coalescence on a substrate. Indeed, an additional external force electric applied to droplets should be capable of a greater switching frequency than droplet formation frequency at the inkjet nozzle (˜10 kHz) and/or the inverse hydrodynamic time τ_{H}⁻¹ of the fluid. For the two inks of interest in the present work (linseed oil and Spot-E), the values of τ_{H} were found to be 1.2 and 0.3 ms, respectively, which yields τ_{H}⁻¹ 833 and 3333 Hz, respectively, which are well below the frequency at which the electric field (E.F.) can be adjusted. The latter makes application of the electric forces for droplet coalescence or splitting extremely attractive. If fact, frequencies up to one-trillion cycles/s, have been reported from modern amplifiers, which significantly exceeds the value of τ_{H}⁻¹ in the present case. While this should not imply the ability to control droplets faster than their natural frequency, rather it shows the E.F. will be fully capable of controlling droplets as fast as they are created or their eigenfrequencies allow. Adding even more to the appeal, the previous work of this group has revealed the ability to retrofit existing machinery to produce enhanced prints without the need for a costly replacement.

The E.F. application is one of several industrial trends aiming at manipulation and, essentially, control of manufacturing materials via sorting, transporting, merging, splitting, and storing droplets. In addition to E.F. used for dynamic electrowetting-on-dielectrics, forces resulting from acoustic waves, electro-magnetic excitation, as well as thermal and hydrodynamic phenomena-related forces can be employed. It should be emphasized that the present work uses only the E.F. generated by a DC source. Note that AC voltages have been shown to stimulate the resonance frequencies of sessile droplets within a transverse E.F. to either coalesce or move such droplets through vibrations.

Many works are directly related to functional inkjet printing with several having experimental methods and theoretical explanations related to the interactions between adjacently placed droplets. For calculations, a simple conservation of volume model may be used to study the instability of an inkjet-printed line on a homogenous and flat substrate. While several authors explain printed stability in terms of a geometric model, not only studied the overlapping of adjacent droplets into lines, but also overlapping of adjacent lines into thin films, and explained the observed morphologies. Although less popular, at least one method in functional inkjet printing avoids the occurrence of overlapping entirely. A two-pass approach may be employed where every other pixel may be printed in the first pass allowing time to dry before going back over to fill in the gaps. While this method was able to produce uniform lines with a claimed beneficial thickness, it would limit the throughput as the print head would be required to make at least two passes per trace. It should be emphasized that one benefit of the non-overlapping method proposed in the present work is the reduction of ‘drawback’ where the second (impacting) droplet is pulled in the direction of the first (sessile) droplet, which becomes exceedingly pronounced when the viscosity is low. The ‘drawback’ may unfavorably break, distort and/or budge a trace line. The reduction of this phenomenon through electrocoalescence, instead of traditional jetting overlap could be beneficial. As to our knowledge, not a single publication was found integrating electrocoalescence with droplet jetting-based 3D printing techniques, which is the main aim of the present work. A great benefit of inkjet printing is the broad range of working fluids which leads to a subsequent number of potential directions for research. Printable inks consist of three main components: carrier medium (water or another solvent) including colorant (pigment), additives (I, carbon nanotubes, etc.), binder (resin). In the present work, two working fluids were chosen based on their relevance to industry or research. Linseed and or soybean oil is the base for most inks and is considered a “green” (bio-renewable) vegetable base for inks. Linseed oil is also known to create prints with a high brightness value and be a major component in functional resins. Synthetic polymers, which are critical in flexible electronics, can also add advantageous physical characteristics (e.g., flexibility, tunable conductivity, low weight, etc.) to inks formulations. A pre-manufactured polymer ink, Spot-E (Spot-A materials) along with linseed oil were purchased for the present work. Relevant properties of these liquids, which are ionic conductors, are listed in Table 1.

TABLE 1
Properties of the inks used in the experiments.

| | SURFACE | VISCOSITY | VAPOR | BOILING TEMP. | ELEC. COND. |
|---|---|---|---|---|---|
| SPOT-E | 33 MN/M | 400 MPA× | NEGLIGIBLE | — | 1.08 × 10⁻⁶ S/M |
| LINSEED OIL | 40.4 MN/M | 39 MPA × S | NEGLIGIBLE | 315 C. | 1.12 × 10⁻⁸ S/M |

If two droplets of similar inks make contact, one anticipates coalescence driven by minimization of surface energy. Here, we experimentally demonstrate that droplets comprised of typical inkjet fluids can achieve line/film coalescence without direct overlap of sequentially printed droplets, which has never been achieved in the existing literature, as to our knowledge. Electrodes, with the ability to create an electric field strength of 1.57 kV/cm between them, were placed in two configurations. For an initial test, both electrodes are placed parallel on the surface (FIG. 25A), while the subsequent tests changed the configuration by placing the electrodes on the printhead and perpendicular to the horizontal surface (FIG. 25B). When charged, these electrodes provide an additional Coulomb force to facilitate the formation of a line (droplet-to-droplet coalescence) or a film (line-to-line coalescence). Liquids are ionic conductors and charge re-distribution in them proceeds on the scale of the charge relaxation time τ_{C}, which is on the 1 μs-1 s time scale. When the characteristic droplet evolution time τ_{H} is of the order of, or longer than the charge relaxation time, extra ions have enough time to migrate to the free surface toward the electrode with the opposite polarity. That means that liquid, essentially, behaves as a perfect conductor, in spite of its low electrical conductivity. The net electric charges created at the surface, thus interact with the nearby electrodes of the opposite polarity, which constitutes the action of additional Coulomb forces acting on liquid from the electrodes.

Accordingly, droplets placed on a surface initially with no overlap can be stretched out of their lowest energy state (an almost spherical segment) and literally reach out to join with a neighboring droplet/droplets forming new, even lower overall energy states. It is important to note that the case displayed in FIG. 25A is less than ideal for real-world printing as the effects of the embedded electrodes would diminish as the build height increases. However, this configuration was initially chosen for ease of application and visualization through high-speed recording. In the second case tested (FIG. 25B), the electrodes are not limited to the build surface having their effects consistent throughout the entire build.

The droplets used in the present experiments were of the order of 200 μm-1 mm (the volume-equivalent diameter). Material droplets of sizes 200 μm-3 mm may be manipulated and moved by the electric forces on a number of dielectric substrates at the electric field strengths well below the dielectrical breakdown in air of ˜30 kV/cm. Accordingly, the electric field strength of 1.57 kV/cm employed here is sufficient for manipulation of droplets of sizes relevant in the 3D printing, and there is a sufficient leverage for manipulation of even smaller droplets by safely increasing the electric field strength beyond the value of 1.57 kV/cm.

Turning to FIGS. 25A and 25B, schematics of a print heads 2500a,b are depicted. FIG. 25A depicts horizontal electrodes on the dielectric substrate. 25B Vertical electrodes mounted on the printhead over the dielectric substrate. Experiments were performed with sessile droplets of the aforementioned liquids printed with an offset using a modified DIW (Direct Ink Writing) automated dispensing system utilizing D.O.D. (droplet-on-demand) generation. To generate droplets of diameter d˜1 mm, a commercial droplet generator (Nordson Ultimus I) was utilized along with a 32-gauge needle (109 μm inner diameter). The droplet generator creates a well-defined pressure pulse for a specific time interval driving the ink through a blunt needle at a pressure ranging from 0.1 to 70 psi. With the printing needle positioned ˜5 mm above the substrate, the droplet impact velocities were estimated to be ˜0.31 m/s. This process is carried out by depositing the first droplet followed by a translation of the chosen substrate before a second droplet is placed. For most experiments, droplets were digitally printed onto bare glass (microscope slides) with just one case being printed onto a glass slide covered with Mylar film. The Mylar film, a semi-transparent, flexible film served as a simple means to alter the hydrophilic nature of glass and diversify experiments. For the initial experiment, several droplets of linseed oil were printed between two horizontal electrodes aligned on the surface of the glass substrate. The electrodes were made by applying self-adhesive copper tape to the glass microscope slide with an insulation gap of 3 cm in-between, as sketched in FIG. 25A.

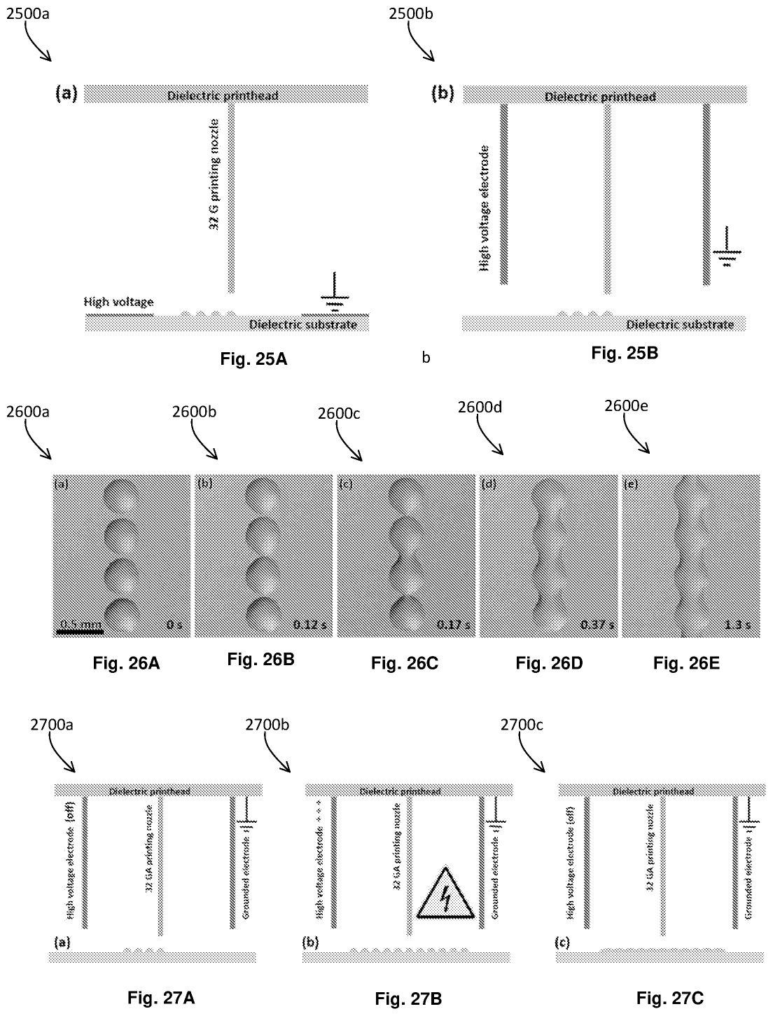

Initially, the droplets were in steady state, as shown in FIG. 26A. When the electric field had been applied, the droplets underwent stretching along the joint central line and coalesced into an intact line, as illustrated in the series of snapshots in FIGS. 26A-E. A slight asymmetry was noticed relative to the center of the printing line both before and after electrocoalescence. While the former is due to fluctuations during flight and impact, the latter is likely due to asymmetry in the E.F. generated by the handmade electrodes, as well as the initial variances from droplet deposition. It should also be noted that this process worked equally well when Spot-E was chosen for the printing ink. FIGS. 26A-E Linseed oil on glass slide subjected to the electric field strength of 1.57 kV/cm. The surface-aligned electrode configuration of FIG. 26A. FIGS. 26A-E demonstrates the ability to redistribute fluid from individual droplets into a continuous trace line with the surface-aligned electrode configuration. To investigate the practically important electrode configuration of FIG. 26B, a dielectric printhead with copper electrodes (0.75 mm×12 mm×20 mm strips) parallel to the nozzle with an insulation gap of 5.08 cm. The dielectric printhead was made from 1.5 cm thick Teflon and modeled after the original aluminum printhead giving approximately 6 cm×6 cm to mount the printing needle and electrodes. This modified printhead was retrofitted to the DIW automated dispensing robot and tested to ensure normal operation. FIGS. 26A-E depicts schematic time-lapse of the modified printing process. With the printing nozzle extending below the lowest end of the attached electrodes, the printer can run through a normal program as depicted in FIG. 26A. After printing the droplets for the desired trace, a simple modification to the program lowers the electrodes till they are just above the substrate (˜1 mm) and centers them over above the print before applying high-voltage to create an E.F. strength of 1.57 kV/cm, as depicted in FIG. 26B. This E.F. strength was chosen based on experiments from previous work. When the E.F. strength was varied slightly for experimental purposes, the value of ˜1.57 kV/cm (corresponding to the potential difference of 8 kV applied over the distance of 5.08 cm) was found to be effective and used throughout experiments to maintain consistency. No better results were achieved when E.F. strength values were different. FIG. 26C shows the DIW robot at idle, after the droplets have coalesced. In general, FIGS. 26A-C depicts a time evolution of two coalescing droplets. The impulse causes a droplet deformation, which lowers the distance between them. Coalescence is triggered if the distance between the droplets is fully covered by deforming liquid surface. During coalescence the contact line of both droplets is pinned. After coalescence the contact line of the resulting droplet moves and the contact angle is changed.

With reference to FIGS. 27A-C, schematic of print head 2700a-c throughout notable positions of the print (not to scale). (a) Needle directly above digital location as the droplet is ejected. (b) While the needle is not printing, electrodes centered over the area of interest are charged to create the horizontal electric field strength of 1.57 kV/cm. Area of interest is tunable via electrode spacing; here it was 5.08 cm. (c) All printing motion and electrical processes have stopped; the finished line or trace having experienced the effect of the applied electric field and subsequently coalesced.

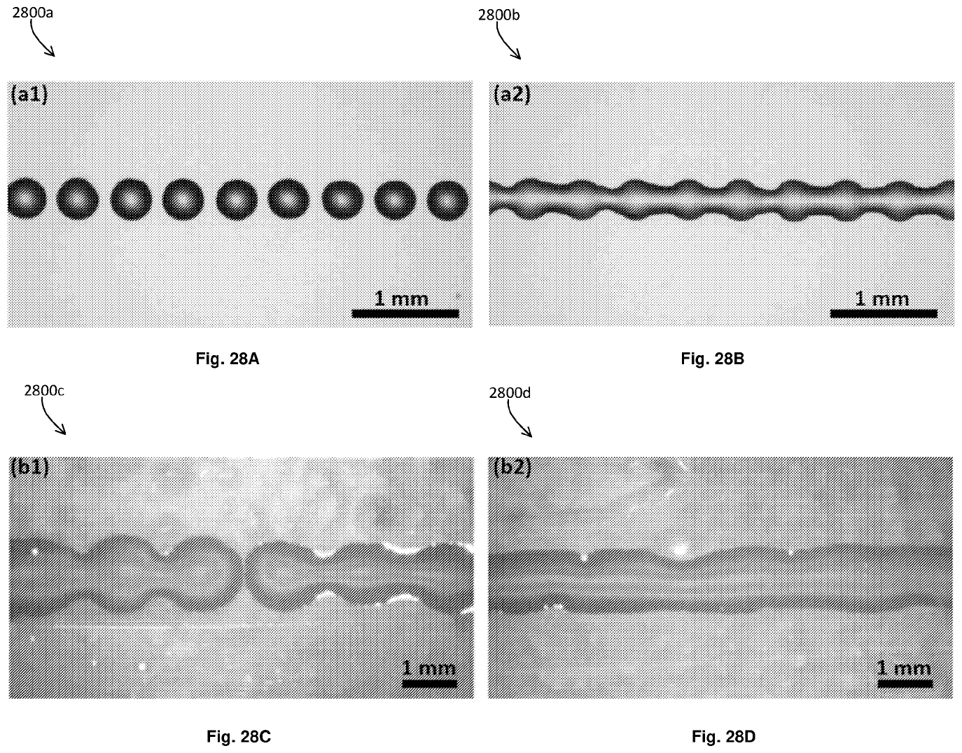

Turning to FIGS. 28A-D, snapshots 2800a-d before and after the electrocoalescence process in several situations are depicted. First, linseed oil droplets were deposited (FIG. 28A), and then subjected to the electric force resulting from the 1.57 kV/cm E.F. strength produced on the printhead. FIG. 4a shows a clear separation between droplets ensuring a steady-state situation where coalescence is highly improbably corresponding to the schematic in FIG. 28A. The previous images (FIGS. 26A-D) captured by high-speed reveal stretching at each side of the droplet forming an appearance of a ‘double cone’) in alignment with the E.F strength vector. Unfortunately, this real-time top view was now being blocked by the printhead and inadmissible for recording during the printing process. Accordingly, the images in FIGS. 28A-D are the static images taken before (e.g., FIG. 28A) and after the entire process (the corresponding FIG. 28B). In FIGS. 28C and 28D, Spot-E was the chosen ink and was printed on a Mylar substrate supported by glass. Through trial and error, an initial droplet spacing was chosen close to the threshold of self-coalescence. Being printed on the threshold of coalescence, FIG. 28C captures a case where the majority of the printed droplets having coalesced, leaving just one small break in the middle of the trace. To fix the broken line with the E.F. application, the modified printhead with electrodes was positioned over the break before charging to 1.57 kV/cm. As FIG. 28D shows, the E.F. can effectively repair a failed discontinuous print trace without any need to reprint.

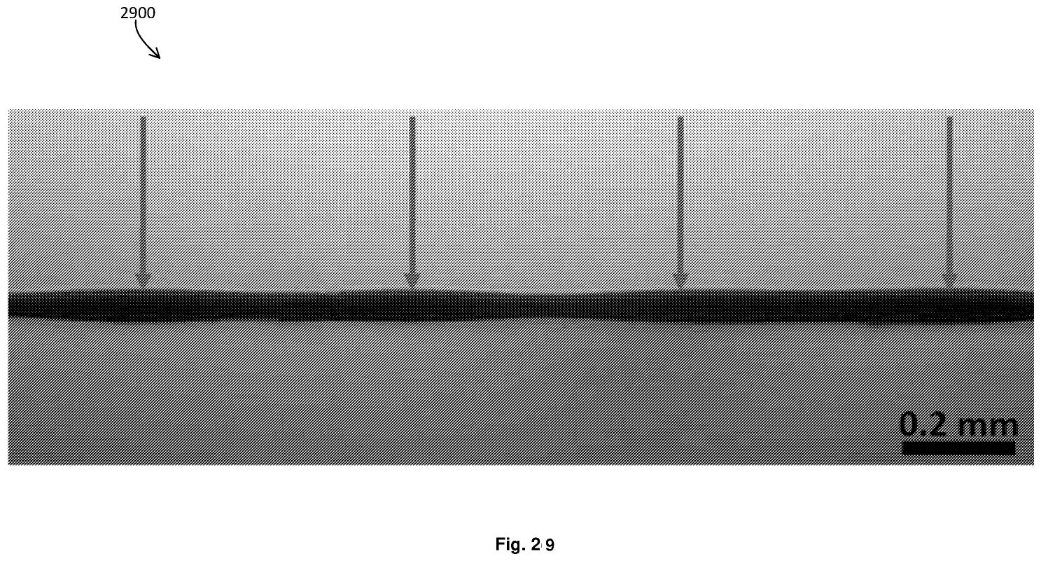

FIGS. 28A-D depict a printed line with droplets of linseed oil on glass at spacing above the thresholds for self-coalescence: FIG. 28A before applied E.F., FIG. 28B after the E.F. strength of 1.57 kV/cm has been applied and droplet coalescence achieved. FIG. 28C Spot-E printing on Mylar at the threshold of self-coalescence resulting in a randomly discontinuous trace. FIG. 28D after the E.F. strength of 1.57 kV/cm has been applied, the results reveal a smoother continuous trace. It should be emphasized that the resulting printed geometry in FIG. 28B does not eliminate all budging which may be disadvantageous for some applications. In general, budging depends on the following four factors being at work simultaneously: (i) the initial waviness of the liquid front depending on the droplet size and the inter-droplet distance, (ii) the surface wettability depending on the liquid and the solid substrate, (iii) surface tension of the liquid, and (iv) its viscosity damping smoothing. Accordingly, it can be seen in FIG. 28D that in the second case the resulting trace has less budging than that in FIG. 28B. It should be also noted that less overall material is used to create continuous traces with this technique, which is definitely beneficial for “green” printing applications (e.g., flexible electronics, scaffolds, bio-structures, flooring, decorative construction materials, wood-like materials, stone-like materials, metal-like materials, textile-, show- and other related materials, electronics-related materials, bio-materials, repairing and remanufacturing, surface texturing, etc.). Also worth mentioning is the ability to tune the waviness of the trace line, and the surface roughness. Indeed, FIG. 29 highlights by red arrows the peaks of the printed line when viewing sideways on the horizontal printing plane. Looking back to FIG. 28A, a distinct and repeatable distance between roughness peaks and troughs can be achieved. Because the frequency of surface roughness is directly linked to the number of droplets over a given length, both adjusting the size of droplets and/or varying the spacing of droplets provides the ability to tune the waviness of the printed surface. As hydrophilicity/phobicity are known to vary with surface roughness at the micro/nano-scales, the present results might be useful to change wettability and adhesive properties without chemical alteration.

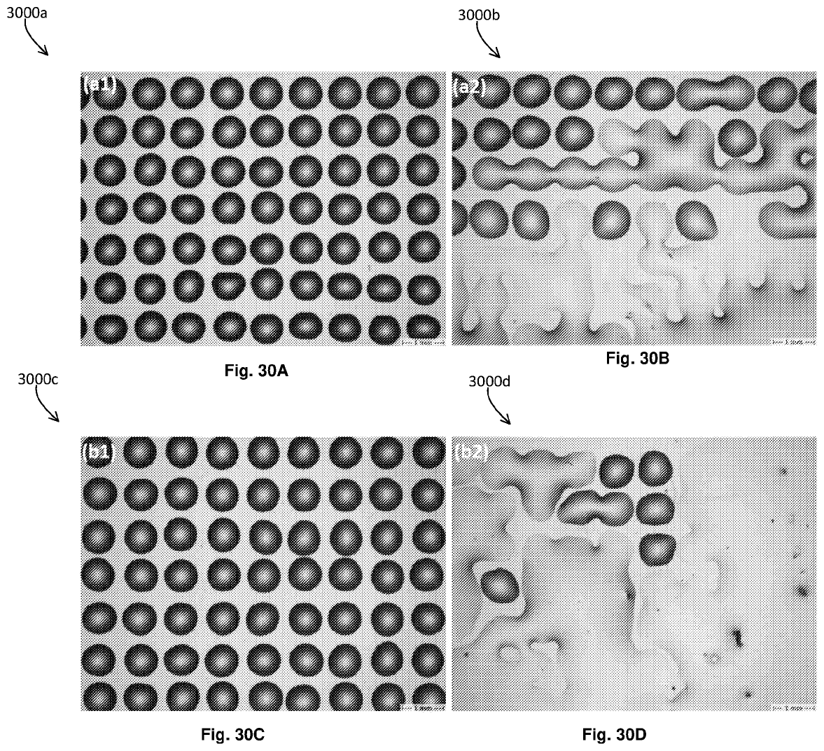

With reference to FIG. 29, surface waviness of printed linseed oil with selective droplet spacing is illustrated. A number of works related to applications of the inkjet techniques in printed electronics ascertain significant interest in printed thin films. With this in mind, the arrays of droplets shown in FIGS. 30A and 30C were subjected to the same charged electrode configuration as that in FIG. 30B. The resulting liquid configurations after application of the E.F. shown in FIGS. 30B and 30D, respectively, reveal that the E.F. promotes film formation. While complete coalescence of all droplets into a thin film was not achieved in the present experiments yet, several domains in FIGS. 30C and 30D do reveal uniform films, which clearly shows that formation of such films over large printed areas should be possible. For example, the ability to rotate or alter the E.F. lines may facilitate the overall droplet coalescence resulting in thin uniform films. Future work will explore whether additional electrodes or ring-like electrodes could facilitate formation of uniform films.

Turning to FIGS. 30A-D, printed arrays of linseed oil on glass used to for electrically-driven film formation are illustrated: (FIG. 30A) Before the E.F. was applied (case 1), and (FIG. 30B) the corresponding image after the E.F. has been applied in case 1. (FIG. 30C) Before the E.F. was applied (case 2), and (FIG. 30D) the corresponding image after the E.F. has been applied in case 2. The experimental results of the present research affirm that an electric field purposely created and oriented near a printing orifice can have a significant effect on droplet coalescence on the substrate. This electrically enhanced printing process offers the ability to control or tune printing parameters in 3D printing due to a greater window of droplet coalescence. The addition of an E.F. near the printing orifice allowed droplets to be printed with spacing much greater than those found in literature while still achieving an intact trace through coalescence. Potential advantages of this printing enhancement include: a reduced volume of ink, adjustable modulation of the printed surface roughness, reduced printing defects, and the ability to connect broken traces when a conventional printing method has failed. The Coulomb force employed here can be accurately controlled, is repeatable and easily scalable to industrial applications.

A commercially available printer, for example, may be modified with the inclusion of two electrodes equally distanced from the nozzle creating a controllable transverse electric field. Two inks including linseed oil and a photo-curable resin (Spot-E) were tested, and in both cases extended initial distances between droplets prior to their electrocoalescence were used. While the ability of the E.F. to coalesce lines into thin films was not as pronounced as in the experiments where droplets were combined into continuous lines, the present experiments reveal a proof of concept and prospective possibilities for thin film formation for jetting-based 3D printing of printed electronics. Since no electrodes are on or beneath the printing surface in the present case, the enhancements gained from the E.F. will remain consistent through a layer-by-layer build. Whether being implemented into new designs, or retrofitted onto existing, the present innovative technique holds great promise of transforming discreet droplet arrays into lines or thin films with tuneable parameters and versatility not found in conventional jetting-based printing.

The present disclosure reveals that an electric field, strategically generated near a printing nozzle, can be used to enhance the DIW jetting process, allowing an orders of magnitude faster speed while reducing the dependence on surface smoothness. The accurate and repeatable jetting enhancement was achieved utilizing the Coulomb force imposed by the electric field oriented in the direction of printing. This approach, first applied in this work to a translating belt system with a fixed nozzle, allowed a high-speed camera to visualize changes in the extruded ink jets. Next, a commercially available printer was modified in this work by the inclusion of a leading electric field acting on a photo-initiated ink Spot-E. Specifically, the addition of a single electrode to the print head, was able to increase the print speed while achieving a higher printing resolution and enabling printing on super-rough substrates. With no electrode or grounded substrate required in the present case, the benefits gained from the E.F. will not diminish with an increase in the build height. The present innovative approach holds great promise for (i) an increase in the overall build speed and throughput while maintaining or even enhancing resolution, and (ii) a further increase in versatility of nozzle-based printing methods by expanding substrate choices previously limited or excluded due to their roughness.

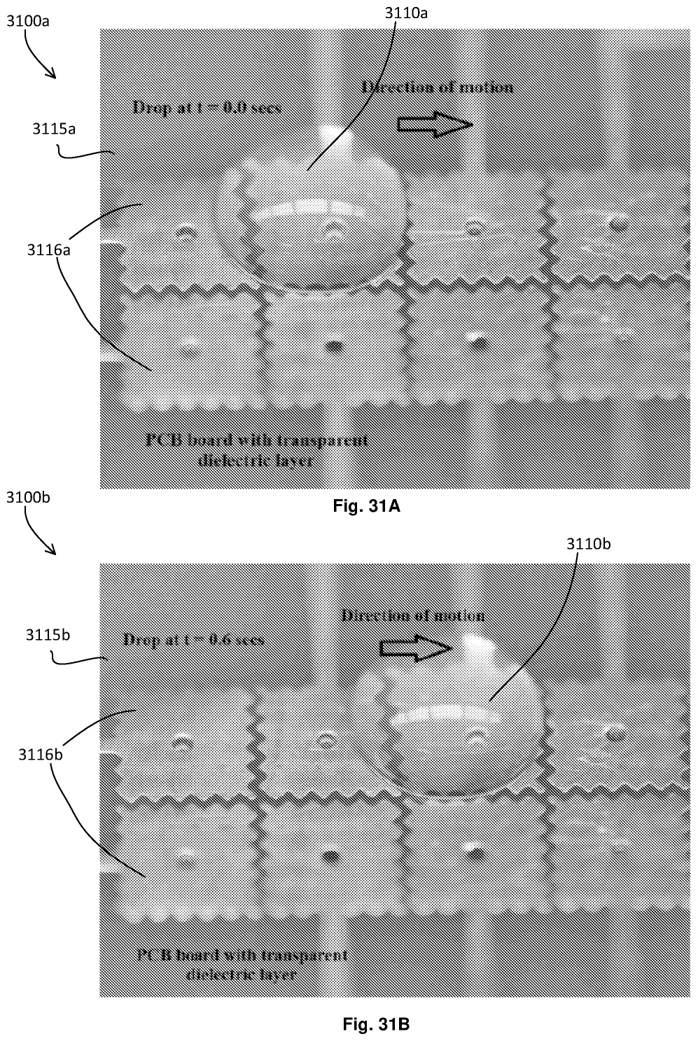

With reference to FIGS. 31A and 31B, electrowetting is illustrated in conjunction with motion control of droplets 3110a,b of different liquids, which are widely used as inks in Direct Writing (DW) based 3D printing processes for various applications. To control the movement of DW ink droplets on dielectric substrates, the electrodes were embedded in the substrate. It is demonstrated that droplets of pure-liquid inks, aqueous polymer solution inks, and carbon fiber suspension inks can be moved on horizontal surfaces. Also, experimental results reveal that droplets of a commercial hydrogel, agar-agar, alginate, xanthan gum, and gum arabic can be moved by electrowetting. Droplets 3110a,b of sizes of 200 μm and 3 mm were manipulated and moved by the electric field on different dielectric substrates accurately and repeatedly. Effective, electrowetting-based control and movement of droplets were observed on horizontal, vertical and even inverted substrates. These findings imply the feasibility and potential application of electrowetting as a flexible, rapid, and new method for ink droplet control in 3D printing processes.

Direct Writing (DW) is a class of Additive Manufacturing (AM, also known as 3D Printing) techniques which deposit functional and/or structural liquid materials onto a substrate in digitally defined locations. Based on the dispensing form, DW could be classified into droplet-based and filament-based. DW differs from conventional AM in terms of the following characteristics. (i) The range of materials deposited can include liquid polymers,⁴⁻⁷ particle suspensions,⁸⁻¹⁰ electronically and optically functional liquids,¹¹⁻¹⁴ as well as biological liquids;¹⁵⁻¹⁷ (ii) The track width ranges from sub-microns to millimeters; and (iii) the substrate is an integral part of the final product, and it could be flat, curvilinear, round, flexible, irregular or inflatable.³ A wide variety of applications from flexible electronics fabrication to functional tissue printing has been demonstrated during the past twenty years.

However, despite this progress, many grand challenges still exist in the printing quality. Ink droplet wetting and spreading coupled with complex fluid dynamics involved plays an important role in defining the surface roughness and geometrical accuracy of the features fabricated by DW. Because of this complexity, many manufacturing defects, including the coffee-ring effect, bulging, liquid puddles, liquid splashing, and scalloped or discontinued line, are caused by the undesirable wetting and movement of liquid ink on the substrate.

Some research efforts have been directed on controlling the substrate wettability, and hence, the liquid ink droplet movement and location on the substrate, to improve the print quality (e.g., eliminating the coffee-ring effect, improving surface finish and edge sharpness). Controlling the ink droplet movement during the Direct Writing process would enhance the locating precision, printable feature size, and printed geometry accuracy. However, all the efforts that have been made to control ink droplet wetting and movement on substrates were focused on substrate surface modification, including changing substrate chemical composition by coating a new layer or changing the surface topology. Yet, chemical modification sometimes is undesirable as it affects the functionality and properties of the final product. The surface topology modification methods, including plasma treatment and surface machining, are time-consuming, costly, and the modified substrate surfaces may easily get damaged during the DW process. Furthermore, the effects of those methods on droplet-substrate interaction are irreversible. Lastly and most importantly, all those control methods cannot dynamically and locally control the droplets. Lack of those capabilities significantly limits the choice of inks and Direct Writing performance.

To seek information pertaining to present-day challenges and potentially inspire new techniques in an expanding industry, a new ink droplet control method using electrowetting is proposed and explored here. Experiments were intended, designed, and performed to study the feasibility of using electrowetting to dynamically control local wetting, spreading and movement of DW ink droplets, on a wide range of substrates. Direct Writing techniques have been applied in industry to fabricate multiple objects for various applications employing numerous liquids as feedstock when printing. In this study, seven categories of liquid inks commonly used in DW are investigated here:

(1) Electrically conductive nanofiber-suspension inks: In this category, a widely used DW ink is Carbon nanotube (CNT) suspension, due to the light weight and excellent mechanical properties of C. In addition, CNT suspensions are also widely used as inks for printing of energy storage devices, such as supercapacitors and batteries, due to their excellent conductivity, large surface area, and good mechanical properties. Hence, in this work a CNT suspension ink was prepared and studied to elucidate the associated electrowetting effects.

(2) Aqueous polymer inks: They are often used as enhanced electrolyte materials in direct writing of various electrochemical devices and high-performance solid-state batteries, because of their superior mechanical strength, biocompatibility, electrochemical stability, and abrasion resistance. Accordingly, in this study, aqueous polymer solutions including polyvinyl alcohol (PVA), polyethylene oxide (PEO), polyacrylamide (PAM), and polycaprolactone (PCL) are investigated.

(3) Non-aqueous polymeric liquid inks: Non-aqueous polymeric liquid inks are widely used in Direct Writing. This study explored three non-aqueous polymeric liquid inks: Spot-E (Spot-A Materials, Spain), Trimethylolpropane triacrylate (TMPTA) and dioctyl terephthalate (DOTP). Spot-E is a photopolymerizable resin used for Direct Writing of objects for applications requiring rubbery and soft, yet resilient materials. TMPTA is widely used as a functional monomer in preparing inks for DW, due to its low volatility and fast cure response. DOTP is usually used as a plasticizer or an additive to prepare inks for Direct Writing of objects such as phantoms for biomedical applications.

(4) Hydrogels: Natural ingredients like alginate, chitosan, xanthan gum or gum arabic are widely used for preparing water-based inks for DW based 3D bio-printing applications such as tissue engineering and 3D food printing. In this study, several natural hydrogels are prepared and investigated.

(5) Silicone-based soft elastomers: They are commonly used as DW inks to print fundamental construction supports in many reported electronic and soft robotic applications. This type of ink also provides an efficient bio-compatibility for skin sensors. Two elastomers, Ecoflex and PDMS, are investigated in this study.

(6) Ionic liquids: This type of ink has been employed in DW for printing batteries and other storage devices. In addition, ionic liquids have been explored as solvents for polymerization processes and for structures of grafted components emerging in DW based 3D printing applications. Benzyltrimeth OH and NaCl ionic liquid inks are investigated in this work.

(7) Liquid crystal inks: They have found successful applications in watches and flat-panel displays. Newer applications are being developed and used in optics, nano-manipulation, composites, and biotechnology. Specifically, molecularly-oriented liquid-crystalline polymers have shown great promise by outperforming 3D-printed polymers via creating highly ordered structures. Hence, a liquid crystal ink, 4′-Pentyl-4-biphenylcarbonitrile, is investigated in this study.

Electric fields have an impact on droplets containing ionic conductors and this phenomenon is called electrowetting. While the term electrowetting originated relatively recently, using surface charges to manipulate water droplets has been in practice for over a hundred years. Due to several modern applications such as digital lenses and circuitry, atomization, spray painting, coating, aging of high voltage insulators, etc., interest in electrowetting has exploded in recent years. The term electrowetting describes a droplet's ability to change its contact angle with the underlying surface when subjected to an electric field, thus changing the wettability by electrical means. Essentially, electrowetting is an active control method, which allows switching between wettable and non-wettable surface states, without modifying the surface or changing any liquid properties. Electrowetting is very repeatable and non-destructive, which is attractive for such practical applications as spray coating, spray painting, adhesion, micro-fluidics, etc.

In general, two types of electrowetting are recognized and distinguished, specifically, classical electrowetting (EW) and electrowetting on dielectrics (EWOD). In the case of the classical EW, a droplet is in direct contact with one electrode and is separated from the second electrode by a dielectric layer. Depending on the droplet electrical conductivity, the droplet can also be considered as an extension of the electrode. Monographs and reviews discussing EW are available from several sources. In particular, this disclosure discusses and compares EW phenomena for a number of liquids with different dielectric properties, polarizabilities and viscosities. One of the interesting applications is the so-called ‘beating mercury heart’, in which periodic EW can be realized accompanied by a periodic change of droplet shape or even motion on inclined surfaces.

In contrast, in the EWOD applications, droplet are not in direct contact with either of the electrodes and are completely separated by a dielectric layer and air gap. Both methods affect the equilibrium contact angle of droplets. However, it should be emphasized that the voltage required to change the contact angle is lower in case of classical EW compared to EWOD. An increase in surface wettability requires an external work to be done, enabling the liquid to increase its surface area and thus the surface energy. In both cases of electrowetting, the electric field does the external work and can be actively controlled. Generally, when a voltage is applied, EW is associated with the reduction in the solid-liquid interfacial energy. This phenomenon is due to the free charges (ions) rearranging within the liquid (implied to be an ionic conductor), consequently redistributing the forces acting between a droplet and the dielectric surface. Manipulation of these forces through EW can be observed and characterized through the changing equilibrium contact angles and is described using the Young-Lippmann equation. Experimentally, the equilibrium contact angle can vary with the applied voltage and change from large values (hydrophobic, or even superhydrophobic) to small values (hydrophilic). In addition, controlling the surface wettability by manipulating the electric field holds great promise for droplet manipulation in such applications as digital microfluidics, electronic displays, paint drying, responsive cooling, adjustable focusing lenses and so on. While EW had already proven its importance in many fields, it remains a complex phenomenon and is far from being completely understood. This lack of understanding is especially true for problems with coupled physics, e.g., the interaction of droplets on a surface (DIW Printing) within an electric field, and leaves many open questions.

In the past, many researchers investigated the impact behavior of droplets onto a dry surface without an electric field. These experiments were conducted with changing surface materials and textures, which revealed a dependence of the droplet behavior on the wettability and roughness of the substrate. The impact of droplets onto a dry wall was characterized, and such regimes as deposition, prompt splash, corona splash, receding break-up, partial rebound, and complete rebound were distinguished. Accordingly, the behavior of impacting droplets is rather complex even without an electric field applied and depends on different parameters, such as the droplet size, impact characteristics, the Weber number, as well as the surface properties. The dependence on the surface properties is expressed via the values of the advancing and the receding contact angles, □_{adv} and □_{rec}, respectively. It was also shown that the droplet behavior can be significantly influenced by the electric field diminishing the influence of surface properties. Generating a net force acting on liquid near the contact line, the electric field can prevent droplet bouncing on a hydrophobic surface and induce movement of sessile droplets. This movement arises when the force applied by the electric field reduces the advancing contact angle. Depending on the receding contact angle, residual droplets can also be formed.

In the present work, the effects of the electric field on 3D printable ink droplets deposited on dielectric surfaces are investigated. The manipulation of droplet position on the surface and the elucidation of the interplay between the electric field and the droplet motion are in focus in this work. The underlying physics of EWOD is outlined herein. An experimental investigation of printable inks is performed on different hydrophobic surfaces under varying conditions of electrowetting.

In perfect conductors with very high electric conductivities, charge relaxation time τ_{C} approaches zero (i.e. the electric charges escape immediately), whereas in perfect dielectrics τ_{C} approaches infinity since the latter possess zero conductivity. Ionic conductors (electrolytes) are of interest here. They possess finite electric conductivities which correspond to finite values of the charge relaxation time. An assortment of polar and non-polar liquids reveals values of the charge relaxation time τ_{C} in the 1 μs to 20 s range.

Flowing electrolytes can be affected by the electric field imposed by solid surfaces, which might be dielectric or conducting. Any flow possesses its own characteristic hydrodynamic time τ_{H} which may be associated with either the residence time of material elements in the flow zone or the time of droplet spreading over a surface. Accordingly, the dimensionless group:

$$α = \frac{{τ}_{C}}{{τ}_{H}} \qquad ( 74 )$$

determines the electrolyte behavior. If α<<1, the electrolyte behaves as a perfect conductor irrespective of its relatively low conductivity. This means that the electric charge can immediately escape into a conducting wall or adjust itself to the ζ-potential of a dielectric surface in contact. For example, a charged oil droplet of very low conductivity located at a dielectric wall for a sufficiently long time would essentially possess the characteristic hydrodynamic time τ_{H}=∞. Thus, in this case, α=0; so the electric charges (ions) always have enough time to adjust themselves to the ζ-potential of the underlying wall. Therefore, even a poorly conducting oil droplet can be considered as a perfect conductor in such cases. On the other hand, when a charged oil droplet is impinging onto a wall and spreading after the impact on the order of time τ_{H}=1 ms, the value of α=2×10⁴, because the charge relaxation time τ_{C} is about 20 s. As a result, in such a transient situation the same oil droplet would behave as a perfect dielectric, and the prediction of the charge redistribution over its bottom during the spreading stage would require the solution of the electrokinetic equations coupled with the flow equations. Also, when α is of the order of one, the charge redistribution would happen during the flow and would be coupled with the flow evolution.

It should be emphasized that the ion distribution at the droplet bottom could be quasi-static, which implies that it is achieved at the droplet bottom at any configuration without a delay. This assumption is true, for example, for water droplet impact, where τ_{C}˜1 μs, i.e., much less than the characteristic impact time τ_{H}˜1 ms, which corresponds to the case of α<<1. This assumption would be inappropriate in cases with α˜1 and α>>1.

In general, the electrostatic energy embedded in the droplet bottom associated with the accumulated ions is:

$${E}_{el} = \frac{1}{2} {\int }_{bottom} {σ}_{ion} UdS \qquad ( 75 )$$

The potential U is essentially imposed by the surface to the accumulate ions in a liquid. The surface concentration of the free ions σᵢₒₙ should be found using a solution of the Laplace equation in the dielectric substrate and the electrostatic boundary conditions at its surface. Note that in the case of a conductive substrate, U is a given constant, because such a substrate is equipotential.

In order to specifically find σᵢₒₙ in a droplet evolving during the impact or movement, the following electrokinetic equations should be solved:
(i) The balance equations for the cations and anions concentrations c^{±}

$$\frac{\partial {c}^{\pm }}{\partial t} + ∇ \cdot ( {c}^{\pm } v ) = D {∇}^{2} {c}^{\pm } \pm \frac{De}{{k}_{B} T} ∇ \cdot ( {c}^{\pm } ∇ φ ) \qquad ( 76 )$$

They account for diffusion (D is the diffusion coefficient), convection (v is the velocity field), and the electric migration (with e being the proton charge, k_{B} being the Boltzmann's constant and T equal to temperature);
(ii) The Poisson equation, which determines distribution of the electric potential φ in the droplet on the surface:

$${∇}^{2} φ = - \frac{4 π q}{ε} \qquad ( 77 )$$

with ε being the dielectric permittivity of liquid, and the local volumetric charge equal to q=e(c⁺−c⁻). Note also, that each droplet carries both anions and cations, which might be in balance if it is uncharged, or unbalanced if it is charged.
(iii) The Navier-Stokes equations, which are solved to determine the velocity field v affected by Coulombic force determined using Eqs. (75) and (76).

The contact angle is required to find the contact line (CL) velocity and thus, update the drop footprint during the numerical simulations based on Eqs. (75)-(77). The contact angle should be calculated as follows. The surface tension (surface energy) at the solid-liquid interface (the droplet bottom) σₛₗ is diminished from its original value σₛₗ⁰ (without the electric field) by the value of the electric energy. This is mainly due to the presence of ions and the fact that they repel each other:

σₛₗ=σₛₗ⁰−Eₑ₁ (78)

In equilibrium, the Young equation reads:

σₛₐ=σₛₗ+σₗₐ cos θ_{eV} (79)

where σₗₐ=γ is the surface tension, θ_{eV} is the equilibrium contact angle after a voltage has been applied, and τ^{sa} is the surface tension (surface energy) at the solid-air interface.

Similarly, without voltage:

σₛₐ=σₛₗ⁰+σₗₐ cos θₑ₀ (80)

where θₑ₀ is the known equilibrium contact angle without voltage.

Then Eqs. (5)-(7) yield:

$$cos {θ}_{eV} = cos {θ}_{e 0} + \frac{{E}_{e ℓ}}{γ} \qquad ( 81 )$$

which is, essentially, a novel generalized form of the Young-Lippmann equation.

In the case of a rough surface, similarly, the adoption of the Wenzel-state assumption would transform Eq. (8) to the following form:

$$cos {θ}_{eV} = r ( cos {θ}_{e 0} + \frac{{E}_{e ℓ}}{γ} ) \qquad ( 82 )$$

where the known factor r expresses the ratio of the real surface area of the droplet bottom to the projected one.

After the equilibrium contact angle under an applied voltage is established using Eqs. (8) or (9), the Hoffman-Voinov-Tanner law⁹² is utilized to find the velocity of the CL motion. Namely, the relation of the dimensionless velocity of the CL in the form of the capillary number Ca=u_{CL}□/γ□ (with u_{CL} being the contact line velocity) and the contact angle is found as:

Ca=g_{Hoff}(θ_{D})−g_{Hoff}(θ_{eV}) (83)

In Eq. (83) θ_{D} is the dynamic advancing contact angle known at each time step from the predicted current droplet shape, and:

$${g}_{Hoff} ( x ) = {f}_{Hoff}^{- 1} ( x ) , {f}_{Hoff} ( x ) = arccos \{ 1 - 2 tanh [ 5.16 {( \frac{x}{1 + 1.31 {x}^{0.99}} )}^{0.706} ] \} \qquad ( 84 )$$

Note that in Eq. (84) x is a dummy variable.

Note also that the standard form of the Young-Lippmann equation (81) is written as:

$$cos {θ}_{eV} = cos {θ}_{e 0} + \frac{{C}_{s} {U}^{2}}{2 γ} \qquad ( 85 )$$

where Cₛ is the capacitance corresponding to a particular geometry.

The implementation of the algorithm based on the numerical solution of Eqs. (75)-(77) and (81)-(84) would require the solution of the three-dimensional transient problem with the free surface and a moving contact line, which is outside the scope of the present work.

Note also that an alternative approach to modeling of symmetric droplet movement on polarized and non-polarized dielectric surfaces and the subsequent spreading and oscillations employed the Cahn-Hilliard-Navier-Stokes (CHNS) technique to describe EWOD phenomena and shed light on droplet manipulations that can be used in novel applications.

To explore the electrowetting effects acting on ink droplets in DW, we integrated an electric field generation unit into a Direct Writing prototype. As illustrated FIG. 25A, a movable x- and y-table as a support for the specimens, along with two different droplet generation systems and a high voltage power supply. The high voltage is selectively applied to different electrodes via micro-controller and circuitry. To generate droplets with a minimum diameter of d=2 mm, an automated syringe pump (single syringe pump NE-300) is connected to a needle of the appropriate size. A liquid ink droplet is pumped through the needle. The droplet size is defined by the needle diameter and surface tension of the fluid because the droplet detaches from the needle due to gravity. The droplet diameter d, in this case, is of the order of a millimeter and varies with the needle diameters. To generate droplets with sizes smaller than 1 mm, a commercial droplet generator (e.g., Nordson Ultimus I, etc.) was used in the DW testbed. Droplets of diameter of ˜250 μm were generated and explored in this work. The droplet generator creates a well-defined pressure pulse for a specific time interval and forces the liquid to flow through the needle. In this case, the distance between the surface and the needle should be in the same order as the needle diameter to ensure droplet detachment. A schematic of the system is shown in FIG. 32A.

With reference to FIG. 32A and FIG. 32B, details of droplet deposition and polarity are illustrated. The distance between the needle and the surface may be h=˜300 μm-3 mm, so that droplets may be deposited at specific locations above or between the electrodes. The surface on which droplets were deposited consisted of three different layers, dielectric support layer, copper electrode layer, and a dielectric layer, as shown in FIG. 32B. Two electrodes made of commercial copper tape adhered to a dielectric support. Glass, polyvinyl chloride (PVC) and circuit boards were used to support the dielectric layers. The distance between the electrodes was varied between 0.127 and 25 mm to investigate its influence. The electrode-electrode distances, such as 0.127 mm and 0.15 mm, were achieved through the fabricating of self-designed circuit boards. For example, a self-designed circuit board with a pad size of 3 mm and an air insulation gap of 0.15 mm between the electrode pads, is shown in Figs. It should be emphasized that this air gap is filled with a 5 cSt silicone oil, which is deposited as a thin coating.

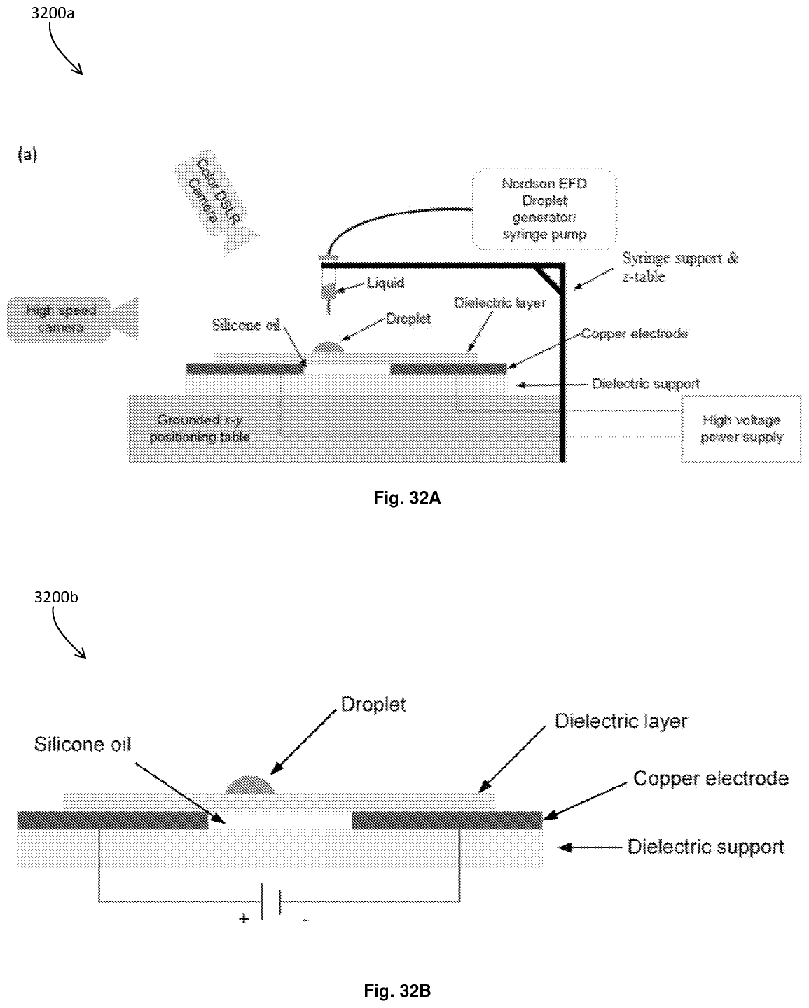

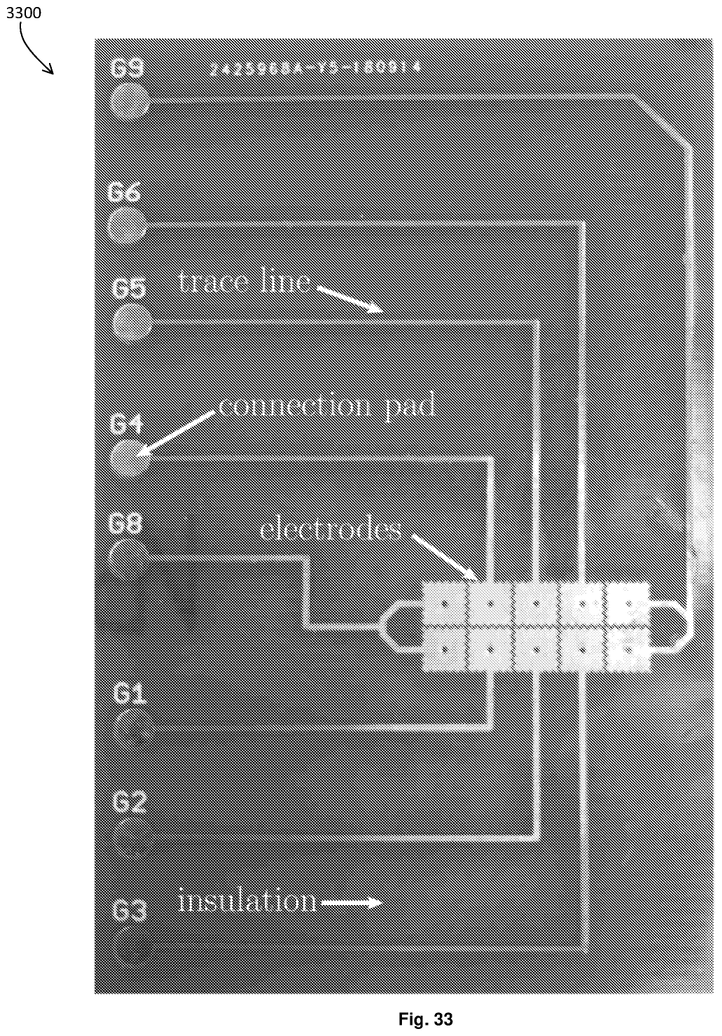

Turning to FIG. 33, an example electrode array 3116a,b on PCB (Printed Circuit Board) board 3115a,b may include an electrode size of 3 mm and an insulation distance of 0.15 mm. The insulation layer is invisible in this image. A voltage between 0 and 10 kV was applied between the electrodes depending on the electrode size as well as the insulation gap. Large voltages up to 10 kV are only applied for large insulation gaps like 25 mm. A reduced insulation gap requires smaller voltages. This results in a driving voltage between 200 V and 400 V required to move droplets with insulation gaps around 0.5 mm. Reducing the insulation gap increases the electric field strength for a constant voltage, therefore the voltage can be reduced for small gaps while keeping the electric field strength constant. To insulate the electrodes from the liquid and to prevent short circuit, a dielectric layer is used to cover them. Accordingly, droplet are only in contact with the dielectric layer.

While initial experiments on droplet motion started with just two crudely-made electrodes, PCB technologies quickly enhanced capabilities allowing many electrodes to be placed on the same circuit board in a small area (cf. FIGS. 3A and 3B). Precision control of these electrodes was achieved using an Arduino micro-controller coupled with a module 123b, 131b. By switching the polarity of the electrodes, the electric field lines and the forces associated with them were choreographed. This allowed a user-defined timing and control of droplet motion in the x-, y-, and even z-directions. A high-voltage power source was applied to high-voltage relays which were in turn activated by a system of optocouplers and transistors used to isolate the high-voltage circuit from the Arduino micro-controller. As the polarity is switched throughout the array of electrodes, relays activate on the Arduino microcontroller's command, providing a closed circuit between the electrode and high-voltage source. To deactivate the active electrode and return it to a grounded state, the relay is opened by the Arduino's programming, which allows the small capacitance stored in the electrode to be neutralized by the ground via an appropriately-sized high-voltage resistor. Changing the resistance controls the characteristic time required to return the electrode to a grounded state. For potential differences on the order of 100 V, a 1 M ohm resistors were used, while 100 M ohm resistors were used to neutralize the electrodes down from voltages ˜10,000 V. Precise droplet control was achieved through these methods, and the droplet's evolution and motion were captured using a high-speed camera (Phantom V210) and shadowgraphy. All experiments were performed under ambient conditions.

Various dielectric substrates commonly used in DW processes are explored in this study, including commercial Teflon tape, commercial wax paper (parafilm), Teflon FEP and PFA foil, as well as commercial Kapton tape with sizes of about 25 mm×25 mm. These substrate materials possess different surface properties including roughness, wettability and uniformity. Unstretched Teflon tape has a hydrophobic surface with a contact angle of about 100°. To increase the hydrophobicity, the Teflon tape is stretched, which results in the contact angles of 150°. In contrast, the wax paper and Kapton tape are less hydrophobic with contact angles around 105° and 95°, respectively. In addition to different surface wettability, the tested dielectric layer materials also have different relative dielectric permittivity values and thicknesses, as listed in Table 2. The thickness of the dielectric layer was kept as small as possible to reduce the necessary voltage required to manipulate the droplets. The most promising dielectric layer for experiments conducted with water and water-based liquids was found to be commercial wax paper (parafilm). To achieve the best surface properties, the parafilm may be stretched to reduce the thickness and is covered with a very thin layer of silicone oil. As a result, the surface repels water very well and enables easy motion of droplets on the surface. Furthermore, the thin layer does have a negligible influence on the required voltage. When testing non-aqueous liquids, FEP was found to exhibit the best surface properties for drop motion.

TABLE 2
Material properties of the specimens.

| | | Relative dielectric |
|---|---|---|
| Material | Thickness in mm | permittivity |
| Teflon tape (unstretched) | ~0.1 | ~2.1 |
| Teflon tape (stretched) | ~0.02 | ~2.1 |
| Parafilm | ~0.02-0.13 | ~2.2 |
| Kapton tape | ~0.05 | ~3-4 |
| Teflon FEP and PFA films | ~0.005 | ~2.0 |

To investigate the influence of ink properties on electrowetting-based droplet control, various liquid inks were prepared, each having a unique viscosity, surface tension and chemical composition. The tested liquid inks include aqueous polymer solutions, non-aqueous polymer solutions, hydrogels, silicone-based inks, electrically conductive inks, ionic liquids, liquid crystals, as listed in Table 3.

TABLE 3
List of inks and their solubility in water.

| | | Solubility |
|---|---|---|
| Ink | Classification | in water |
| Deionized water | Common liquid | Yes |
| 50 wt % water/glycerol mix | Common liquid | Yes |
| Pure glycerol | Common liquid | No |
| CNT | Nanofiber suspension | Water-based |
| | | suspension |
| Basic PVA | Aqueous polymeric | Yes |
| PVA with LiCl | Aqueous polymeric | Yes |
| PVA with HCL or NaOH | Aqueous polymeric | Yes |
| Basic PEO | Aqueous polymeric | Yes |
| PEO with LiCl or KCl | Aqueous polymeric | Yes |
| PAM | Aqueous polymeric | Yes |
| PCL | Aqueous polymeric | Yes |
| Spot-E | Non-aqueous polymeric | No |
| Dioctyl terephthalate | Non-aqueous polymeric | No |
| Trimethylolpropane triacrylate | Non-aqueous polymeric | No |
| Ecoflex | Silicone-based | No |
| PDMS | Silicone-based | No |
| Commercial hydrogel | Hydrogel | Yes |
| Agar-agar | Hydrogel | Yes |
| Alginate | Hydrogel | Yes |
| Xanthan gum | Hydrogel | Yes |
| Gum arabic | Hydrogel | Yes |
| Chitosan | Hydrogel | Yes, with acid |
| Sericin | Hydrogel | Yes |
| Benzyltrimeth OH in water | Ionic liquid | Yes |
| Benzyltrimeth OH in methanol | Ionic liquid | Yes |
| NaCl in water | Ionic liquid | Yes |
| 4′-Pentyl-4-biphenylcarbonitrile | Liquid crystal | No |

As a reference, pure deionized water, which has a surface tension of γ=72.75 N/m and a kinematic viscosity of ν=1.0034×10⁻⁶ m²/s at ambient conditions, may be deposited. To vary the viscosity and surface tension, deionized water was mixed with pure glycerol, which has a surface tension of γ=63.4×10⁻³ N/m and the kinematic viscosity of ν=5.2×10⁻⁵ m²/s. A mixture of 50% water and 50% glycerol was tested along with pure glycerol.

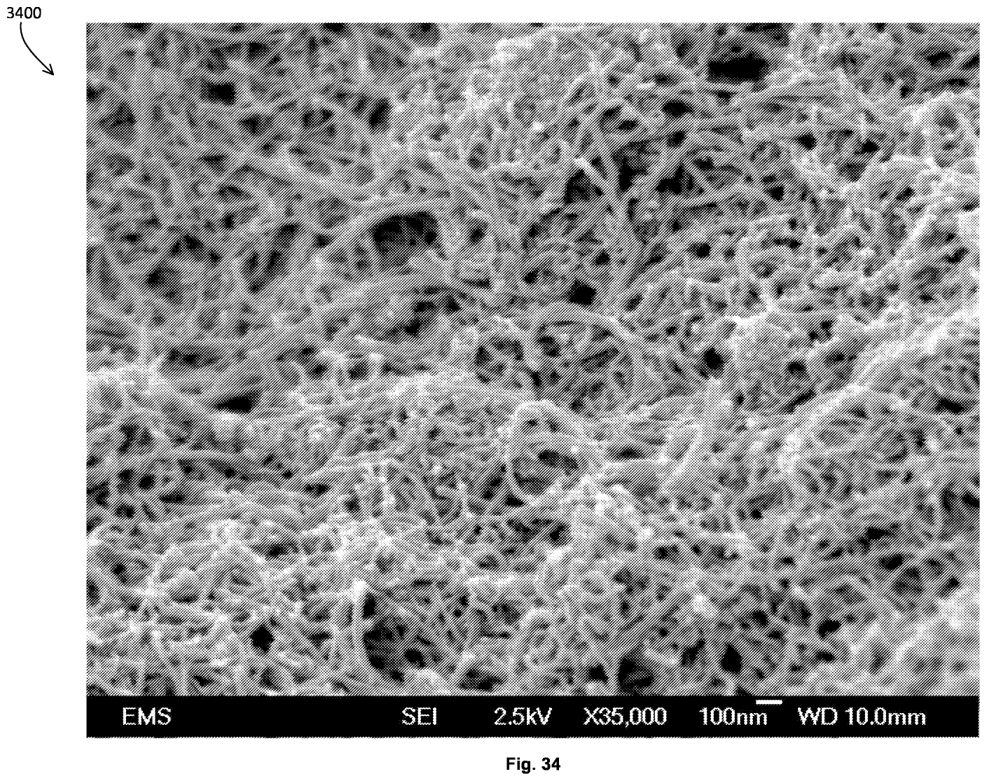

Multi-walled carbon nanotubes (MWNT) (purity>95 wt %, 10-20 nm), from Cheaptubes (product code 030103) were used as received. 50 mg of MWNT and 125 mg of sodium dodecyl sulfate powder (>99.0%, Sigma-Aldrich) was mixed with 50 mL deionized water in a mixer (e.g., AR-100, Thinky) at 2000 rpm for 15 min, and then sonicated in a probe sonication (QSonica Q500, 60% power) by 1 hour. After that, the carbon nanotubes were uniformly dispersed in the suspension. The prepared water-based nanotube ink is a conducting fluid due to the presence of the suspended carbon nanotubes. The rheological behavior of the CNT ink is similar to that of water, but the electrical conductivity is much higher. A droplet of a CNT ink was placed on a glass specimen and dried at ambient temperature. The orientation of the CNTs was investigated by a scanning electron microscopy (SEM), after drying with and without the influence of an electric field. FIG. 34 shows an example of the CNTs observed in a SEM image. The length of individual CNTs is of the order of several microns, and the diameter is less than 100 nm. The CNTs are randomly distributed and not aligned by the electric field, implying that the electric field, as well as ink preparation process including the sonication, have no influence on the alignment and size of the CNTs in the prepared ink.

Turning to FIG. 34, a SEM image of sonicated ink (a CNT suspension) dried under the effect of 1 kV electric potential difference at ambient temperature. Preparation of the PVA-based electrolyte ink (PVA) is a two-part process. First, 6 g of PVA powder (Mowiol® 18-88, mol wt ˜130,000, Sigma-Aldrich) was added to 40 g deionized water. Second, the solution was stirred (Eurostar 60, IKA) on an 85° C. hot plate for at least 45 min at a 500 rpm rotating speed. This base solution was kept as the control, while other components were added to the solution to check their influence on the droplet motion. PVA is a highly polar molecule with amphiphilic properties due to its hydrophilic —OH group. 12 g of lithium chloride powder (>99.0%, Sigma-Aldrich) were added to the base solution and stirred to form an electrolyte. Dissolving the lithium chloride powder adds ions in the ink and thus increases the mobility of electrons Furthermore, the pH value of the base solution was measured at pH≈6. Adding some acid (HCl) or base (NaOH) resulted in a changed pH value and in both cases only a droplet of the acid or base was mixed with the original solution. Adding a droplet of a 37% HCl solution resulted in a pH value of ˜2 and the solution with a droplet of a 50% NaOH solution yielded pH≈12.

Similarly to the preparation of the PVA solution, 6 g of Polyethylene oxide (PEO) powder (Sigma Aldrich, M_{w}˜200,000 Da) is dissolved in 40 g of deionized water resulting in a 13% solution. After mixing, the solution is stirred on a hot plate at a temperature of 85° C. for several hours. In contrast to PVA, PEO is a nearly non-polar molecule due to the symmetric chemical structure. Nevertheless, the base PEO solution was also mixed with salts, and results were compared with the modified inks.

To compare the influence of the polarity between molecules, another highly polar molecule, Polyarylamide (PAM) was prepared, using a procedure similar to the PEO and PVA solutions. 6 g of PAM (Sigma Aldrich, M_{w}˜150,000 Da) is dissolved in 40 g of deionized water. The solution is stirred for several hours on a hot plate at a temperature of 85° C.

Besides the above-mentioned aqueous polymer solutions, PCL solution is prepared by dissolving 3.47 g of PCL powder in 40 g of acetone, and the mixture is stirred on a hot plate with a temperature of 85° C. for several hours.

Spot-E liquid polymer was purchased from Spot-A Materials (Spain) and used as received. Trimethylolpropane triacrylate (TMPTA) and dioctyl terephthalate (DOTP) were purchased from Sigma Aldrich (U.S.). Spot-E has the kinematic viscosity of ν=3.64×10⁻⁴ m²/s. The purchased Trimethylolpropane triacrylate and dioctyl terephthalate possess viscosities of η=80-135 mPa s and η=63 mPa s at 25° C., respectively. The DOTP was used as received. 20 ml of the TMPTA were mixed with 20 ml hexane (Sigma Aldrich) for printability and experiments.

To explore hydrogel inks affected by the electric field, several inks were prepared in the present study. A commercially available hydrogel (Skintegrity by Medline) was purchased and mixed with water. For printability, 10 g of the hydrogel is mixed with 20 ml of deionized water to form a printable gel. In addition to the commercial hydrogel, several gels commonly used in 3D bio-printing are prepared as follows. 2.1 g of alginate powder purchased from Sigma Aldrich is mixed with 40 ml of deionized water. The mixture is stirred for several hours at a temperature of 85° C. until fully dissolved. In a similar manner, 7 g of gum arabic (Sigma Aldrich) is dissolved in 40 ml of deionized water to prepare a 15 wt % solution. Two grams of sericin (Bonding Chemical) are dissolved in 8 g of deionized water forming a 20 wt % solution. Xanthan gum (Sigma Aldrich) and agar-agar (Sigma Aldrich) are also dissolved in deionized water and stirred on a hotplate in 0.5 wt % and 2 wt % solutions, respectively. In contrast to the other hydrogels formed solely in deionized water, chitosan is dissolved in a mixture of formic acid and water. Chitosan requires an acidic solution to fully dissolve, so a mixture of 20 ml of deionized water and 20 ml of formic acid is used to dissolve 2.1 g of chitosan. The three ingredients are stirred on a hot plate for several hours at a temperature of 85° C., forming a 5% wt. chitosan solution.

Two silicone-based inks commonly used in 3D printing⁹⁴⁻⁹⁷ are investigated. The first silicone-based ink is prepared by mixing Ecoflex with Smooth-On at the ratio of 50:50. The second silicone-based ink, Polydimethylsiloxane (PDMS), is prepared by mixing the base and the curing agent at the ratio of 10:1. In their uncured state as used in DW, Ecoflex has a viscosity η≈3000 mPa s at 25° C., whereas the uncured PDMS has a viscosity of η=3500 mPa s at 25° C.

Several room-temperature ionic liquids were purchased from Sigma Aldrich and used as received without further modification. Benzyltrimethylammonium hydroxide solution (40% wt. in H₂O) and Benzyltrimethylammonium hydroxide (40% wt. in methanol) are both tested. A third ionic liquid is formed by dissolving table salt to near saturation levels (˜26% wt.). The nematic liquid crystal 4′-Pentyl-4-biphenylcarbonitrile (liquid crystal, nematic, 98% Sigma-Aldrich) more commonly known as 5CB, was purchased and used in the present experiments without any further modification.

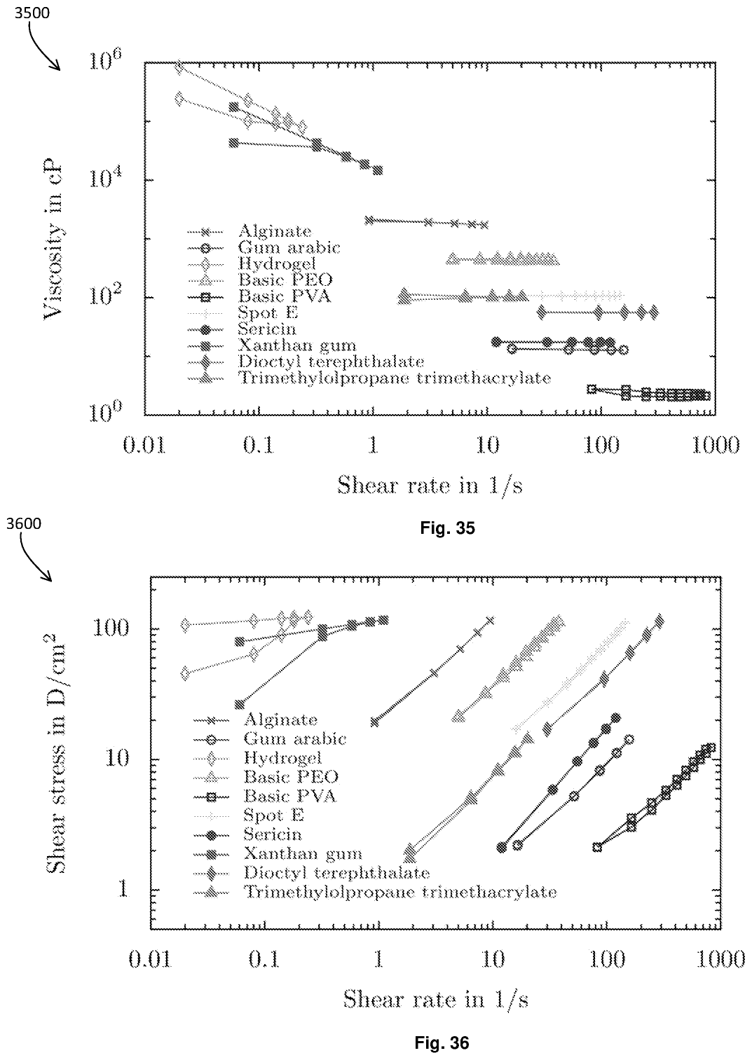

With reference to FIG. 35, flow curves of different inks measured using the rotational viscometer Brookfield DV II+ Pro are illustrated. Rheological behavior of the inks is characterized in a rotational viscometer (Brookfield DV II+ Pro). Every ink prepared in this study was tested by increasing and decreasing the shear rate between 10% to 90% of the maximum torque produced by the rotational viscometer. Hence, for every shear rate, two values for the shear stress and viscosity were measured. FIGS. 35 and 36 show the measured flow curves of the selected inks. FIG. 35 shows that xanthan gum and the hydrogel revealed a clear shear-thinning behavior. Also, alginate revealed a weak shear-thinning. All the other liquids revealed an almost constant viscosity, i.e. the Newtonian behavior in the tested shear-rate range.

Turning to FIG. 36, shear stresses corresponding to the flow curves of FIG. 35 are depicted. In addition, the inks were tested using a uniaxial elongational rheometer based on capillary thinning of a liquid thread. The uniaxial elongation tests were conducted with the commercially available ink (Spot-E), Trimethylolpropane triacrylate, dioctyl terephthalate, and Ecoflex. The results of these tests revealed Newtonian behavior (the linear-in time decrease of the cross-sectional radius of the thread) and are not included in here for brevity.

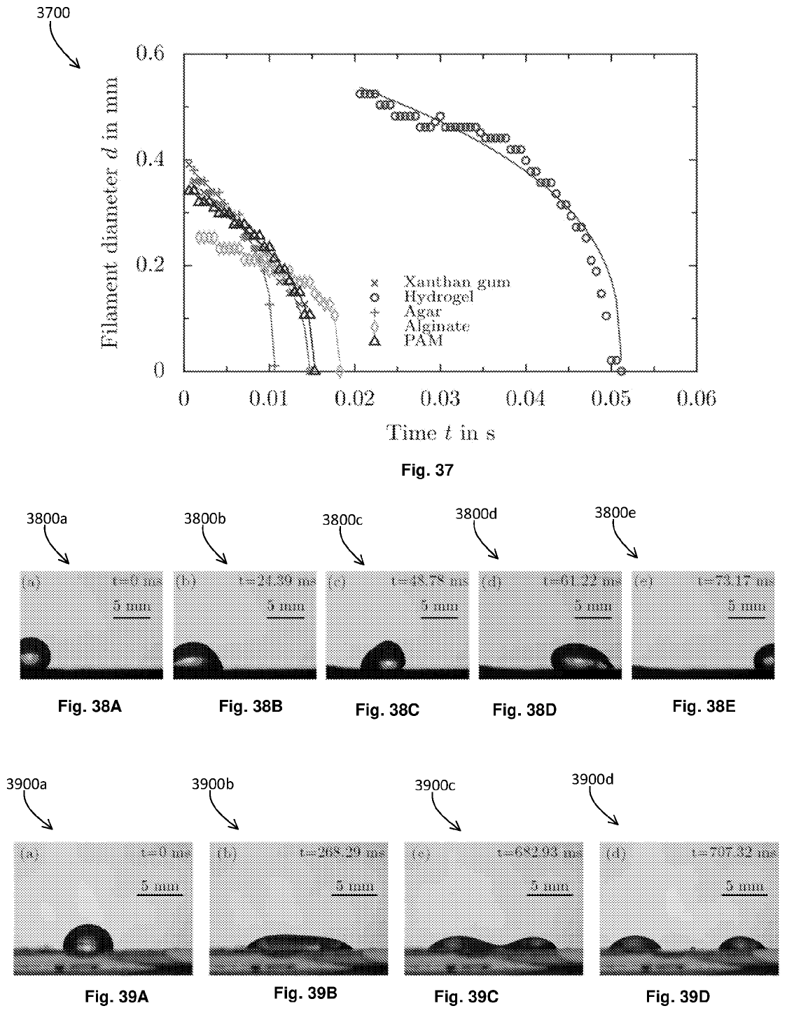

With reference to FIG. 37, results of the uniaxial elongation experiment are depicted, which revealed non-Newtonian behavior. Experiments were performed under different conditions with sessile droplets of different inks on a wide range of surfaces. Sessile droplet diameters were chosen with respect to the electrode sizes. It was found that the droplet footprint needed to commensurate to the electrode area. For example, droplets which were considerably smaller than the underlying electrode did not reveal an increased wetting in the direction of electrode switching and therefore, showed no movement on the surface. In cases where droplets were significantly larger than the electrode, they were unable to be confined above the electrode as undesirable flows and non-uniform shapes ensued. Air entrapment between the dielectric layer and the electrodes was avoided with the use of a silicone layer (shown previously in FIGS. 32A and 32B) to ensure a well-defined electric field. To test electrowetting capability in controlling ink droplet motion on hydrophobic surfaces, different surfaces were prepared. Similarly, the test results for the photosensitive ink, which revealed Newtonian behavior in simple shear, is not detailed here for brevity. Inks which exhibit non-linear thread thinning in time are non-Newtonian and the corresponding results obtained using uniaxial elongational rheometer are depicted in FIG. 37. The filament diameter formed during the experiments is measured as a function of time. Due to the surface-tension-driven squeezing of liquid from the filament, its diameter decreases in time until the filament breaks up. FIG. 37 shows the measured filament diameter as a function of time, as well as the corresponding data fits. Thinning of filaments of inelastic non-Newtonian fluids reveals a power-law behavior corresponding to the fits in FIG. 37. According to the results of the elongational experiments presented in FIG. 37, xanthan gum, hydrogel, agar-agar, alginate, and PAM are shear-thinning liquids with the uniaxial elongation results being in agreement with those of the simple shear flow experiments in FIGS. 34 and 35.

To determine the best surface and surface properties for controlling sessile droplet motion of different inks, experiments were performed on un-stretched and stretched Teflon, as well as on stretched parafilm. For these experiments, several liquids including deionized water, pure glycerol, 50 wt % glycerol-water mixture, basic PEO solution, basic PVA solutions, as well as Spot-E were tested. The initial surface used to investigate droplet motion was a glass sheet with copper electrodes spaced at distances between 15 to 25 mm. Such wide variation in electrode placement helped to determine the strength of the electric field required to move droplets over a predetermined distance.

To determine the effect of droplet placement and orientation within the electric field, ink droplets were set at different locations between the electrodes. The droplet motion was captured by a high-speed camera when the electric field was switched on. Through these experiments, position, droplet size, and the applied voltage have all shown significant impacts on motion.

At low voltages, the electric field between the electrodes does not lead to droplet motion regardless of its location. The droplet may lean towards one electrode, but the three-phase contact line stays pinned for low voltages. A further increase in the electric field strength causes droplets with the out-of-center positions to move. Droplets with a larger volume always require a lower voltage to begin moving irrespective of the substrate surface. The larger the droplets are, the larger is the disparity between their right- and left-hand sides if they are located off the center of the electrodes. Thus, they are subjected to a higher net pulling force. For the tested substrate surfaces, the stretched parafilm produced the most accurate and repeatable results. On the other hand, Teflon has nonuniform surface properties and thus less repeatable results. For both stretched and un-stretched Teflon, no difference in the motion onset voltage was observed. Nevertheless, Teflon stretching decreased layer thickness and may have had an influence on its hydrophobicity. It should be emphasized that a lower voltage was required in the case of the parafilm surface in comparison with that of the Teflon surface.

In most cases, the droplet motion reveals a stick-slip pattern at the contact line resulting in oscillations within droplets. Variations of the contact angle cause a partial spreading of the droplet. FIGS. 38A-E shows the stick-slip motion of a water droplet and the corresponding oscillations. With an increased liquid viscosity, droplets were observed to creep on the surface which resulted in a smoother motion. Under low electric field strengths, droplets located at the center between two electrodes are merely deformed and reveal no motion. In contrast, high electric field strengths induce motion of all droplets, irrespective of their positions. Besides initial placement, it was also found that sessile droplet motion depends on the electrode configuration. Uncharged droplets usually move to the high-voltage electrode and, therefore, away from the low-voltage electrode, as shown in

FIGS. 38A-E. However, in some cases, the opposite direction of droplet motion was observed, most probably because of a net charge on the droplet which causes an additional Coulomb force. Depending on the electric field strength, this additional force can cause motion in the opposite direction, as observed. The origin of the net charge might be in the accumulated charges on the dielectric layer, which are transferred to the droplet,^{102,103} or in charges, which are transferred during droplet deposition. FIGS. 38A-E depict motion of a sessile droplet from a grounded electrode (left) to the high-voltage electrode (right) accompanied by a stick-slip motion and the corresponding oscillations (surface waves on the droplet surface) at 8 kV. The inter-electrode distance is 12 mm.

For a more controlled droplet motion, an electrode array was designed, as shown in FIG. 33. The electrodes may be covered with stretched parafilm and a thin layer of silicon oil (10 cSt) which increased the ability of droplets to move. In addition, the silicon oil ensures that no air is entrapped between the electrodes and the dielectric layer. The size of the electrodes shown in FIG. 33 may be, for example, 3 mm×3 mm and the distance between the electrodes is 0.15 mm. Hence, droplets can be moved within a very short distance, and very precisely. If a droplet needs to be moved for a long distance, an electrode array similar to that in FIG. 33 may be used. Due to the small insulation gaps between the electrodes as in FIG. 33, droplet motion is possible even at low voltages such as ˜200 V. It should be emphasized that the voltage required to trigger droplet motion decreases with a decrease in the inter-electrode distance. The smaller the electrodes and the inter-electrode distance, the lower is the required voltage to achieve the critical electrical field strength for triggering the droplet motion. With the electrode array as shown in FIG. 33, repeatable drop motions can be performed at different speeds, with switching at frequencies of ˜10 Hz. Besides simple linear movement, the arrays were also programmed allowing precise control in two orthogonal directions. To manipulate ink droplets with smaller sizes, electrode sizes are reduced to about 0.127 mm and the inter-electrode distance is also reduced to 0.090 mm. Similar results were observed with this smaller electrode array.

However, it should be emphasized that controlled droplet motion was not possible for all liquids studied. Definite and precise motion control was achieved for most of the aqueous solutions including pure water and CNT suspensions, which behave like water. Table 4 summarizes the observed outcomes related to let motion for the liquids investigated in these experiments.

TABLE 4
Summary of the tested liquids and the resulting outcomes related to droplet motion.

| Liquid | Classification | Moveable |
|---|---|---|
| Deionized water | Common liquid | Yes |
| Pure glycerol | Common liquid | No |
| 50 wt % water - glycerol mix | Common liquid | Yes |
| CNT | Nanofiber suspension | Yes |
| Basic PVA | Aqueous polymeric | No |
| PVA with LiCl | Aqueous polymeric | No |
| PVA with HCl or NaOH | Aqueous polymeric | No |
| Basic PEO | Aqueous polymeric | Yes |
| PEO with LiCl or KCl | Aqueous polymeric | Yes |
| PAM | Aqueous polymeric | Yes |
| PCL | Aqueous polymeric | No |
| Ecoflex | Silicone based | Yes |
| PDMS | Silicone based | No |
| Hydrogel | Hydrogel | Yes, if diluted with water |
| Agar-agar | Hydrogel | Yes |
| Alginate | Hydrogel | Yes |
| Xanthan gum | Hydrogel | Yes |
| Gum arabic | Hydrogel | Yes |
| Chitosan | Hydrogel | No |
| Sericin | Hydrogel | Yes |
| Spot-E | Non-aqueous polymeric | (Yes) Limited |
| Dioctyl terephthalate | Non-aqueous polymeric | Yes |
| Trimethylolpropane triacrylate | Non-aqueous polymeric | Yes, if diluted with hexane |
| Benzyltrimeth OH in water | Ionic liquid | Yes |
| Benzyltrimeth OH in methanol | Ionic liquid | (Yes) Limited |
| NaCl in water | Ionic liquid | Yes |
| 4′-Pentyl-4-biphenylcarbonitrile | Liquid crystal | (Yes) Limited |

Droplets of aqueous solutions of PVA, and the non-aqueous Spot-E ink revealed a reduced or very random and uncontrollable motion: typically, they are stuck at the surfaces and left residuals near the contact line. PVA is a highly polar amphiphilic molecule which could cause such observed behavior, even though being in aqueous solution. In contrast, droplets of aqueous solutions of PEO or PAM, could be moved very precisely. PEO is an almost non-polar molecule and droplets of its solutions could be moved at several concentrations. To explore the influence of polarity of molecules on droplet behavior, PAM was also employed. PAM molecules are also polar (as PVA molecules are), but droplets of PAM solutions could still be moved by the electric field very precisely, in contrast to droplets of PVA solutions. It can be concluded that polarity of PVA molecules is not the reason that PVA solution droplets cannot be controlled, albeit the exact reason is currently unknown.

As summarized in Table 4, most of the hydrogel droplets can be manipulated by the electric field. However, since the prepared hydrogel inks had high initial viscosities, their dilution (thinning) was required for droplet movement. After thinning, such hydrogels as alginate, agar-agar, xanthan gum and gum arabic formed droplets that could easily be moved on the substrates. In contrast, chitosan was the only hydrogel solution, which droplets revealed no movement in the present experiments. One explanation could be that chitosan solution contains formic acid, which was necessary to fully dissolve chitosan. Since this was the only hydrogel dissolved in water/formic acid mixture, it is hypothesized that formic acid is responsible for the different behavior observed with droplets of the chitosan solution.

The commercially available monomers, like Dioctyl terephthalate and Trimethylolpropane triacrylate, formed droplets that could be moved applying the electric field. However, unlike the Dioctyl terephthalate which could be moved at the original concentration, Trimethylolpropane triacrylate had to be diluted with equal parts of hexane to reduce its viscosity.

In DW 3D printing processes, droplets of sizes ˜200 μm are of special interest. The movement of such droplets requires electrode arrays much smaller than the one shown in FIG. 33. The smallest electrode size used in the present study was 127 μm×127 μm (which is smaller than the one in FIGS. 32A and 32B by about 24 times). In the case of small electrodes and droplets on the order of 200 μm, the motion of water, and any other ink marked as moveable in Table 4, is possible in two directions. However, droplets of Spot-E ink in the size range 200 μm-3 mm did not move as easy as those of water. It was assumed that motion of Spot-E is inhibited by the curing of the ink due to ambient light. Therefore, motion of the droplets consisting of Spot-E is investigated in darkness. The experiments show that the motion of the ink droplets is increased but still incomparable to the motion of water droplets. In addition to the curing of the ink, the surface properties have a large influence on the motion of the droplet. The more a surface repels a liquid, the easier the liquid moves on the surface in the electric field. The mobility of Spot-E droplets on the stretched parafilm surface is seemingly also decreased due to surface wetting properties. Changing the substrate to FEP, slightly increased the mobility of Spot-E droplets, though still nowhere close to that of water droplets.

Splitting of droplets of moveable inks is observed at high electric field strengths, depending on the surface properties and droplet location. On parafilm, droplet splitting happened at the voltage of ˜5 kV for droplets with diameters of ˜2 mm and the inter-electrode distance of 5 mm. The droplet size significantly influences the occurrence of droplet splitting. The larger the droplet volume, the lower is the voltage resulting in droplet splitting. Nevertheless, the volume is limited by the distance between the electrodes, because if the droplet touches both electrodes at the same time a short circuit occurs. The propensity to droplet splitting is diminished at an increased voltage. In the case of droplet splitting, two droplets appear as a result. Both resulting droplets move to one of the electrodes and a tiny residual droplet might rest at the initial position. FIGS. 39A-D depict an example of droplet splitting with a tiny residual droplet in the middle.

Turning to FIGS. 39A-D, droplet splitting is illustrated with a tiny residual droplet staying in the middle. Both bigger droplets move to different electrodes. In contrast to deionized water or glycerol, droplets of aqueous polymer solutions have a tear-like shape and do not move strictly toward the grounded electrode. The shape of the droplet is asymmetric relative to its longitudinal middle cross-section. In most cases, a tail is formed behind the droplet (FIGS. 40A-C), which resembles tails formed by bubbles rising in aqueous polymer solutions. This phenomenon is presumably caused by high elastic stresses (associated with the elongational viscosity) arising at the rear side of the droplet due to its propensity to pin at the surface. In contrast to the tested Newtonian liquid droplets, the motion of droplets of the aqueous polymer solutions between the electrodes is not straight anymore, but rather meandering.

With reference to FIGS. 40A-C, PEO droplets are depicted: (a)The original shape of the droplet (the aqueous 10 wt % PEO solution; PEO Mᵥ=200,000 Da). (b) Deformed droplet, as well as (c) the final position of the droplet. During droplet motion it acquires a teardrop shape and forms a tail shaped like a cone.

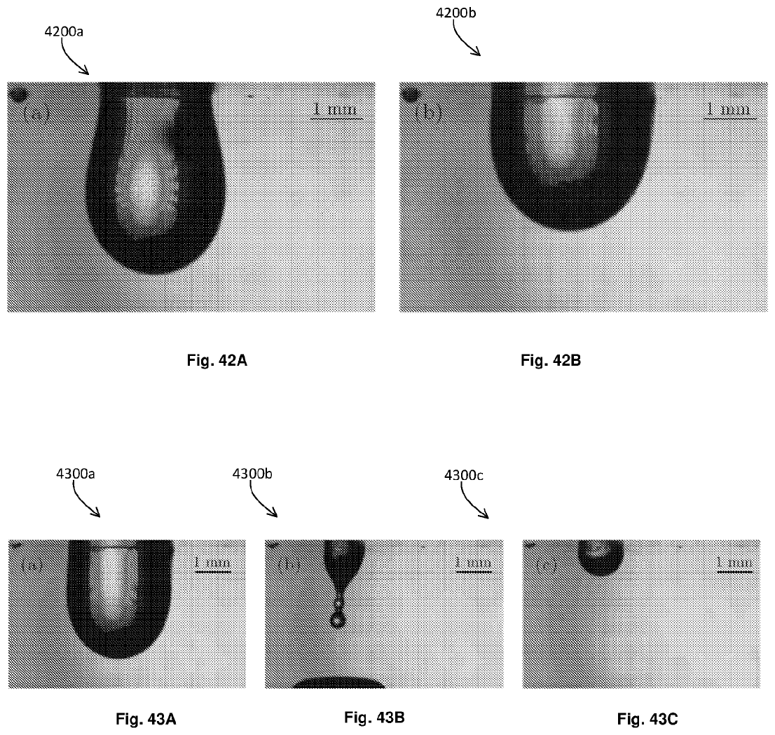

Turning to FIGS. 41A-D, stick and release of a water droplet is illustrated on a vertical wall. Panel (a) shows the droplet stick to the wall, (b) the moment of release, and (c) and (d) the sliding motion of the droplet on the wall. Due to the fact that droplets are typically attracted to the high-voltage electrode, the setup can also be used to hold a droplet in place, even on inclined surfaces. The electric field holds a droplet in place on inclined surfaces up to and beyond the angle of 90° (a vertical wall), as shown in FIGS. 41A-D. Switching the electric field off results in droplet release and a sliding motion on the surface. In the case of pendent droplets, the release moment is actively controlled by turning the electric field off. When being on, the electric field influences surface wetting and hold the droplet on the inverted substrates. Switching off the electric field changes the wetting angle on the surface, reducing the surface energy and allowing detachment from the inverted surface, provided the droplet is large enough for gravity to be the dominant force. Increasing the electric field strength subsequently increases the surface wettability. This pulls the droplet against gravity to the inverted surface, as shown in FIGS. 42A and 42B. As a result, pendent droplets that would normally detach from an inverted surface can be sustained by an electric field giving a user-defined control over detachment. Such suspended droplets can easily be detached from the surface simply by switching the electric field off. However, it should be noted that sometimes a small residual droplet may remain attached to the surface because, with smaller droplets, surface tension remains the dominant force. A demonstration of this phenomenon is depicted in FIGS. 43A-C. In addition to holding a suspended droplet with an electric field, such droplets could also be moved with the electric field. The motion of suspended droplets occurred in a very similar manner to that on a non-flipped substrate when the droplets were smaller than 1 mm.

With reference FIGS. 42A and 42B, a pendent droplet is illustrated, which is not large enough to detach from the surface. (a) Droplet shape and contact angle without electric field, (b) enhanced surface wetting and attraction of the droplet to the surface due to the electric field.

Turning to FIGS. 43A-C, a pendant droplet sustained by the electric field (a). After switching the electric field off, the droplet detaches from the surface (b), and a residual droplet sticks to the surface (c). For smaller droplet sizes (about 1 mm, or smaller), a vertically oriented setup can be used to move droplets against gravity force. Large droplets are too heavy and pulled down, whereas for the smaller droplets the pulling electric force is stronger than gravity. Hence, small droplets can be moved against gravity on a vertical wall.

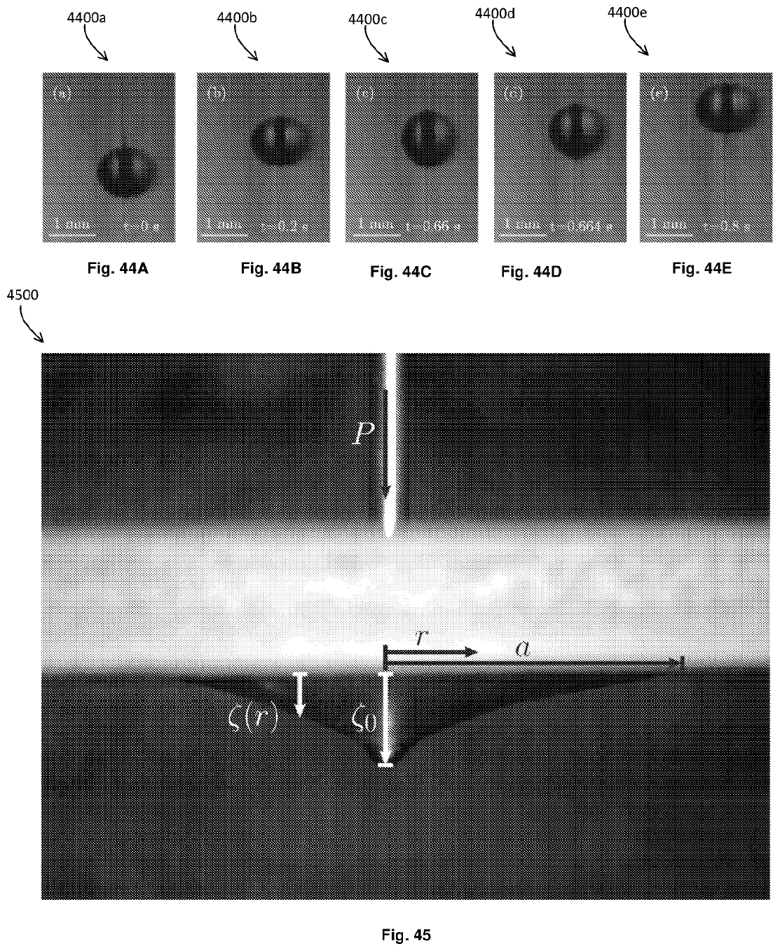

FIGS. 44A-E depict upward motion of a water droplet with a volume of about 0.3 μl on parafilm and silicone oil. For the vertical motion of droplets, switching of the electrodes requires caution. During the switching of the electrodes, high-voltage is applied to two electrodes to prevent a droplet from sliding down the surface due to gravity. Accordingly, the droplet is pinned to the electrode array and pulled upwards as soon as the lower electrode is switched off. FIGS. 44A-E, along with video 10 from the supporting material, shows the upward motion of a droplet with a size of about 1 mm. As shown in the figure, the droplet moves upward in panels (a) to (b). Panels (c) to (e) in FIGS. 44A-E show an additional upward motion of the droplet in more detail. As soon as the electric field switches from one electrode to another, the droplet is stretched as shown in panel (c). Then the droplet starts to move upward, as in panel (d) and reaches the final position, as shown in panel (e). Panels (a), (b) and (e) in FIGS. 44A-C correspond to the end of an electrode. There, the droplet is held in place by the electric field and its shape is almost hemispherical.

The present experiments revealed that the electric field in a dielectric DW substrate can cause ink droplet motion on it depending on the droplet liquid as well as the substrate surface properties. It was shown that droplets of many aqueous polymer inks and CNT suspension inks can be moved on horizontal substrate surfaces. For example, several polymer inks, like PEO and PAM, revealed droplet motion comparable to that of water. However, PVA ink droplets could not be moved by the electric field: the droplets were stuck to the surface and left a residual near the contact line. On the other hand, PVA droplets without the electric field were not stuck and can freely slide on the surface. PVA is a highly polar molecule, as well as PAM. Therefore, the difference in their behavior cannot be attributed to polarity, and the inability of PVA droplets to move is an open question. With the exception of chitosan, all the hydrogel droplets could be moved by the electric field. This includes a commercial hydrogel, agar-agar, alginate, xanthan gum, and gum arabic. The inability of chitosan droplets to move could probably be attributed to formic acid present in addition to water to dissolve chitosan. Furthermore, droplets of several commercially available monomers, which are widely used as feedstock in DW 3D printing, can be manipulated by the electric field. In contrast, droplets of commercial products such as Spot-E are less affected by the electric field due to the curing action of light and excessive wettability of the substrate surfaces studied.

Overall, droplets with sizes between ˜200 μm and 3 mm formed from many Newtonian liquids with a wide range of viscosities, non-Newtonian polymeric solutions, suspensions, as well as hydrogels, which are commonly used as DW ink, can be manipulated and moved by the electric field in the dielectric substrate. This can be done with high accuracy and repeatability. The experimental findings indicate that the electrowetting is a feasible and effective method for controlling ink droplet-substrate interaction dynamically and locally in DW 3D printing process. Future work will focus on: (i) investigation of the electrowetting effects on the DW printed trace quality, and (ii) development of the novel electrowetting-assisted DW 3D printing process.

Direct Ink Writing (DIW) is a class of Additive Manufacturing (AM) techniques which deposit functional and/or structural liquid materials onto a substrate in digitally defined locations. Based on the dispensing form, DIW could be classified as droplet-based (I, piezoelectric ink jetting) or filament-based. DIW differs from conventional AM in terms of the following characteristics: (i) the range of materials deposited can include metals, ceramics and polymers, electronically and optically functional materials, as well as biological materials including living cells; (ii) the track width ranges from sub-microns to millimeters; and (iii) the substrate is an integral part of the final product. A wide variety of applications from flexible electronic fabrication to functional tissue printing has been demonstrated during the past twenty years.

However, despite all this progress, grand challenges in ink-substrate interaction still exist and thus cause various manufacturing defects. For example, many DIW manufacturing defects, including coffee-ring effect, bulging, liquid puddles, liquid splashing, scalloped or discontinuous line, are caused by the undesired wetting and spreading of liquid on the substrate. Furthermore, for full functionality, multiple inks with varied chemical compositions and properties need to be printed on different substrates, which sometimes are superhydrophobic. In such multi-material direct ink writing processes, inks should be compatible with the substrate and form a proper bond with previously deposited materials or the substrate. Insufficient cohesion between layers of ink or adhesion between the ink and substrate will cause large interface resistance or even material separation failures. All those challenges majorly stem from the ink-substrate interaction, especially the wettability of the substrate by the ink.

All efforts that have been made to adjust the ink-substrate interaction are focused on substrate surface modification, including changing substrate chemical composition by coating a new layer, or changing the surface topology. Yet the chemical modification sometimes is not desired as it affects the functionality and properties of the final product. The surface topology modification methods, including plasma treatment and surface machining, are time-consuming, costly, and the modified surface may easily get damaged during the DIW process. Lastly and most importantly, all those surface modification methods cannot dynamically and locally adjust the wettability, are irreversible, and cannot control the wettability of both the substrate and the deposited layers in a layer-by-layer direct writing process. Lack of those capabilities significantly limit the choice of inks and the direct writing performance.

In this work, we investigate electrowetting for dynamic and local control of the ink-substrate wetting properties and hence the adhesion strengths. Moreover, we provide a direct method of measurement of the adhesion energy. In the past, several attempts to use the electric field to influence and optimize the printing process were reported. In most cases the electric field is applied between the needle and the specimen similarly to electro-spinning. Accordingly, control of drop behavior using the electric field is very limited. In this work, we introduce a novel electrowetting setup, in which the electric field is applied on the printing surface and can be programmed in a pixel-by-pixel fashion using coded electrodes.

Several inks, including photosensitive inks as well as silicone-based inks which are beneficial for production of flexible electronics, have been characterized in this work. Deposition of these inks on various substrates, including glasses, wood, Kapton tape, superhydrophobic coating surface, and ceramic surface, has been investigated. Overall, in Direct Ink Writing, the range of inks deposited can include metals, ceramics and polymers, functional composites as well as biological materials. In addition, the substrate which could be flat, curvilinear, round, flexible, irregular or inflatable, is usually an integral part of the final product. Due to the large material difference of the ink and substrate, as well as the varied topology of the substrate, the ink-substrate adhesion can be very weak, leading to manufacturing challenges or even defects, such as separation of printed layer from the substrate or undesired moving of ink on the substrate before the full solidification, and so on. Experiments were performed to analyze the effect of the electric field on the deposition of these inks. Blister tests were conducted to characterize the influence of electrowetting on the interfacial adhesion of printed samples.

To measure the adhesion energy between the dried printed ink and the supporting material, blister tests are employed. Such tests have already been used in the past to measure the adhesion and cohesion energy between polymers, nanofiber mats and substrates and other thin films. The blister test characterizes adhesion of two materials, which is determined by the shape of the blister and the force causing it. Delamination of the dried printed ink from the substrate caused by the pushing shaft, results in formation of a blister, i.e. a new free surface is exposed, which requires work conducted by the shaft. The exact blister shape in the case of soft stretchable blister materials (in distinction from the stiff blister materials) was found theoretically as a solution of the membrane equation. In particular, the axisymmetric blister geometry depicted in FIG. 45 is found as:

$$ζ = \frac{2}{3} {( \frac{{Pa}^{2}}{π Eh} )}^{1 / 3} [ 1 - {( \frac{r}{a} )}^{2 / 3} ] \qquad ( 86 )$$

where P is the force applied by the shaft which results in blister formation, a is the base radius of the blister, E is Young's modulus of the dried printed layer, h is the thickness of this layer, and r is the radial coordinate centered at the shaft and belonging to the base plane of the blister.

With reference to FIG. 45, a blister configuration may be photographed with parameters of Eq. (86) superimposed. Accordingly, the maximum blister height is:

$${ζ}_{0} = \frac{3}{8} {( \frac{P}{π Eh} )}^{1 / 3} {a}^{2 / 3} \qquad ( 87 )$$

It should be emphasized that the force P, and the blister radius a are directly measured in the blister test. Then, the adhesion energy T is calculated as following:

$$T = \frac{3}{8} {( \frac{1}{{π}^{4} Eh} )}^{1 / 3} {( \frac{P}{a} )}^{4 / 3} , \qquad ( 88 )$$

The adhesion energy is measured in J/m².

Note, that in fracture mechanics the energy G, which is needed to create a new surface, is associated with the rate of release of the elastic energy U per unit area A and an imposed displacement δ:G=(δU/δA)_{δ} For a plane stress or strain and fracture in mode I indicated by the index, the strain energy release rate G is given by:

$${G}_{I} = \frac{{K}_{I}^{2}}{{E}^{′}} = \frac{{K}_{I}^{2} ( 1 - {v}^{2} )}{E} \qquad ( 89 )$$

where K_{I} is the stress intensity factor for mode I, and ν is Poisson's ratio; E′=E/(1−ν²) . The value of G_{I} is associated with the surface energy γ of the two banks of the newly created crack:

G_{I}=2γ (90)

### i.e., G_{I}=T.

Material may be printed on a specimen support, which is placed upside down on the stage of the mechanical testing machine. A blister is formed using an Instron 5942 with 500 N load cell. A shaft with the diameter of 0.8 mm is used to form the blister and delaminate the printed ink from the support medium. The shaft is attached to the load cell, which generates the blister using an advancing rate of 10 mm/min. This rate was used to ensure that the blister is formed practically instantaneously. The shaft enters a through hole in the specimen support and only touches the solidified ink. The blister formation is captured underneath by a digital USB microscope (Dino-light edge) with 20˜220× magnification capable of taking 5 MP pictures at a framerate of 10 fps. At the start of the experiment, the video data as well as the data recorded by the Instron are synchronized. Both, the force and the extension of the shaft are recorded by the load cell of the Instron with an accuracy of ±0.5% of the reading and ±0.02 mm, respectively. The tests were conducted until the sample fails due to bursting of the blister or if the blister has a diameter larger than ˜20 mm, which is larger than the field of view of the digital microscope. Afterwards, the video and the recorded data are analyzed using an in-house Matlab code to determine the diameter of the blister and to correlate the data with the measured load. A video of blister formation is imported into MATLAB and manually synchronized with the data of the Instron machine by using an optical indicator, which facilitates calculation of the adhesion energy. Note that the corresponding image of the blister is shown and its diameter is ascertained by the boundary line. The sensitivity of the analysis has been estimated too. Finally, the adhesion energy is calculated using Eq. (88).

To measure the adhesion of the solidified inks on different substrates, several inks and substrate materials are tested. In general, the ink is printed on a surface of a substrate, which has a size of ˜25 mm×˜75 mm, with a through hole of 1 mm diameter at the center. To test realistic material combinations, the adhesion of a commercially available photosensitive ink, as well as a silicone-based ink were explored. These are already commonly used materials in 3D printing. Substrate materials tested in this study include commercial Kapton tape, sandblasted glass, chemically etched glass, glass coated with a commercially available hydrophobic coating (Never wet), wood, and ceramics.

To prepare blister test specimens using the Kapton tape as a substrate material, a fiberglass board is used as the support with a central hole concentric to the one in the tape. Such support is required to prevent bending of the tape during the blister test. The specimen preparation is done very carefully to ensure the repeatability. The fiberglass boards are cleaned with ethanol and electrodes are eventually adhered at 15 mm-25 mm from each other, depending on the desired electric field strength. Both the fiberglass board and the electrodes are subsequently covered with Kapton tape and a hole with a diameter of 1 mm is drilled in the Kapton tape to ensure the free motion of the shaft.

To prepare specimens with sandblasted glass as the substrate, microscope slides are sandblasted for 3 s and cleaned afterwards with water. A diamond drill bit is used to drill a 1 mm hole through the glass, and the specimen is then cleaned with ethanol. For the chemically etched glass specimen substrate, the procedure of sandblasting is replaced by chemical etching. A commercial etching cream (Armour Etch Cream) is applied on the glass for 1 h. Afterwards, the glass is cleaned with water and the specimen is treated the same way as the sandblasted one. For the coated glass sheet substrate, clean glass without any etching or sandblasting is used. After the through hole is drilled, the surface is coated with the two-component coating (Rust-Oleum Never Wet). The coating itself is not cleaned again because it is very sensitive regarding mechanical abrasion and the surface properties might be influenced by solvents like ethanol, which would result in a low repeatability. It should be noticed that only inks (EcoFlex), which are repelled by the coating are tested with this substrate. Similar to the glass specimens, the diamond drill bit is used to drill a hole in the ceramic specimen, which is then cleaned with ethanol.

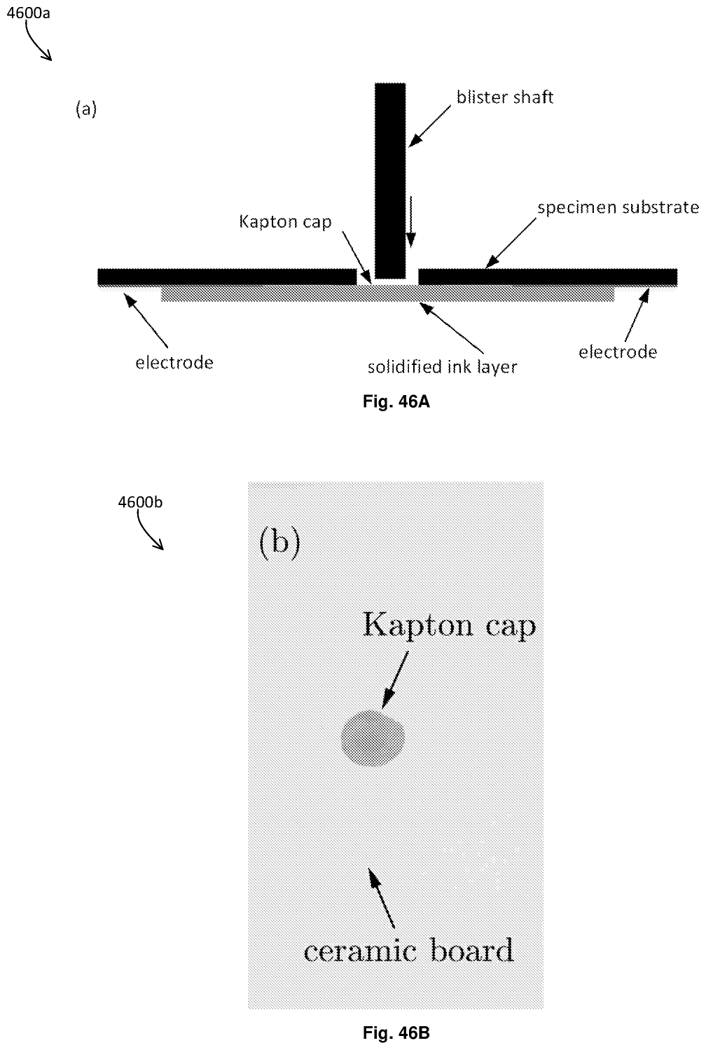

The hole for the shaft must be covered to prevent ink from leaking into it during the direct writing process. Different covering methods have been tested. In the first method, wax was used to fill the hole up and clog it. After printing on the specimen, the wax was then removed by melting at its low melting temperature of ˜37° C. However, several trials revealed that the blister testing of specimens prepared using this wax-based method has a large variability. Especially, for the specimens produced with the electric field, it seems that the photosensitive ink still can enter the hole filled with wax and therefore, affect the measurement results. It was recognized that the electric field forces the ink to move in the electric field and increases the surface wetting. Hence, it is possible that the ink creeps into the hole in addition to wax. To address this leaking problem, we applied an alternative covering method, that is, instead of filling with wax, the hole is covered with a small piece of Kapton tape, which is adhered to the surface to seal the hole. The corresponding schematic is shown in FIGS. 46A and 46B.

With reference to FIG. 46A, a principle of blister may including a specimen substrate, Kapton cap, electrodes, as well as the through hole for the shaft in blister test. FIG. 46B depicts an image of a Kapton cap on ceramic board ready for 3D printing. For preparation of silicone ink, EcoFlex 00-30 was purchased and used as received. This type of silicone solidifies at room temperature in 4 h by mixing part A and part B in a 1:1 ratio. In this study, 5 g of part A, 5 g of part B, and 0.1 g of silicone retarder (Smooth-On Slo-Jo) are mixed at 2000 rpm for 3 min (viscosity of 30 g/cm×s), followed by centrifuging for 1 min (AR-100, Thinky; a planetary centrifugal mixer) before printing. The Young's modulus of Ecoflex 00-30 is 27 kPa.

For preparation of photopolymer ink (viscosity of 4 g/cm×s), a flexible resin (product code Spot-E, Spot-A Materials, Spain; https://spotamaterials.com/wp/wp-content/uploads/2015/07/Spot-E_MSDS_tmp.pdf) was purchased and used as received. Spot-E is non-water based photo-polymerizable resin in the near-UV and visible spectrum, which is highly stretchable after curing. The Young's modulus of solidified Spot-E is given by the manufacturer as E=12 MPa. To verify this value, several tensile tests were performed, which revealed that the Young's modulus value strongly depends on the force and extension. The measurement results at three different extension rates are shown in FIG. 3. At very low strains, the Young's modulus is E=12 MPa and is independent of the extension rate as shown in the inset in FIG. 3 (indicated by the dashed circle). The inks used in this study did not manifest any non-Newtonian effects and can be considered as viscous Newtonian liquids.

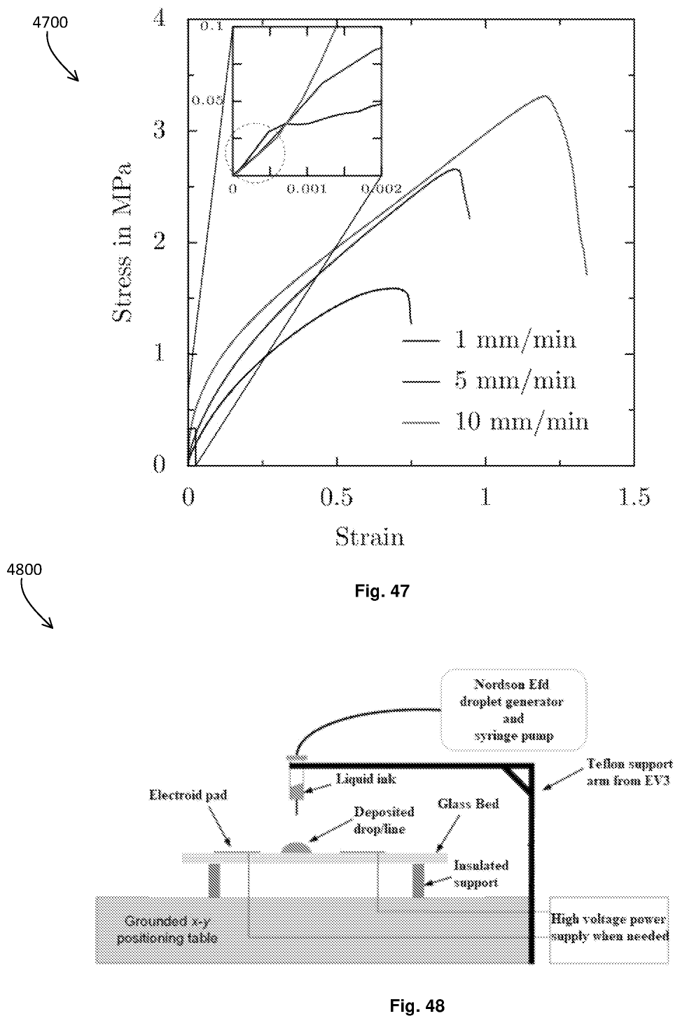

Turning to FIG. 47, stress-strain curves are depicted for Spot-E at three different extension rates. The inset shows the small-strain range (encompassed by dashed circle) where Young's modulus of 12 MPa was measured. The system used for direct ink writing (DIW) experiments was developed by modifying a dispensing robot (E3V, Nordson EFD) and a schematic can be seen in FIG. 48. The experiments were conducted by extruding inks through dispensing tips onto a moving platform in a trace-by-trace and layer-by-layer way. The air pressure and the vacuum level were accurately controlled by dispensers (Ultimus I and Ultimus III, Nordson EFD). Traces were directly written using various stationary blunt stainless-steel syringe tips with inner diameters in the 0.10 mm to 0.41 mm range and a pump system coupled with a motorized X-Y stage. The ink was prepared by loading the solutions in a 10 cm³ syringe barrel. The experimental setup also contains a pressure controller, which can regulate the ink flow rate. The syringe tip was fixed to a Z stage. The standoff distance was adjusted according to the tip gauge in each experiment. The DIW setup is connected to external electronics to fully functionalize a controllable electric field. A homemade high-voltage power source is used to generate the electric field. A multimeter is utilized to monitor the real-time potential across the two copper electrodes placed 25 mm apart from each other. The electric field strength is between 200 V/mm and 400 V/mm.

With reference to FIG. 48, a sketch of a material deposition device 4800 may include a modified Nordson printer with an electrode location shown. To initiate printing, the stage was reset to the origin point. Upon reaching the starting position of a trace, the pre-programmed ink flow at the rate regulated by the applied pressure and began immediately after the start of the platform motion. The printing pattern for fabricating the blister test specimens was a 20 mm×20 mm square pattern. To print this square pattern, a back-and-forth path with a trace gap ranging from 0.5 to 1.0 mm was programmed. Printing settings for fabricating blister test specimens using Ecoflex were as follows. A dispensing tip of 0.96 mm inner diameter (18 gauge) is placed above the substrate at an approximately 0.50 mm standoff distance (because Ecoflex possesses a significant viscosity). The air pressure is set at 3 psi, and the substrate speed is set at 10 mm/s. A 1.0 mm printing trace gap is used. Printing settings for fabricating blister test specimens using Spot-E were as follows. A dispensing tip of 0.43 mm inner diameter (23 gauge) is placed above the substrate at an approximately 0.20 mm standoff distance. The air pressure is set at 3 psi, and the substrate speed is set at 5 mm/s. A 0.5 mm printing trace gap is used.

It is of interest to study the influence of the electric field on the adhesion energy of material deposited under different manufacturing conditions. In this study, tests were performed with an electric field applied at different phases during the manufacturing process: (i) immediately after the ink has been printed onto a substrate; (ii) during printing and during the subsequent curing process. The curing of Spot-E ink can be subdivided into two stages: the pre-curing stage, which is ˜2 min directly during printing (only applicable if UV-light is used), and the post-curing of all specimens together, which lasts ˜45 min to ensure complete solidification of the ink Spot-E. Especially for Spot E, a third manufacturing process (iii) is defined by applying the electric field during printing and using UV light to cure the ink while printing. For the Ecoflex samples, they are dried at ambient temperature or in the oven at a temperature of 65° C. It should be emphasized that in some cases pre-curing during printing was not used, as specified in the following sections. The blister test is performed for all specimens in the same way to ensure comparison between the individual samples. Because a circled piece of Kapton tape was used to cover the though hole in the substrate by adhering to the printing surface, it influences the force-extension curve as well as the blister formation. FIG. 5 shows a typical force-extension dependence of the tested specimens.

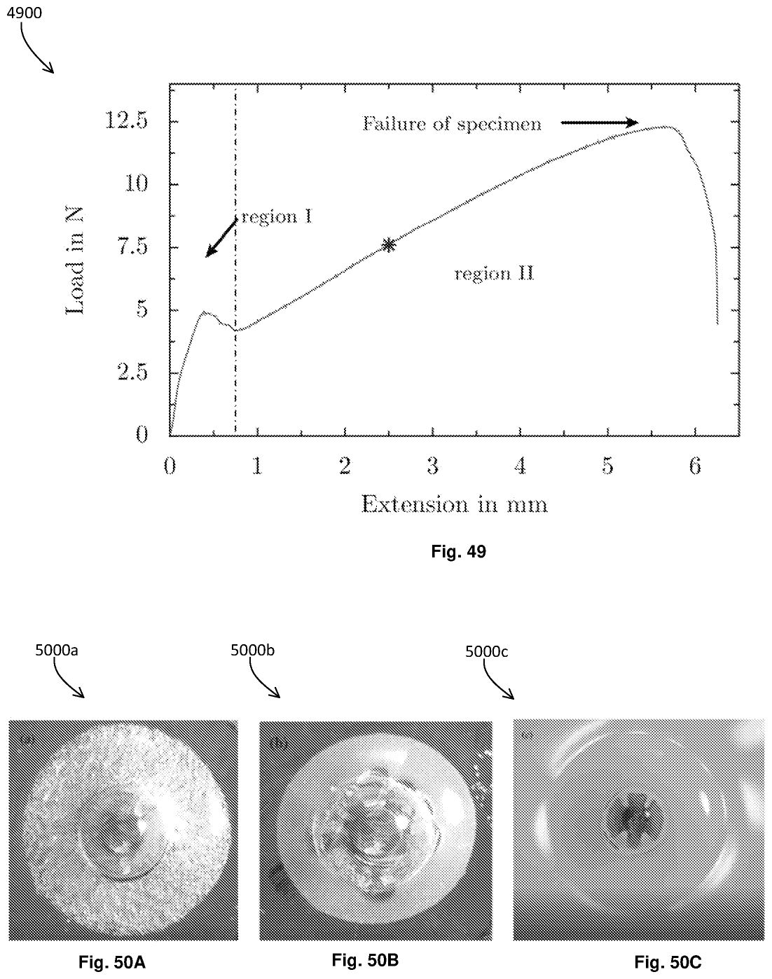

Turning to FIG. 49, a typical load-extension curve is depicted which is measured in the blister test of Spot E. Region I corresponds to the delamination of the Kapton tape, and region II—to the blister formation. The extension of 2.5 mm marked by an asterisk is used in data processing. At the beginning of the experiment, the shaft has to form a blister and to delaminate the Kapton tape. The force increases steeply because the Kapton tape strongly adheres to the surface. This corresponds to region I in FIG. 49, where the diameter of the blister is practically equal to the size of the cap. As soon as the Kapton cap has been delaminated from the surface, the force diminishes, whereas the blister precursor increases in diameter (region II in FIG. 49). The force-extension curve is almost linear in region II. The data analysis is performed using this linear part of the curve, because the same value of the adhesion energy is found using any point on the linear slope. Accordingly, the extension of 2.5 mm was chosen as a characteristic point for the analysis of the blister diameter where the force responsible for blister formation is measured with an extension rate of 10 mm/min. As soon as a blister rips or its size reaches the size of the printed layer, the measured force abruptly diminished and the experiment was stopped.

With reference to FIGS. 50A-C, blister formation of Spot E on (a) sandblasted glass, (b) chemically etched glass, and (c) ceramic. In all cases the shaft extension is 2.5 mm. The blister borders are highlighted by red circles. It should be emphasized that blister formation is different for the several tested inks due to the different ink properties. After the initial blister formation, the blister diameter increases continuously in case of Spot E; in contrast, the Ecoflex ink is much more flexible, so that the diameter of the blister does not increase that much after the initial formation. As a result, the blister has a more elongated shape and the measured forces are much smaller in case of Ecoflex compared to Spot-E. Overall, at least six specimens of every material were investigated to measure their adhesion energy on different substrates. FIGS. 50A-C show three snapshots which illustrate blister border detection by Matlab in specimens made of sandblasted glass and etched glass substrates, as well as ceramic substrate. The blister radius a at the moment of its formation (the extension of 2.5 mm) is determined from such images. The load P at the moment of blister formation is measured using the load-extension curve similar to the one in FIG. 6. Young's modulus E of the solidified coating is found in tensile tests conducted using the Instron 5942 independently.

Adhesion energy in the cases where electric field was applied immediately after the ink has been printed onto a substrate. Here, samples are printed on specimens without the influence of electric field and no additional irradiation is added to the surrounding light. After the printing process is finished, the electric field is applied during the post-curing stage (during drying outside of the printer). Table 5 (accompanied by the corresponding bar graph) lists the measured adhesion energies of Spot E on different materials.

TABLE 5
The measured adhesion energy of Spot E on Kapton, glass and ceramic
substrates with and without electric field; (EF) denotes the cases where
the electric field has been applied. The applied voltage was 7.5 kV.

| | Number of | Mean adhesion | Standard |
|---|---|---|---|
| Substrate | specimens | energy, (J/m²) | deviation, (J/m²) |
| Kapton | 25 | 89.39 | 19.21 (21.49%) |
| Kapton (EF) | 20 | 39.41 | 14.48 (36.74%) |
| Ceramic | 8 | 326.15 | 33.49 (10.27%) |
| Ceramic (EF) | 7 | 327.13 | 76.07 (23.25%) |
| Glass - sandblasted | 6 | 310.69 | 46.93 (15.11%) |
| Glass - sandblasted (EF) | 5 | 297.80 | 42.69 (14.34%) |
| Glass - etched | 6 | 265.90 | 60.46 (22.74%) |
| Glass - etched (EF) | 4 | 241.20 | 37.93 (15.73%) |

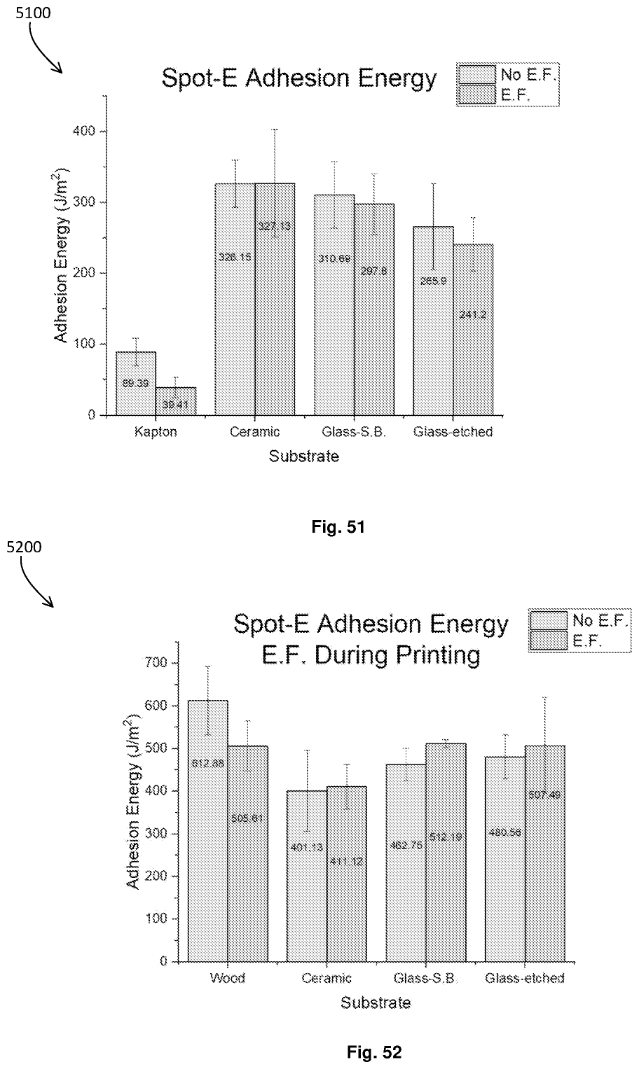

Turning to FIG. 51, a graph 500 depicts spot-E adhesion energy of a printed material relative to various substrates. The data reveal that in the majority of these cases the adhesion energy is not changed due to the application of the electric field, except the case of Kapton tape, where the adhesion energy has been lowered due to the application of the electric field. In all the other cases the mean values of the adhesion energy are close with and without the electric field, the standard deviation is quite large due to the large variation of the individual experiments to draw a clear distinction. The curing rate of Spot-E used in these experiments is ˜0.1 mm in 15 s or less, i.e., the region near the three-phase contact line is cured relatively fast and the contact line surroundings are essentially pinned to the substrate surface.

Adhesion energy in the cases where electric field was applied during printing and during the subsequent curing process. Here the electric field is also applied during printing as well as the post-curing. In this scenario, the ink is immediately influenced by the electric field after being issuing from the needle. In particular, it acts on droplets during their spreading over the substrate surface and enhances spreading. The electric field continues to be applied during the subsequent curing process (the post-curing) because turning it off would abruptly remove the stretching electric force, and thus, cause deposit shrinkage. Table 6 (accompanied by the corresponding bar graph of FIG. 51) shows the measured adhesion energies of Spot E on different substrates including ceramic, sandblasted and etched glasses (the roughness of both types of glass is much lower than thickness of the deposited layers), as well as wood.

TABLE 6
The measured adhesion energy of Spot E on ceramic, glass and wood
substrates with and without electric field; (EF) denotes the cases where
the electric field has been applied. The applied voltage was 7.5 kV.

| | Number of | Mean adhesion | Standard deviation, |
|---|---|---|---|
| Substrate | specimens | energy, (J/m²) | (J/m²) |
| Ceramic | 6 | 401.13 | 94.93 (23.67%) |
| Ceramic (EF) | 17 | 411.12 | 52.48 (12.77%) |
| Glass - sandblasted | 5 | 462.75 | 38.58 (8.34%) |
| Glass - sandblasted (EF) | 4 | 512.19 | 8.51 (1.66%) |
| Glass - etched | 4 | 480.56 | 51.49 (10.71%) |
| Glass - etched (EF) | 5 | 507.49 | 112.49 (22.17%) |
| Wood | 5 | 612.88 | 80.25 (13.09%) |
| Wood (EF) | 5 | 505.61 | 59.37 (11.74%) |

With reference to FIG. 52, an example graph 5200 depicts spot-E adhesion energy of a printed material relative to various substrates with E.F. during printing. The results listed in Table 6 show that the electric field has no major influence on the adhesion energy when applied to Spot-E during printing. For glass and ceramic substrates, the mean values of the adhesion energy are slightly higher with the electric field applied. Still, considering the standard deviation, which is quite large, the increase in the adhesion energy cannot be claimed. The large standard deviation is caused by the varying substrate properties. Even though the specimens are prepared carefully, the surfaces might still have some invisible defects or properties gradients, especially in case of sandblasted or etched surfaces. These defects can have a great influence on the adhesion energy and facilitate large standard deviation.

In addition to Spot-E, another ink was used in these experiments. Namely, the silicone-based ink called Ecoflex was printed with the electric field applied and then dried in ambient air or in an oven. If the specimens are dried in ambient air, the electric field is still applied. However, during specimen drying in an oven, the electric field was switched off right before that. Table 7 (accompanied by the corresponding bar graph) lists the measured adhesion energy of Ecoflex 00-30 on wood (crafting plywood purchased from Menards), plane glass and glass coated with Never Wet coating. With the latter coating, two different methods were used to dry the ink: a slow drying under ambient temperature and an accelerated drying in an oven at 65° C.

TABLE 7
The measured adhesion energy of Ecoflex 00-30 on wood, glass and
Never Wet substrates with and without electric field; (EF) denotes the
cases where the electric field has been applied. The applied voltage was
7.5 kV for glass and wood. For glass coated with Never Wet the applied
voltage was 10 kV.

| | Number of | Mean adhesion | Standard |
|---|---|---|---|
| Substrate | specimens | energy, (J/m²) | deviation, (J/m²) |
| Never Wet -dried in | 5 | 41.36 | 9.86 (23.84%) |
| ambient air | | | |
| Never Wet (EF) -dried in | 5 | 38.61 | 5.93 (15.36%) |
| ambient air | | | |
| Never Wet - dried in | 4 | 20.11 | 2.18 (10.84%) |
| an oven | | | |
| Never Wet (EF) - dried | 4 | 36.11 | 9.36 (25.92%) |
| in an oven | | | |
| Glass | 6 | 37.61 | 8.40 (22.33%) |
| Glass (EF) | 6 | 36.04 | 7.84 (21.75%) |
| Wood | 4 | 49.7 | 7.11 (14.31%) |
| Wood (EF) | 3 | 49.65 | 1.90 (3.83%) |

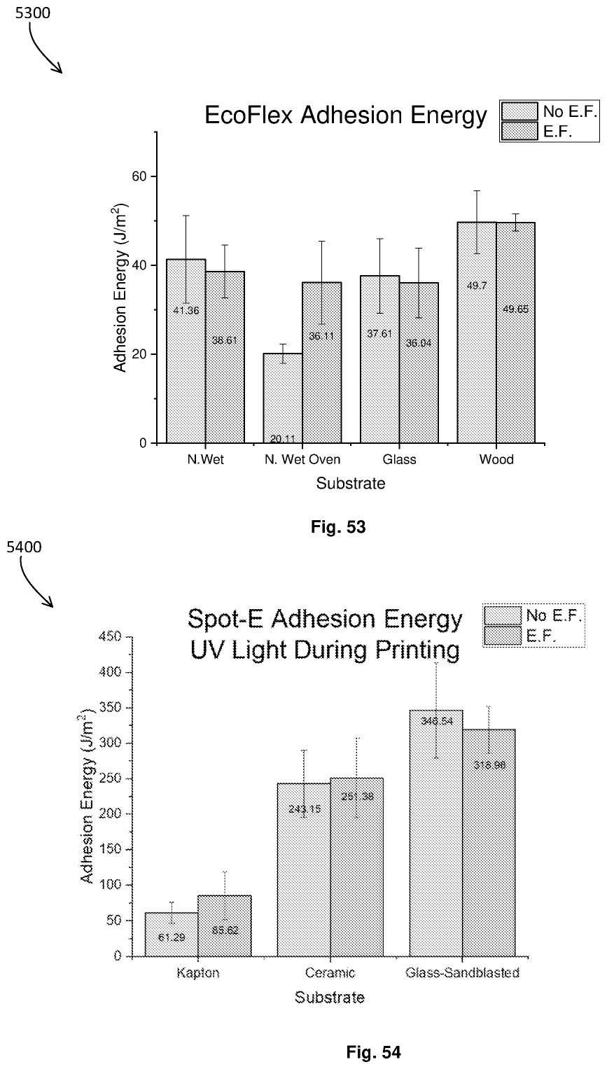

Turning to FIG. 53, an example graph 5300 depicts EcoFlex adhesion energy of a printed material relative to various substrates. The results in Table 7 reveal that there is no increase in the adhesion energy in case of wood or plane glass substrates; the measured adhesion energies with and without the electric field are very close. In contrast, the mean adhesion energy of Ecoflex on glass, which is coated with Never Wet is slightly higher in case of fast drying in an oven at 65° C. In the latter case the standard deviation is relatively small and the increase in the adhesion is statistically sound. The hydrophobicity of the Newer Wet coatings repels Ecoflex, so the ink adhesion is greatly facilitated by the electrowetting phenomenon this case. Accordingly, the adhesion energy can be increased with an electric field if the specimens are cured very fast in an oven. This might improve the manufacturing process and increase the output due to smaller curing times, with sufficient adhesion of printed ink to the substrate. On the other hand, the adhesion of the slowly-dried samples is unaffected by the electric field. In case of a slow curing in ambient air the ink has more time to adhere to the surface and therefore, no increase due to the electric field is found.

Adhesion energy in the cases where electric field is applied simultaneously with curing by UV light may include application of the electric field simultaneously with printing and curing by the UV light is only possible with the photosensitive inks. The light source is focused on the specimens during printing, so that the ink is cured simultaneously while wetting the surface, and affected by the electric field. Table 8 (accompanied by the corresponding bar graph) lists the results for all specimens formed with and without electric field. In these cases, the specimens were directly printed onto different substrates including Kapton tape, ceramic, as well as sandblasted glass.

TABLE 8
The measured adhesion energy of Spot E on Kapton, glass and ceramic
substrates with and without electric field; (EF) denotes the cases where
the electric field has been applied. The applied voltage was 7.5 kV.

| | Number of | Mean adhesion | Standard deviation, |
|---|---|---|---|
| Substrate | specimens | energy, (J/m²) | (J/m²) |
| Kapton | 9 | 61.29 | 14.82 (24.18%) |
| Kapton (EF) | 10 | 85.62 | 33.89 (39.58%) |
| Ceramic | 9 | 243.15 | 47.11 (19.37%) |
| Ceramic (EF) | 9 | 251.38 | 56.48 (22.47%) |
| Glass - sandblasted | 3 | 346.54 | 67.20 (19.39%) |
| Glass - sandblasted (EF) | 5 | 318.96 | 33.17 (10.40%) |

With reference to FIG. 54, an example graph 5400 depicts spot-E adhesion energy of a printed material relative to various substrates with UV light during printing. The results show that for the tested glass specimens the mean adhesion energy is higher without the electric field compared to the specimens manufactured with the electric field applied. Nevertheless, the decrease is not statistically sound given the standard deviation. In addition, the adhesion energy on the ceramic specimens is slightly higher for the specimen subjected to the electric field compared to those without it. In the latter case, the standard deviation is rather high, 20%. Furthermore, the experiments with Kapton tape also show that the specimens subjected to the electric field reveal a slightly higher adhesion energy than without it, even though in this case the standard deviation is higher.

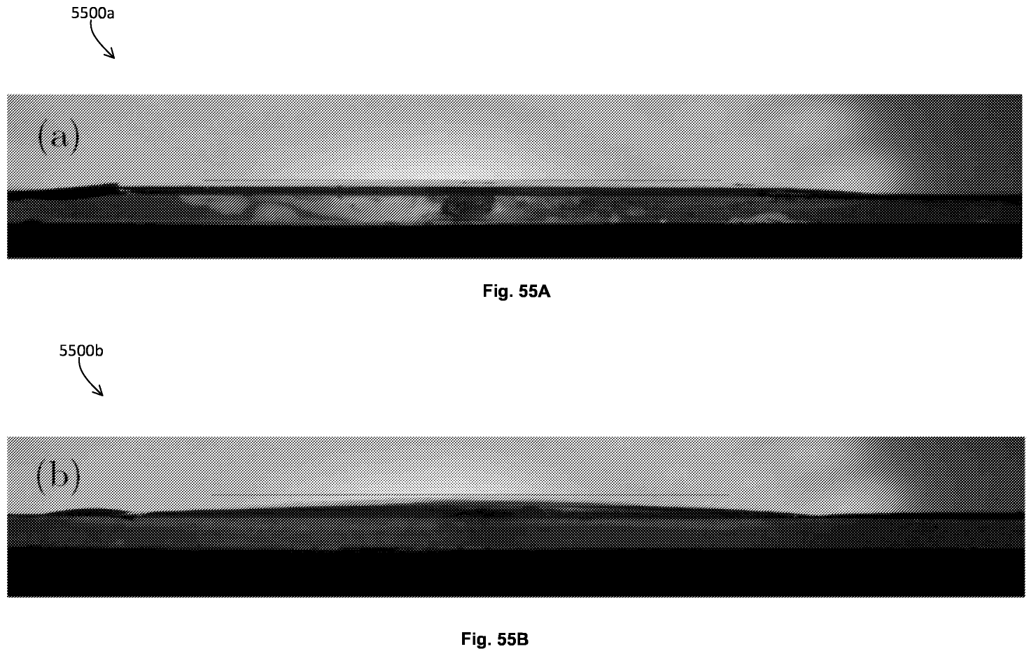

With reference to FIGS. 55A and 55B, a side view of a Spot-E layer printed on glass is depicted without (a) and with the electric field (b). The line horizontal lines are tangents at the top of each layer. The profile is highly uniform in the case of specimens without electric field (panel a), and non-uniform for specimens printed under with the electric field (panel b). It should be emphasized that the layer thickness is an order of magnitude less than that of the substrate, and the latter can be considered absolutely rigid during the blister tests. The measurement of the thickness h used in Eq. (88) for the adhesion energy is done in the middle of the specimen directly above the hole assuming the thickness of the ink layer to be constant. Especially, for the specimens printed under the effect of the electric field this assumption might be not very accurate and cause a rather high standard deviation. FIGS. 55A and 55B show two different specimens and their surface profiles. FIG. 55A shows a specimen formed without the electric field and 55B—the specimen, which was printed being subjected to the electric field. In both images the line indicates a horizontal line tangent to the surface at the highest point. In case of FIG. 55A the surface of the printed ink is relatively flat and has a constant thickness. In contrast, the thickness of the ink layer has a large variation in FIG. 55B. The highest point is in the middle of the specimen and the profile decreases on both sides, resulting in a height difference of ˜0.2 mm. The fundamental theory of the blister test assumes a thin and uniform layer. Therefore, the mean adhesion energy found in the non-uniform cases can be underestimated. An increase of ˜10% in the adhesion energy can be expected in such non-uniform cases.

Another factor is the uniformity of the surface. In case of ink curing during the printing by the UV light, the liquid solidification is very fast and can affect the uniformity of the surface. The printing pattern is given by line pattern used to generate a rectangular ink layer. If a strong light source is used during the printing process, the ink solidifies so fast that the line pattern is still visible after printing, i.e., the lines stay apart. In case of printing without the UV light, the ink surface has time to adjust itself due to the surface tension tending to minimize the surface area via merging the parallel printed lines and making them planar. Thus, the printing results in an almost uniform surface. Hence, the rate of curing has to be adjusted to ensure a uniform surface. Furthermore, the surface roughness is also affected by the rate of curing. A high surface roughness of the printed layer might influence the adhesion energy, as well as the uniformity of the layer properties.

Different substrate material and ink combinations may reveal an effect of the electric field and the associate electrowetting on the adhesion energy. An increase in the adhesion was found for a highly hydrophobic surface (glass covered by Never Wet) in the case of a very fast curing (oven-cured) of the silicone ink. Due to the fast curing and printing, the electric field facilitates a better surface wetting, and thus the resulting adhesion. Therefore, the printing process can be significantly accelerated if the electric field is applied in such cases similarly to the present work. In contrast, slow curing at ambient temperature, as well as for other ink and material combinations, I, of Spot-E with wood, ceramics, Kapton tape, glass or even glass with Never Wet, do not seem being affected by the electric field. Thus, the adhesion energy stays unchanged. Not even these substrates in combination (excluding Never Wet) with EcoFlex do show any increase in the adhesion due the electric field. Furthermore, the increase in the adhesion also depends on the printing process and parameters. The most promising procedure regarding EcoFlex is to use the electric field during the printing process, as well as during the post-curing stage and curing at a temperature higher than 65° C. It should be emphasized that no pre-curing can be applied in this case because the material is dried by heat. Other tested methods including the application of the electric field only during the post-curing stage do not reveal a significant influence on the adhesion and only complicate the printing process. In addition, the printing process of Spot-E can be influenced by the electric field but none of the tested methods including printing with an electric field, applying the electric field during post-curing, and using pre-curing with UV light during the printing process, did reveal any increase in the adhesion between the ink and the tested substrates. Since ink is not water-based, it is not repelled by the coating resulting in no increase in the adhesion.

Overall, the present experiments enhanced direct ink writing-based 3D printing capabilities on hydrophobic surfaces when silicone-based inks are used. These were achieved by application of the electric field and the related electrowetting phenomenon and a fast curing process. Accordingly, the adhesion between the printed dried ink and the substrate was increased, and the production rate can be also increased.

After completing experiments with droplets created on-demand from orifices within inkjet printing parameters, a transverse electric field was retrofitted to a direct writing (DW)-based three-dimensional (3D) printer. The application of electrodes to the print head not only reduced the need for mechanical motion during printing but also revealed novel solutions to problematic printing applications, namely, 3D printing within confinements. These results divulge a plethora of new design opportunities for ink droplet control in 3D printing processes.

Inkjet-based 3D printing is a widely applied additive manufacturing method that made an industrial-scale transformation from two-dimensional graphical to three-dimensional structural print. It is typically divided into two broad categories determined by the mechanism used to form droplets, continuous inkjet (CIJ) and Drop-on-Demand (DOD) 3D printing. Both techniques produce uniform droplets from the print head. Fueled by a global shift toward lean manufacturing, DOD 3D printing is found to be advantageous over CIJ with less waste and no need for complicated ink recycling systems. DOD 3D printers can form and eject droplets on demand by mechanisms including thermal, piezo, pressure and electrohydrodynamic (EHD) methods. Regardless of the droplet formation methods, it was deemed important that the droplets were produced from a fluid channel within the 10 to 150 μm diameter range as in the DOD 3D printing literature and industry. For adaptability of our work in the current DOD 3D printing research and industry, this study herein focuses on investigating droplets with sizes within this range.

Droplet manipulation and resulting metrology is crucial to the advances and applications of DOD-based inkjet 3D printing in many fields, such as bioassays chemical and drug delivery, and electro/mechanical/biological microdevices. In these applications, existing manipulation techniques include forming, transporting, merging, sorting, splitting, and storing droplets. Such droplet manipulations can be powered by acoustic waves, electric, magnetic, thermal and hydrodynamic forces and surface tension. Among these manipulation techniques, the employment of electric force is one of the most promising methods because of its good compatibility coupled with the short response time. In most cases, the hardware required to create the electric field can be easily integrated into existing machines, making these adaptable technologies highly desirable for today's industry.

Using electric force to manipulate the inkjet 3D printing process holds great promise for specialized applications. The reduction of moving parts, limited impact onto flexible or delicate substrates, and even printing in conventionally hard-to-reach locations (e.g., under an overhang, etc.) are just a few of the potential benefits. Doak et al. showed that high-voltage electrodes can be used to deflect a stream of droplets using dielectrophoresis, albeit production and control of an individual droplet was never achieved. Electrostatic jets may be deflected using high-voltage electrodes, and when solidified, they create submicrometer features on a translating substrate. Similar to the present work, electrostatic jet deflection method may increase the printing speed and resolution while reducing wear on mechanical stages. However, individual droplet control may not be achieved, which limits the printing geometry accuracy. In addition, as to the authors' knowledge, none of the existing works investigated the feasibility and effectiveness of the electrostatic deflection in drop-on-demand inkjet 3D printing within confinements (e.g., under an overhang, etc.).

A drop-on-demand (DOD) printing system may integrate an electric field to, for example, manipulate individual droplets through electrostatic charging and deflection, and implementation of an associated droplet manipulation method for 3D printing within confinements which are not accessible by ordinary 3D printing devices. The systems may employ ink-jet printer applications, and may deflect metal droplets of small size on an open substrate. However, drop-on-demand 3D printing within confinements, which is the main aim of the present work, has never been attempted. In addition, deflection of non-metal drops demonstrated in the present work involves charging mechanisms different from the metal ones, which deserves exploration. Keeping all this in mind, the present work determined the effective charging mechanism of ink droplets and established the metrology for the electrostatic deflection-assisted 3D printing process. In the rest of the paper, the experimental setup is discussed in section II. The theoretical analysis is provided in section III. Results and discussions are presented in section IV, and conclusions are drawn in section V.

To explore ink droplets falling through a transverse electric field, copper electrodes were fitted to a DOD pneumatic print head. The experimental setup consists of a movable x-y table as a support for the collection vessel, two parallel copper electrodes, and a high-voltage power supply, as shown in FIG. 1a. A high voltage is applied to different electrodes via a micro-controller and circuitry. To generate droplets of diameter d around 1 mm, a commercial droplet generator (Nordson Ultimus I) was used along with a 30-gauge or 32-gauge needle (159 μm and 109 μm inner diameter, respectively). The droplet generator creates a well-defined pressure pulse for a specific time interval driving the ink through a blunt needle at a pressure ranging from 0.1 to 70 psi.

Two distinct droplet-charging techniques may be connecting by a selectable charging wire between the grounded electrode and the printing needle. The path for ions in the droplets to be charged or discharged was opened and closed via a high-voltage relay. This relay determined whether the droplets received their charge through direct contact with the printing needle, or through ionized air when falling through the inter-electrode gap (cf. FIG. 56A). The distance between the printing needle and the surface h was kept relatively large as compared to the needle diameter, i.e., h>5 cm, so that droplets have enough time to be positioned between the electrodes during free fall when the electric field was applied. Two vertical electrodes were made of 0.8 cm×5 cm×5 cm copper plates adhering to standing dielectric supports made of a 0.7 cm fiberglass board. The distance between the vertical electrodes was fixed at 7.7 cm with the printing needle centered in-between, as illustrated in FIGS. 56A and 56B.

Turning to FIG. 56A, a schematic of a DOD system 5600a is depicted. FIG. 56B depicts electrode design without a grounded needle. FIG. 56C depicts example electrode design with a grounded needle. To test the electrostatic deflection and 3D printing process, undiluted glycerol and Spot-E (Spot-A Materials) were used as the materials in the following experiments. Spot-E is a photo-polymerizable resin in the near UV and visible spectrum for applications needing flexibility in typical additive manufacturing process. It contains 8-25% aliphatic acrylate, 8-25% aliphatic urethane crylate, 10-40% aromatic acrlylate, 40% aliphatic acrlylate 40%. Its density is approximately 1.10-1.12 g/cm³, and its viscosity is 100 to 150 cP at 25° C. according to the data sheet. All the materials were used undiluted as-received. In the previous work of this group, many Direct-Written ink droplets were controlled employing electrowetting. However, this approach did not work with glycerol. Namely, it was impossible to relocated sessile glycerol droplets on horizontal substrates. Motivated by this limitation found in our previous work, Glycerol is tested in this study with the aim of proposing an effective electric-field-assisted approach for manipulating deposition of Glycerol droplets along the horizontal direction. Spot-E has the kinematic viscosity of v=3.64×10⁻⁴ m²/s and was pushed through a 32-gauge needle (108 μm inner diameter) with a syringe pressure of 1.5 psi.

Voltages of 3, 5, 6, 7 and 9 kV applied between the vertical electrodes in the experiments resulted in the electric field strengths of 0.39, 0.65, 0.78, 0.909 and 1.17 kV/cm, respectively (cf. Table 9). The application of 1.17 kV/cm resulted in a droplet deflection at an approximately 45° inclination angle relative to the vertical direction. The electrode voltage was manually controlled with the high-voltage power supply while the polarity was switched by an Arduino micro-controller coupled with a high-voltage relay. These adjustable parameters allow a user-defined control of the droplet motion in the horizontal direction.

TABLE 9
Correlation between voltage and the electric field strength.

| VOLTAGE (KV) | ELECTRIC FIELD STRENGTH |
|---|---|
| 3 | 0.39 |
| 5 | 0.65 |
| 6 | 0.78 |
| 7 | 0.91 |
| 9 | 1.17 |

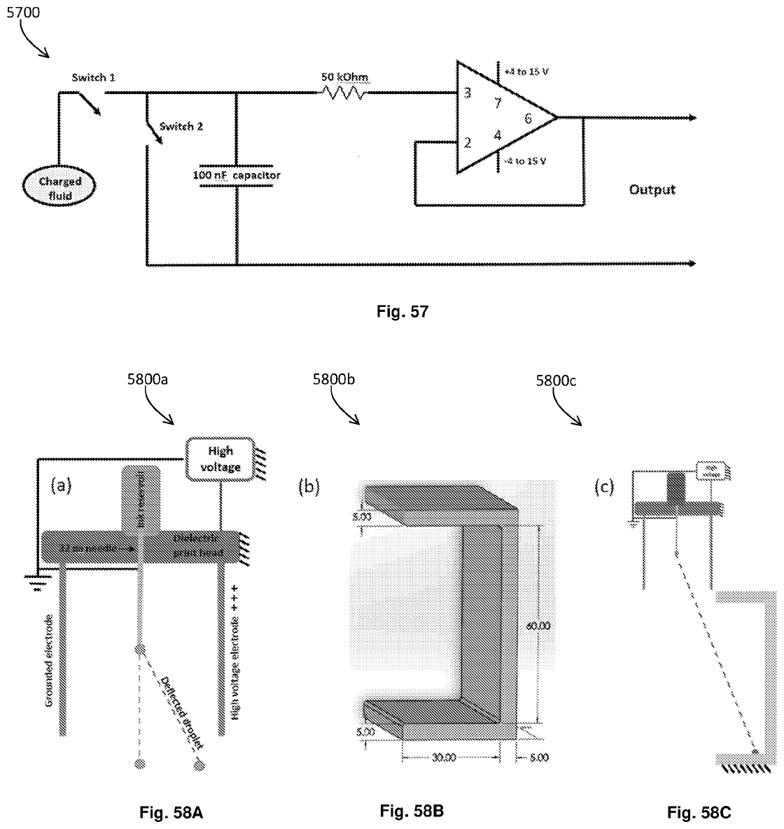

The droplet charge was calculated indirectly, by comparing the recorded droplet motion with the theoretical modeling in section III. This is termed as a primary method of droplet charge measurement. As a secondary method of measuring the droplet charge, a collection vessel was connected to high-impedance buffer and multimeter. The high-impedance buffer is a resistor/capacitor (RC) circuit comprised of 50 kΩ resistor and 100 nF low-leakage capacitor, which were connected to a CA3140 MOSFET operational-amplifier allowing the voltage of the capacitor to be read from the multimeter. By noting the sign of the output voltage, the charge can be identified as either positive or negative. A schematic of this apparatus is shown in FIG. 57.

With reference to FIG. 57, a schematic of the high-impedance buffer circuit for use within a material deposition system is depicted. After initial experiments correlating the droplet charge with its subsequent trajectory when falling through an electric field, the setup was retrofitted to a DIW (Direct Ink Writing) automated dispensing system. Two 0.3 cm×1.5 cm×3 cm copper electrodes were attached to a custom dielectric printhead centering the printer's needle within the electric field and located ˜8 cm above the substrate, as shown in FIG. 58A. To demonstrate the feasibility of this approach for 3D printing in confinements, a simple overhang structure was prepared for the following test. As shown in FIGS. 58A-C, with the developed electrostatic deflection assisted DIW system, droplets were dispensed and selectively deposited on the surface beneath this overhang to build new features. The droplet motion was captured using a high-speed CCD camera (Phantom V210) using back-light shadowgraphy. All experiments were performed under ambient conditions.

Turning to FIG. 58A, a schematic of a print head retrofitted with electrodes is depicted. FIG. 58B depicts a CAD drawing of overhang structure (a model confinement) with all dimensions (mm). FIG. 58C depicts a trajectory of ink droplets as a modified printhead overcomes the problematic printing situation caused by an overhang structure. To achieve a desired printing accuracy using the proposed electrostatic-deflection-assisted 3D printing process, the droplet motion and deposition need to be controlled precisely, which requires a method for modeling and measuring the individual droplet charge in the process. It is known that the charge relaxation times τ_{C} of liquids range from 1 μs to 20 s. Glycerol, in particular, has the charge relaxation time on the order of 3 μs. The characteristic hydrodynamic time τ_{H}, which is the residence time of liquid volume in the needle, is ˜0.43 s in this study. Because τ_{C}<<τ_{H}, glycerol behaves in the present experiments as a perfect conductor and droplets become charged in the needle.

Charged pendant droplets at the needle's exit are subjected to both gravity and Coulomb forces resulting from the electric field imposed by the electrodes. These forces detach the droplet from the needle. Then, free fall determined by gravity and Coulomb forces begins. Droplet motion in the free fall is described by the second law of Newton, which takes the following form:

$$m \frac{{d}^{2} R}{{dt}^{2}} = - mgk + QEi \qquad ( 91 )$$

where t is time, m is the droplet mass, r is its radius-vector, g is the magnitude of gravity acceleration, i and k are unit vectors of the horizontal and vertical directions, respectively, Q is the droplet charge, and E is the electric field strength imposed by the electrodes.

Projections of Eq. (91) on the horizontal and vertical axes yield:

$$m \frac{{d}^{2} R}{{dt}^{2}} = QE , \frac{{d}^{2} z}{{dt}^{2}} = - g \qquad ( 92 )$$

The droplet detachment moment is taken as t=0, and Cartesian coordinates at the needle exit are set as x=0 and z=h. Accordingly, the following initial conditions are imposed on the solutions of Eqs. (92):

$$at t = 0 , x = 0 , z = h , \frac{dx}{dt} = \frac{dz}{dt} = 0 \qquad ( 93 )$$

Solutions of Eqs. (93) subjected to the initial conditions (88) read:

$$x = \frac{QE}{m} \frac{{t}^{2}}{2} , z = - g \frac{{t}^{2}}{2} + h \qquad ( 94 )$$

The substrate on which droplets impact is located at plane z=0. Then, the impact moment is t*=\sqrt{2h/g} and the horizontal coordinate of the impact location is:

$${x}_{*} = \frac{QEh}{mg} \qquad ( 95 )$$

Moreover, Eq. (95) yields the droplet trajectory in flight as a straight line described by:

$$x = \frac{QE}{m} \frac{( h - z )}{g} \qquad ( 96 )$$

In addition, Eq. (96) expresses the droplet charge, still unknown, as:

$$Q = \frac{{mgx}_{*}}{Eh} = \frac{{mgx}_{*} L}{Vh} \qquad ( 97 )$$

where V is the applied voltage, and L is the distance between electrodes.

Droplet mass was measured using its images and the known density under the assumption that the droplet is spherical. The landing position x* was measured using the video images. Accordingly, the second Eq. (97) can be employed to measure the droplet charge Q. The volumetric flow rate \dot{Q} is found from the Poiseuille law is:

$$\dot{Q} = \frac{π {R}^{4}}{8 μ} \frac{Δ p}{Δ ℓ} \qquad ( 98 )$$

where Δp is the magnitude of the applied pressure differential to the syringe, R is the inner radius of the needle, μ is the dynamic viscosity of the ink, and Δl is the length the needle through which the ink must be pushed.

It should be emphasized that in the equations of motion (2) the air drag is neglected. The reason is that for the characteristic conditions in the present case the air drag force F_{D}=C_{D}(1/2)ρₐU²πD²/4, with C_{D} being the drag coefficient, ρₐ being the air density, U being the drop velocity, and D being the drop diameter, is negligibly small compared to the Coulomb force F_{C}=QE and the drop weight F_{W}=mg. Indeed, take for the estimate U=\sqrt{2gh}, C_{D}=0.45, and as in the following experimental data discussed in section IV, m=0.001-0.004 g, h=3 cm, Q=(10⁻¹¹−10⁻¹⁰)C=(0.03−0.3)g^{1/2}cm^{3/2}/s, E=1 kV/cm=10/3 g^{1/2}/(cm^{1/2}s), and ρₐ=1.21×10⁻³ g/cm³. Then, one obtains that F_{C}˜(10⁻¹−1)g×cm/s², F_{W}=(1−4)g×cm/s², whereas F_{D}˜10⁻² g×cm/s². The latter shows that F_{C} and F_{W} are commensurate, and much larger than F_{D}, which justifies that it was neglected in Eq. (87).

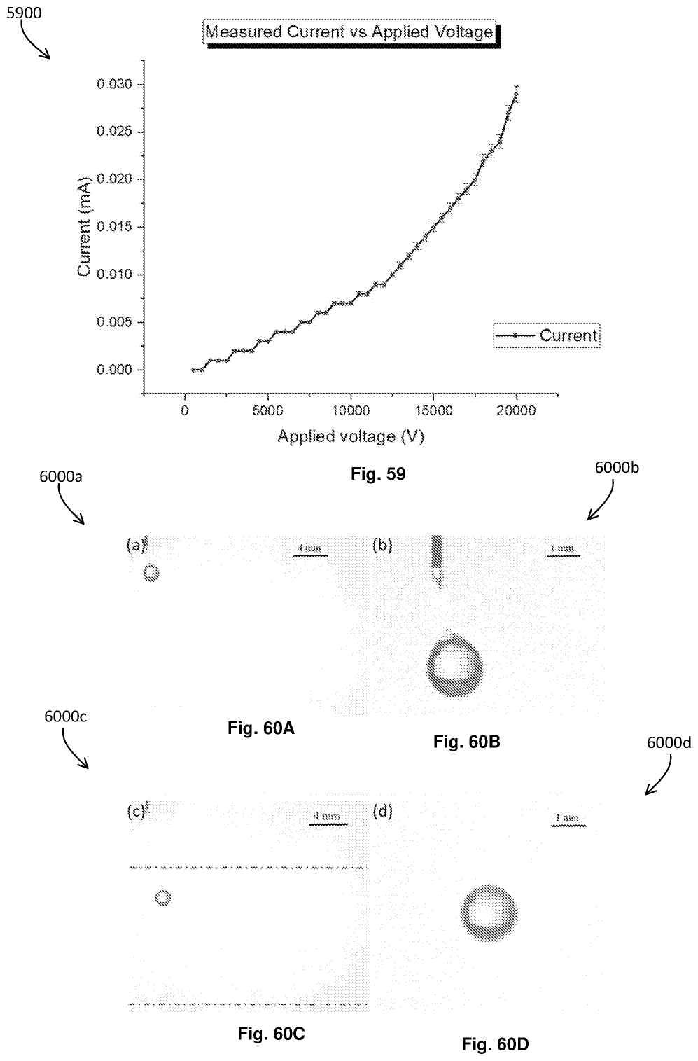

With reference to FIG. 59, a measured current/voltage characteristics of the inter-electrode gap is depcited. The experimental data is shown by symbols spanned by a line. Two approaches of droplet charging are described in detail herein. In the first case, the printing needle was directly connected to the grounded electrode, as shown in FIG. 1c. This configuration provides a direct path for ion exchange, ultimately leading to glycerol polarization (charging). On the other hand, in the second approach, the printing needle was disconnected from the grounded electrode, with the droplet charging solely relying on the charge transferred from the ionized air within the inter-electrode gap during the droplet fall, as shown in FIG. 56B. FIG. 59 reveals the measured electric current-voltage characteristic of the inter-electrode gap determined by air ionization by the transverse electric field. It should be emphasized that in the second approach air ionization can be affected by local humidity and other variable factors, which makes it less reliable from scratch, albeit still interesting to explore. To track the droplet motion, high-speed videos of droplets in flight were recorded. These droplets and the corresponding trajectories were analyzed frame by frame by an in-house Matlab program.

Turning to FIG. 60A, a global view of tear-like droplet just detached from the printing needle is depicted. FIG. 60B depicts a magnified image of tear-like droplet just detached from the printing needle. FIG. 60C depicts a spherical droplet in the range used for further analysis. FIG. 60C depicts a magnified image of spherical droplet in the range used for further analysis. Note that magnified droplets in panels FIG. 60B and FIG. 60C were photographed to visually capture transition from tear-like tail to a perfectly spherical droplet. In this section, the study of droplet geometry evolution was explored to understand the behavior in flight. As recorded by the high-speed videos, immediately after detachment from the needle, a tear-like droplet shape is observed, as demonstrated in FIGS. 60A-D. As time progresses, surface tension rounds the droplet off (FIGS. 60C and 60D). Such images are convenient for further analysis, and they were taken in the height range marked by the two horizontal dashed-dotted lines in FIG. 60C. It is important to note that FIGS. 60B and 60D show larger droplets formed to accentuate the shapes and features of the falling droplets during review and initial experiments. It should also be noted that all other droplets produced and studied are below the 1 mm diameter and larger than 150 μm capillary to meet the inkjet requirements, unless otherwise stated. Still, slight oscillations of the droplets are evident with the oblate and prolate spheroidal shapes observed throughout the entire fall. To understand the influence of the electric field on the droplet size, two methods of droplet charging described in section II using the voltage of 3-6 kV. Both with ionic and direct charging of a droplet by a wire electrode, a size of the falling droplet is inversely proportional to the applied voltage.

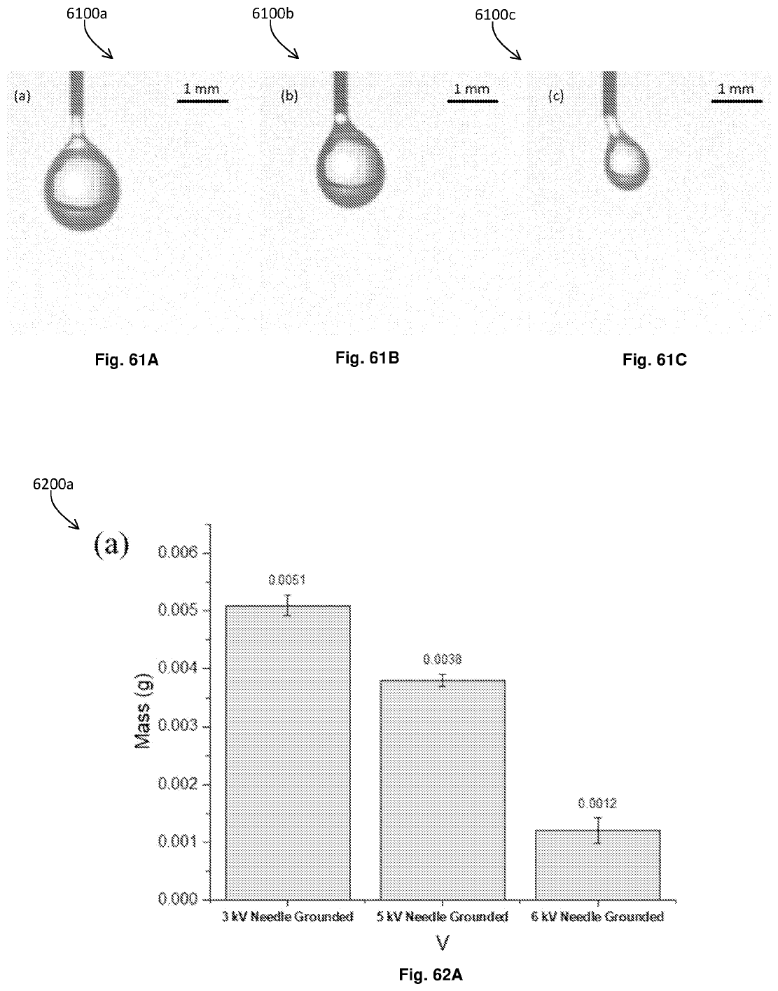

Turning to FIGS. 61A-C, a series of detaching droplet snapshots depict larger droplets for clarity. The snapshots clearly show a dramatic effect on the diameter of droplets of the increasing applied voltage. As the voltage is increased throughout the series of images shown in FIGS. 61A-C, the resulting increasing Coulomb force combines with gravity force already acting on the body of the droplet. If the electric field strength becomes too large however, the pull on the pendant droplet will become large enough and can even stretch the droplet to the electrode in a similar manner to EHD (electrohydrodynamic) printing. Another possible cause of the reduced droplet size might be related to the shear force introduced by the electric field which might stretch the solid/liquid contact area in an undesirable way when compared to pure tension between the needle and the droplet.

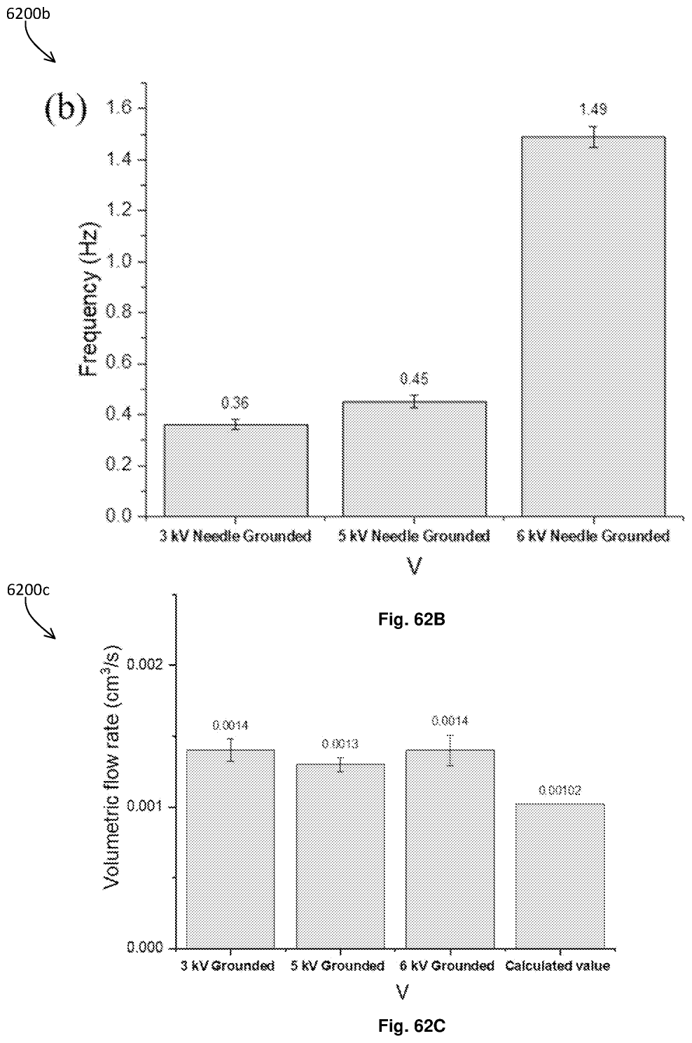

FIG. 61A depicts detaching droplets at the following applied voltages: 3 kV, FIG. 61B depicts 5 kV, FIG. 61C depicts 6 kV. The printing needle may be grounded in all cases. Under the electric field, since the flow rate through the printing needle is independent of the applied voltage, a reduction in the droplet size is required to compensate for the periodic detachment of droplets. FIGS. 62A-C illustrates the measured relationship between the droplet mass, the detachment frequency and the imposed volumetric flow rate. In particular, in FIG. 61C, the volumetric flow rate predicted using the Poiseuille law is slightly lower than the measured values because of the additional pulling electric force unaccounted in Eq. (97). FIG. 62A depicts a droplet mass detachment frequency FIG. 62B depicts the imposed volumetric flow rate [with the one calculated using Eq. (97)] FIG. 62C depicts three different values of the applied voltage (3, 5 and 6 kV) in the case of grounded printing needle. The average charges on droplets established via Eq. (97) and the experimental data for the landing location for both charging methods at several values of the applied voltage are presented in FIG. 63.

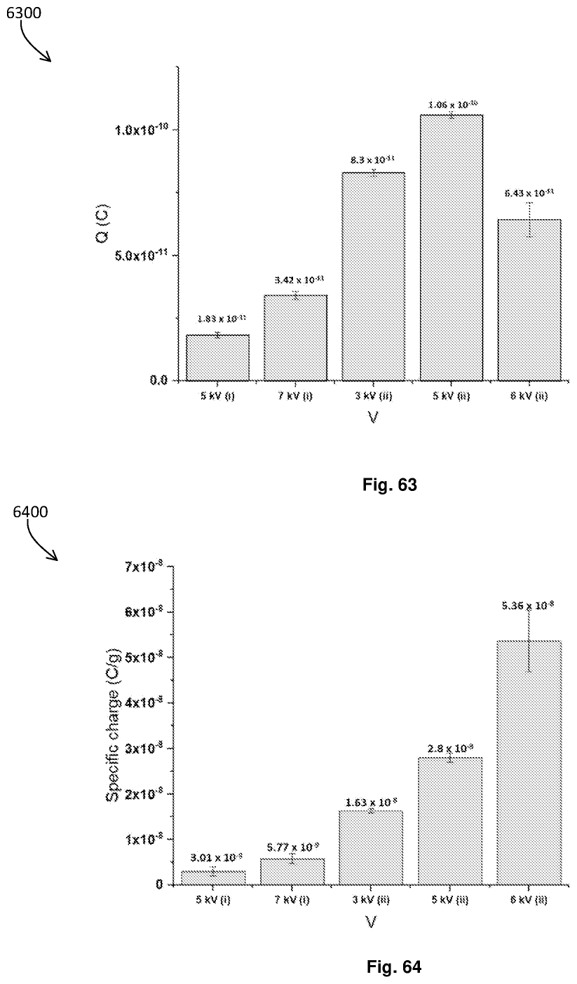

With reference to FIG. 63, an average charge of glycerol droplets found using Eq. (92) and the experimentally measured droplet landing location is depicted. Charging by ionized air is denoted as (i), whereas direct charging by wire electrode—as (ii). It was established in FIG. 62A that as the electric field strength between the electrodes increases, the mass of the droplets m can decrease. Then, using the data from FIG. 62A, one can determine the specific droplet charge q=Q/m, which is presented in FIG. 64. It is seen that the specific charge strongly increases with the applied voltage for both methods of charging. It should be noted that since the error bar in FIG. 64 results from the ratio of two variables, Taylor expansion was used to estimate (<10%) Var(C)=Var(A/B) where C, A, and B are the means of their distributions, as in the following equation:

$$Var ( C ) = {C}^{2} [ \frac{Var ( A )}{{A}^{2}} + \frac{Var ( B )}{{B}^{2}} - 2 \frac{Cov ( AB )}{AB} ] \qquad ( 99 )$$

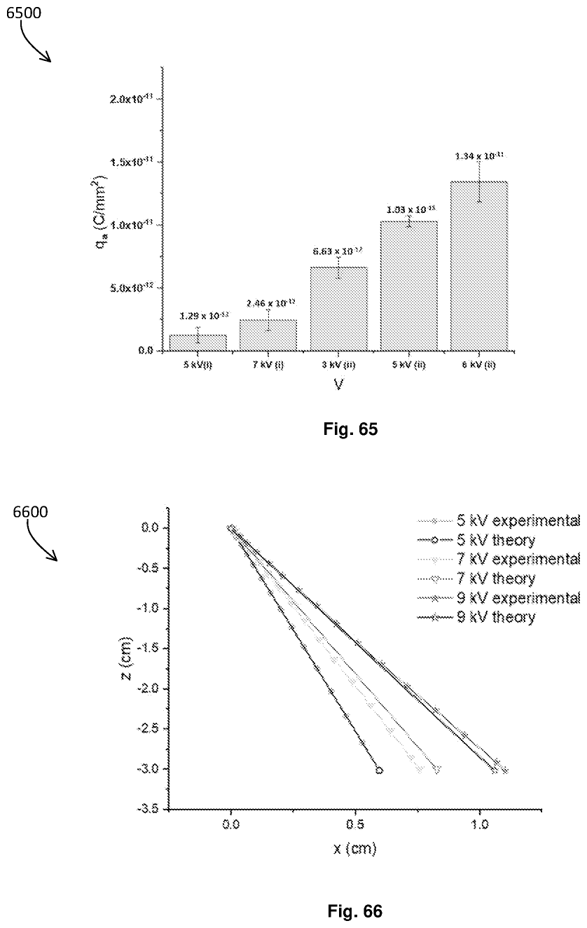

Turning to FIG. 64, a specific charge of glycerol droplets is depcited. Charging by ionized air is denoted as (i), whereas direct charging by wire electrode—as (ii). In addition, FIG. 65 illustrates that the charge per unit surface area qₐ, on the droplet, also increases with the applied voltage. An independent, direct measurement of droplet charge Q using the approach shown in FIG. 57 was also conducted. 100 droplets were dripped into a conductive collector which was insulated from its surroundings. The cumulative charge of these droplets was transferred to a capacitor of a known capacitance, wherewith the help of a buffering op-amp (FIG. 57), the voltage was recorded using a multimeter. The specific charge found by this independent method is then compared to the one found via Eq. (97), which reveals a reasonably accurate agreement. It should be noted that the droplet's charge due to solely air ionization was too small to be measured with the buffered capacitor setup of FIG. 57, and therefore, the direct droplet charging with the grounded wire attached to the needle is preferable.

With addition reference to FIG. 65, a charge per unit surface area on glycerol droplets is depcited. Charging by ionized air is denoted as (i), whereas direct charging by wire electrode—as (ii). Transferring a charge to the ink droplet has enabled one in positioning the ejected droplets within an electric field following detachment from the needle. Accordingly, the experimental setup can be reduced in size allowing attachment to a commercial DIW printer. DIW printers operate very close to the printing surface, and thus are set to a home position calibrating the standoff distance (distance from print needle to substrate) before printing can commence. By eliminating this calibration (homing) on the z-stage and limiting the printing needle to a specific plane ˜8 cm above the substrate, the commercial DIW printer effectively transformed into a DOD inkjet printer prototype previously described by the schematic in FIGS. 58A-C. Here, adding electrodes along with a high-voltage power supply and required circuitry allowed additional control of the droplets after ejection. Two liquids were chosen for testing on the modified printer. To keep in line with the previous experiment, glycerol was the first fluid tested, while a photo-resin polymer ink (Spot-E, Spot-A Materials) was also chosen to show operation with commercially available industrial materials. It should be emphasized that for all the following printing scenarios, the print head was fixed the z-direction. The print head moved only along the y-axis while the droplets were positioned along the x-axis by means of the electric field which acted on the droplets falling vertically (against the z-axis).

The recorded droplet trajectories were established frame by frame using video recordings for hundreds of droplets. The measured droplet trajectories appeared to be linear in agreement with the predictions of Eq. (96); cf. FIG. 66. Superimposing the predicted trajectory (6) with the experimental data allows one to find the droplet charge Q, using the measured droplet mass m. Also, this can be done directly using Eq. (97) and the measured horizontal droplet landing coordinate x*. Note that the predictions are in rather good agreement with the data, albeit the most deviation between the theory and experiment is observed at the intermediate voltage of 7 kV. This might be related to the fact that at 7 kV the secondary geometric features of the electric field in some cases facilitated issuing a slightly longer droplet tail, which increased the droplet mass versus the one used in the calculations, and thus caused an earlier droplet landing.

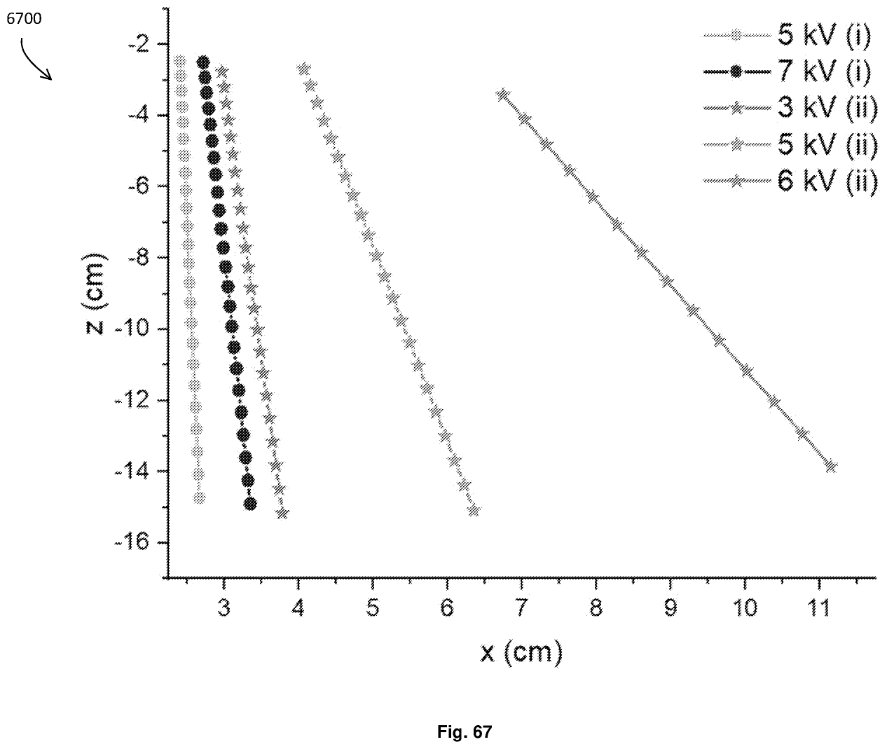

With reference to FIG. 66, droplet trajectories in the case of charging by ionized air as in FIG. 57B is depicted. Experimental data are shown by symbols, the trajectories predicted by Eq. (92)—by straight lines with open symbols corresponding to the listed applied voltages. On the other hand, FIG. 67 compares the effect of the droplet charging method on their trajectories. The larger horizontal droplet deflections reveal that the direct charging by the wire electrode allows for a higher droplet charge than the one acquired from the ionized air in the case of indirect charging at the same voltage (5 to 7 kV). Note that at 3 kV, droplet charging by ionized air resulted in a practically unnoticeable horizontal deflection, and this data is not included in FIG. 67.

Turning to FIG. 67, droplet trajectories resulting from the two different methods of droplet charging are depicted: Charging by ionized air is denoted as (i), whereas direct charging by wire electrode—as (ii). Initial tests on the retrofitted DIW printer used glycerol as the working fluid with the 30-gauge printing needle fixed about 6.5 cm above the glass substrate supported by the print bed. While the 30-gauge needle is slightly larger (159 μm) than the 10-150 μm range found in inkjet literature, the size was selected to simplify the initial case and maximize viewing potential. The pressure was set to 5 psi. FIG. 13a shows the expected placements of glycerol droplets numbered sequentially in their order of printing for each y-position (cf. Table 10). The capital letters set to subscript each droplet represent specific electric filed strengths (cf. Table 11). It should be emphasized that the absence of subscript denotes no-electric-field-applied cases.

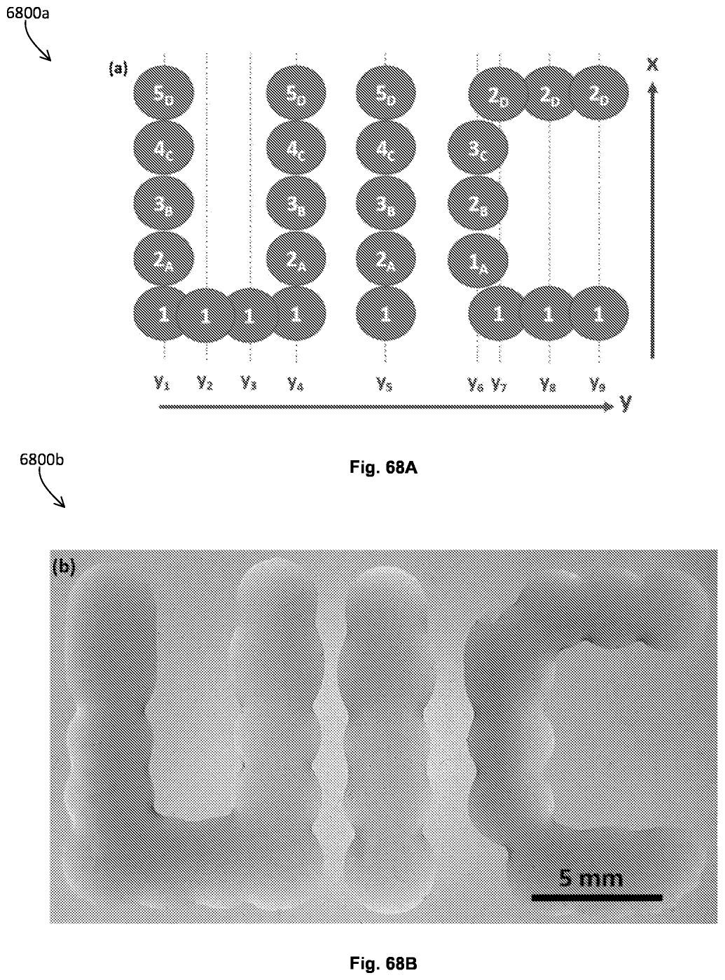

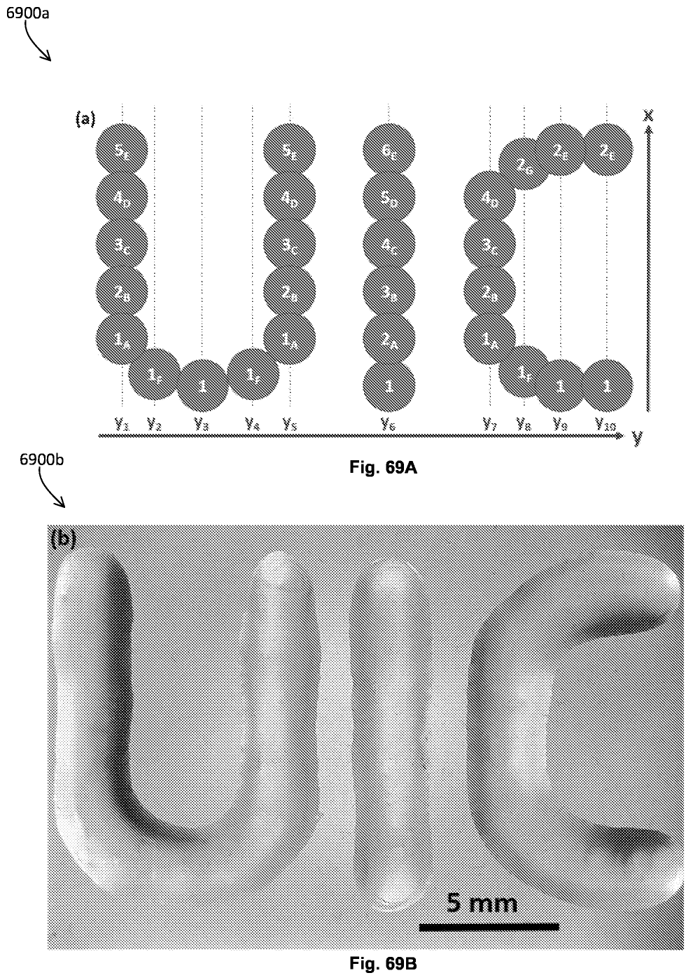

With reference to FIG. 68A, a photo of the corresponding glycerol print is depicted. FIG. 68A depicts a schematic of intended glycerol droplet locations. FIG. 68B depicts a photo of a glycerol sample pattern on a glass substrate printed in minutes. Table 10 details the y-positions during glycerol printing along with the number of droplets ejected to each location. Table 11 details the voltages and the corresponding electric field strengths of each high-voltage setting used to move the droplets along the x-axis. Parameters of each printed droplet can be found in the schematic in FIG. 68A combined with the associated Tables 10 and 11 [e.g., the first leg of the U letter in UIC was printed at position y₁ (0,0), where 5 droplets were deposited]. The first droplet was placed with no voltage applied, the second one was placed with 2.3 kV, while the third droplet was placed with 2.4 kV, etc.

TABLE 10
Listing of the y-positions during printing
and the number of droplets ejected at each position.

| POSITION | Y (MM) | NUMBER OF DROPLETS |
|---|---|---|
| Y₁ | 0 | 5 |
| Y₂ | 2.5 | 1 |
| Y₃ | 5 | 1 |
| Y₄ | 7.5 | 5 |
| Y₅ | 12 | 5 |
| Y₆ | 16.5 | 3 |
| Y₇ | 18 | 2 |
| Y₈ | 20.5 | 2 |
| Y₉ | 23 | 2 |

TABLE 11
Listing of voltage and the corresponding electric field
strength during printing.

| | | ELECTRIC FIELD |
|---|---|---|
| HIGH-VOLTAGE | VOLTAGE | STRENGTH |
| SETTING | (KV) | (KV/CM) |
| A | 1.35 | 0.45 |
| B | 1.8 | 0.6 |
| C | 2.15 | 0.716 |
| D | 2.45 | 0.817 |

After the initial test with glycerol on the prototype printer retrofitted with high-voltage electrodes, the working fluid was changed to Spot-E photo-resin. The printing needle was also changed to a 32-gauge needle, which at 108 μm, falls within the inkjet range from the literature. The pressure was reduced to 1.5 psi. FIG. 69A depicts the expected placements of Spot-E droplets numbered sequentially in their order of printing for each y-position. The ability to cure the photo-resin with UV light allowed multiple layers of the ink to be printed. The UV light used in this study was an uvBeast (uvBeast UVB-01 V3 365 nm UV Flashlight, 5400 μW/cm2). The UV light was set up to directly project onto the printing substrate. For a single droplet, the curing time is smaller than 3 s. In multilayer printing, droplets for the second layer were jetted after the first layer has been solidified. The first layer of deposited ink measured 0.44 mm thick, while the addition of the second layer resulted in a thickness of 0.67 mm. FIG. 69B depicts a photo of the dual-layer Spot-E print.

FIG. 69A depicts a schematic of intended Spot-E droplet locations numbered sequentially in printing order. This procedure was repeated twice to achieve a dual-layer print. FIG. 69A depicts a photo of a dual-layer Spot-E sample pattern printed in minutes. Table 12 lists the y-positions during the dual-layer Spot-E printing along with the number of droplets ejected at each location.

TABLE 12
Listing of the y-positions during dual-layer Spot-E printing
along with the number of droplets ejected at each position.

| POSITION | Y (MM) | NUMBER OF DROPLETS |
|---|---|---|
| Y₁ | 0 | 5 |
| Y₂ | 1.5 | 1 |
| Y₃ | 3.5 | 1 |
| Y₄ | 5.5 | 1 |
| Y₅ | 7 | 5 |
| Y₆ | 11 | 6 |
| Y₇ | 15 | 4 |
| Y₈ | 16.5 | 2 |
| Y₉ | 18.5 | 2 |
| Y₁₀ | 21.5 | 2 |

Table 13 lists the voltages and the corresponding electric field strengths of each high-voltage setting used to move the droplets along the x-axis.

TABLE 13
Listing of voltage and the electric field strength
during dual-layer Spot-E printing.

| | | ELECTRIC FIELD |
|---|---|---|
| HIGH-VOLTAGE | VOLTAGE | STRENGTH |
| SETTING | (KV) | (KV/CM) |
| A | 1.35 | 0.45 |
| B | 1.75 | 0.58 |
| C | 2.15 | 0.72 |
| D | 2.3 | 0.77 |
| E | 2.5 | 0.83 |
| F | 1.2 | 0.4 |
| G | 2.45 | 0.82 |

To demonstrate novel capabilities of the proposed method, 3D printing inside a confinement (an overhang) in FIG. 3b is explored next. This would be a problematic printing situation for any ordinary 3D printing device, but not for the present electrically-assisted one, as is depicted in FIG. 58C. Moreover, this particular situation is not just problematic for DIW and inkjet printers but to all known sub-classes of conventional or 3D printing processes researched until now, as to our knowledge.

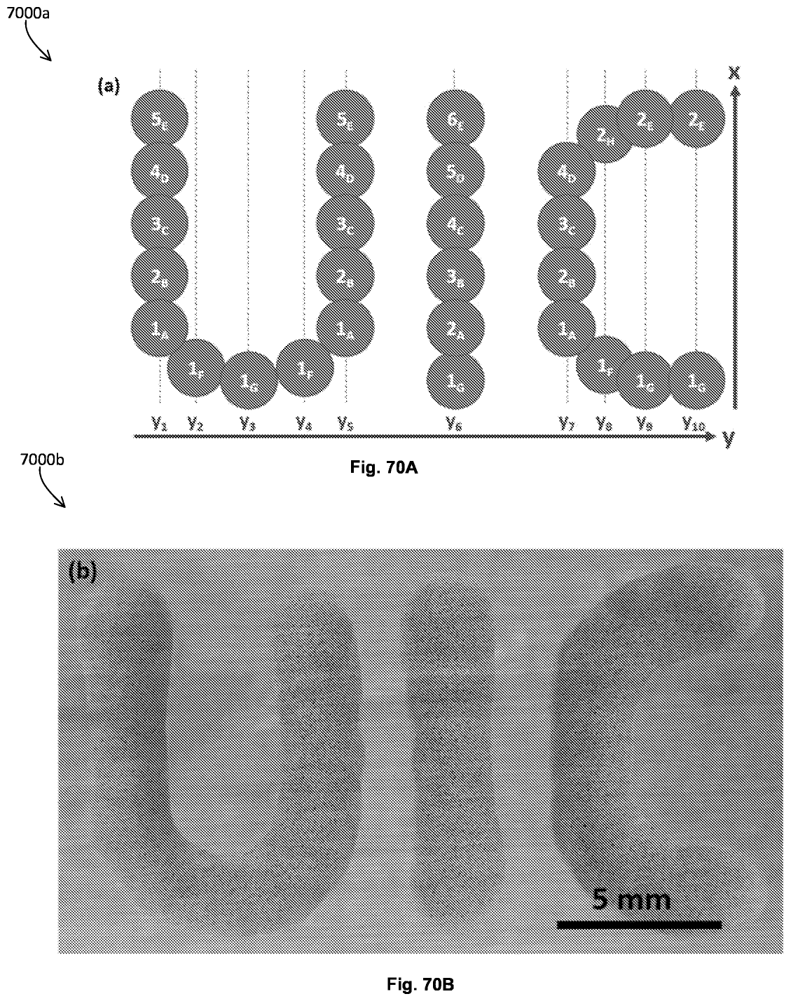

A 32G printing needle may be employed with a pressure remaining at 1.5 psi. FIG. 68A depicts the expected placements of Spot-E droplets numbered sequentially in their order of printing for each y-position. It should be emphasized that every droplet should be affected by the electric field in this case, as every droplet must be deflected from vertical to ultimately land beneath the overhang (inside the confinement). FIG. 70B shows a photo of the UIC logo printed beneath the printed overhang structure.

Turning to FIG. 70A, a schematic is depicted of intended Spot-E droplet locations to be printed below the problematic overhang structure (inside a confinement) and numbered sequentially in printing order. Lettered subscripts denote specific applied voltages corresponding to different electric field strengths. FIG. 70A depicts a backlit photo (taken orthogonal to the x-axis) of Spot-E printed below problematic overhang structure comprised of VeroClear RGD-810 photo-resin. Table 14 details the y-positions used while printing beneath the problematic overhang structure.

TABLE 14
Listing of the y-positions used while printing beneath
the problematic overhang structure along
with the number of droplets issued.

| POSITION | Y (MM) | NUMBER OF DROPLETS |
|---|---|---|
| Y₁ | 0 | 5 |
| Y₂ | 1.5 | 1 |
| Y₃ | 3.5 | 1 |
| Y₄ | 5.5 | 1 |
| Y₅ | 7 | 5 |
| Y₆ | 11 | 6 |
| Y₇ | 15 | 4 |
| Y₈ | 16.5 | 2 |
| Y₉ | 18.5 | 2 |
| Y₁₀ | 21.5 | 2 |

Table 15 details the voltages and the corresponding electric field strengths of each high-voltage setting used to move the droplets along the x-axis and below the overhang.

TABLE 15
Listing of voltage and the electric field strength while
printing beneath the overhang.

| HIGH-VOLTAGE | VOLTAGE | EF STRENGTH |
|---|---|---|
| SETTING | (KV) | (KV/CM) |
| A | 2.45 | 0.82 |
| B | 2.55 | 0.85 |
| C | 2.65 | 0.88 |
| D | 2.72 | 0.91 |
| E | 2.82 | 0.94 |
| F | 2.34 | 0.78 |
| G | 2.3 | 0.77 |
| H | 2.78 | 0.93 |

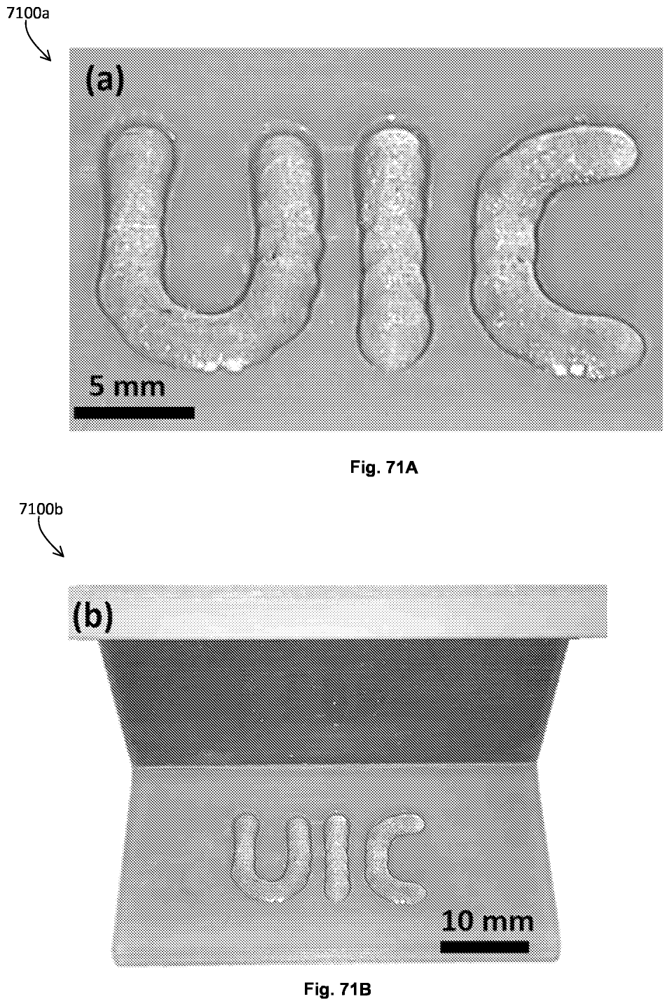

An alternative view, taken at about 45° is depicted in both FIGS. 71A and 71B shown at two different magnifications. FIG. 71A depcits a photo (taken at about 45° from horizontal) of Spot-E printed below the problematic overhang structure (in confinement). FIG. 71B depcits a zoomed-out photo revealing the overhang structure with a printed logo inside. The present disclosure reveals that an electric field, strategically generated near a printing orifice, can be used to selectively place printed ink droplets. By evaluating the droplet charge using joint theoretical and experimental efforts, an accurate and repeatable movement of droplets was achieved by means of the Coulomb force imposed by the transverse electric field. In previous works of the present group, it was found that glycerol was incapable of movement on the surface by means of electrowetting-on-dielectrics in 3D printing applications. However, in the present work, it was demonstrated that glycerol droplets can be positioned by the applied electrostatic force during droplet flight. Next, a commercially available printer was modified by inclusion of the transverse electric field and used to print photo-initiated ink Spot-E. Specifically, a straightforward addition of two electrodes to the printhead, was able to reduce moving parts, deposit droplets onto flexible substrates without splashing, and even print in conventionally hard-to-reach locations, such as under an overhang confinement. In a sense, one of the methods proposed in this work pulls closer the domains of 3D printing, electrospinning and electrospraying. The apparatuses, systems, and methods of the present disclosure may be configured to: (i) generation techniques aimed at reduced droplet volumes for greater resolution, and (ii) 2D droplet control by addition of a second set of electrodes oriented by 90° about the y-axis.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. An electrohydrodynamic material deposition printer head, comprising:
a material delivery nozzle configured to deliver at least one material in a first direction relative to a substrate; and
an electric field generator configured to control a direction of an electric field proximate the material being directed to redirect at least a portion of the at least one material in a second direction relative to the substrate, wherein the second direction is different than the first direction.

2. A printer head as in claim 1, wherein the electric field generator includes at least one electrode proximate the material delivery nozzle.

3. A printer head as in claim 1, wherein the electric filed generator includes at least one electrode integral with the material delivery nozzle.

4. A printer head as in claim 1, further comprising:
a controller configured to control the electric field generator to reorient the electric field to redirect at least a portion of the at least one material relative to the substrate.

5. A printer head as in claim 1, further comprising:
an array of electrodes positioned on an opposite side of the substrate with respect to the material delivery nozzle.

6. A printer head as in claim 1, further comprising:
a material delivery nozzle control device; and
a controller configured to control the electric field generator and the material delivery nozzle control device to redirect at least a portion of the at least one material relative to the substrate.

7-11. (canceled)

12. An electrohydrodynamic material deposition system, comprising:
a material delivery nozzle configured to deliver at least one material in a first direction relative to a substrate;
an array of electrodes positioned on an opposite side of the substrate with respect to the material delivery nozzle configured to generate an electric field proximate the material being delivered and
to redirect at least a portion of the at least one material in a second direction relative to the substrate, wherein the second direction is different than the first direction.

13. The system of claim 12, wherein the at least one electrode is mounted on or proximate to the substrate.

14. The system of claim 12, further comprising:
a material delivery nozzle control device;
an electric field generator; and
a controller configured to control the electric field generator and the material delivery nozzle control device to redirect at least a portion of the at least one material relative to the substrate.

15. The system of claim 12, further comprising:
at least one material delivery nozzle electrode positioned proximate the material delivery nozzle.

16. The system of claim 15, further comprising:
an electric field generator; and
a controller configured to control the electric field generator to apply a voltage to each of the array of electrodes and the at least one material delivery nozzle electrode independent from one another.

17-33. (canceled)

34. A non-transitory computer-readable medium storing computer-readable instructions that, when executed by a processor, cause the processor to control electrohydrodynamic material deposition, further execution of the computer-readable instructions causes the processor to:
control a material delivery nozzle, wherein the material delivery nozzle is configured to direct at least one material in a first orientation relative to a substrate in response to the processor executing a material delivery nozzle control module; and
control an orientation of an electric field proximate the material delivery nozzle to redirect at least a portion of the at least one material in a second orientation relative to the substrate in response to the processor executing an electric field controlling module, wherein the second orientation is different that the first orientation.

35. The computer-readable medium as in claim 34, wherein further execution of the computer-readable instructions causes the processor to control an array of electrodes positioned on an opposite side of the substrate with respect to the material delivery nozzle.

36. The computer-readable medium as in claim 34, wherein further execution of the computer-readable instructions causes the processor to control at least one material dispensing nozzle electrode positioned proximate the material delivery nozzle.

37. The computer-readable medium as in claim 35, wherein further execution of the computer-readable instructions causes the processor to control the material delivery nozzle in coordination with the array of electrodes.

38. The computer-readable medium as in claim 36, wherein further execution of the computer-readable instructions causes the processor to control the material delivery nozzle in coordination with the at lease one electrode.

39. The computer-readable medium as in claim 36, wherein further execution of the computer-readable instructions causes the processor to control an array of electrodes positioned on an opposite side of the substrate with respect to the material delivery nozzle.

40. The computer-readable medium as in claim 39, wherein further execution of the computer-readable instructions causes the processor to control the material delivery nozzle in coordination with the at least one material dispensing nozzle electrode.

41. The computer-readable medium as in claim 39, wherein further execution of the computer-readable instructions causes the processor to control the material delivery nozzle in coordination with the array of electrodes.

42. The computer-readable medium as in claim 34, wherein further execution of the computer-readable instructions causes the processor to control the material delivery nozzle in coordination with the array of electrodes and the at least one material dispensing nozzle electrode.

43-77. (canceled)
